(19) United States
(12) Patent Application Publication
(10) Pub. No.: US 2007/0212498 A1
(43) Pub. Date: Sep. 13, 2007

(54) Optical film, antireflection film, polarizing plate, display apparatus and method for manufacturing optical film

(75) Inventors: Yuuichi Fukushige, Kanagawa (JP); Takato Suzuki, Kanagawa (JP)

Correspondence Address: BUCHANAN, INGERSOLL & ROONEY PC, POST OFFICE BOX 1404, ALEXANDRIA, VA, 22313-1404, US

(73) Assignee: FUJIFILM Corporation, Tokyo (JP)

(21) Appl. No.: 11/707,934

(22) Filed: Feb. 20, 2007

(30) Foreign Application Priority Data
Feb. 24, 2006 (JP) 2006-048839

(51) Int. Cl. C09K 19/00

(52) U.S. Cl. 428/1.31

(57) ABSTRACT

An optical film, which comprises: a transparent support; and at least one layer of functional layer formed from a coating composition, wherein the at least one layer of functional layer is formed by curing the coating composition by a heat energy and a light energy.

### BACKGROUND OF THE INVENTION

1. Field of the Invention

The present invention relates to an optical film, an antireflection film, a polarizing plate, a display apparatus, and a method for manufacturing the optical film.

2. Description of the Related Art

The antireflection film is generally positioned on the outermost surface of a display apparatus in order to prevent contrast reduction due to reflection of external light or glare of images in a display apparatus such as a cathode ray tube display apparatus (CRT), a plasma display (PDP), an electroluminescence display (ELD), or a liquid crystal display apparatus (LCD) so as to reduce the reflectance using the principle of the optical interference. In general, the antireflection film can be manufactured by forming, on a support, a high refractive index layer such as a hard coat layer, and further, a low refractive index layer with a proper film thickness thereon. The low refractive index layer which, in many cases, becomes the uppermost layer of the antireflection film is required to have a high scratch resistance. However, in order to implement a high scratch resistance for the low refractive index layer which is a thin film, the strength of the film itself and the adhesion to the underlayer are required.

On the other hand, in order to implement a low reflectance in the antireflection film, a material with a minimum refractive index is desired for the low refractive index layer. In order to reduce the refractive index of the layer, there are means such as (1) introduction of a fluorine atom, and (2) reduction of the density (introduction of voids). However, in any case, the film strength or the adhesion is reduced, so that the scratch resistance tends to be reduced. Thus, it has been difficult to achieve both the low refractive index and the high scratch resistance.

For example, there is described a means for introducing a polysiloxane structure into a fluorine-containing polymer, and thereby reducing the friction coefficient of the film surface for improving the scratch resistance (see, JP-A-11-189621, JP-A-11-228631 and JP-A-2000-313709). The technologies disclosed in these documents are effective for the improvement of the scratch resistance to a certain degree. However, the scratch resistance was not enough.

There is described the following technology: in order to ensure the scratch resistance, the abrasion resistance, and the weather resistance of the surface of the antireflection film while ensuring the adhesion onto the support, a coating molded product is formed in which out of the coating layers of at least the two layered structure, the support surface layer does not contain colloidal silica, and the upper layer contains colloidal silica (see, Japanese Patent No. 3687230). However, this means is not enough for allowing optical films, particularly an antireflection film to exhibit their various performances (refractive index, hardness, brittleness, curl characteristics, internal haze, surface haze, and the like).

### SUMMARY OF THE INVENTION

It is one aspect of the present invention to provide an optical film which has been improved in scratch resistance, an antireflection film which has been more improved in scratch resistance while having a sufficient antireflection performance, and a method for manufacturing the optical film. It is another aspect of the invention to provide a polarizing plate and a display apparatus which have the optical film or the antireflection film, and has scratch resistance while having a sufficient antireflection performance.

The present inventors have conducted a close study in order to resolve the foregoing problems. As a result, they found that the foregoing aspects can be achieved by the following means, and they have reached the completion of the invention. Namely, the invention is as follows.

(1) An optical film, which comprises:

a transparent support; and

at least one layer of functional layer formed from a coating composition,

wherein the at least one layer of functional layer is formed by curing the coating composition by a heat energy and a light energy.

(2) The optical film as described in (1) above,

wherein the at least one layer of functional layer is formed by a plurality of cycles of sequential or simultaneous application with the heat energy and the light energy.

(3) The optical film as described in (1) or (2) above,

wherein the coating composition comprises a heat curable material and a light curable material.

(4) The optical film as described in any of (1) to (3) above,

wherein the coating composition comprises a compound including a heat curable moiety and a light curable moiety in the same molecule.

(5) The optical film as described in any of (1) to (4) above,

wherein the at least one layer of functional layer includes a layer in contact with a surface of the transparent support.

Although the coating composition containing a heat curable material and a light curable material has no particular restriction, mention may be made of compositions obtained by mixing two or more types of each material.

The compound including a heat curable moiety and a light curable moiety in the same molecule has no particular restriction. However, mention may be made of a compound (such as monomer, oligomer or polymer) having at least one light polymerizable moiety (e.g., a (meth)acrylate group or an epoxy group), and at least one heat curable moiety (e.g., a hydroxy group or an amino group) in one compound at the same time. Incidentally, when the layer formed by curing the coating composition is a hard coat layer, the compositions including a binder polymer or a monomer to be used for the hard coat layer described below corresponds to a coating composition containing a heat curable material and a light curable material, or a coating composition containing a compound including a heat curable moiety and a light curable moiety in the same molecule.

To the curing method by a light energy, a known means is applicable. However, preferred is an energy beam of which the wavelength of light of the light energy falls within a range of 200 to 500 nm. As the light source of the energy beam, the ones emitting an ultraviolet ray and a visible light are preferred. There is preferably used, for example, a metal halide lamp, a low pressure mercury lamp, a high pressure mercury lamp, a super high pressure mercury lamp, a bactericidal lamp, or a xenon lamp.

The curing method by a heat energy is a method for curing by heating (carrying out thermal polymerization. The heating conditions have no particular restriction, and may be appropriately determined by the type of a thermal polymerization initiator to be used, and the like. Heating can be carried out at 60° C. to 140° C. for 10 minutes to 120 minutes by the use of hot air and/or hot water bath. For the heating method, the temperature may be increased through multi steps.

### <Antireflection Film>

### [Layer Structure of Antireflection Film]

When the optical film of the invention has at least an antireflection layer (preferably a hard coat layer and at least one layer of an antireflection layer), the film functions as an antireflection film. The antireflection film may have another optical functional layer other than the hard coat layer and the antireflection layer. The antireflection film of the invention has, on a transparent support (which may be referred to as a base material or a base material film), a hard coat layer described layer, and has thereon an antireflection layer stacked in view of the refractive index, film thickness, number of layers, order of layers, and the like so as to be reduced in reflectance due to optical interference. The simplest structure of the antireflection layer is preferably configured such that a hard coat layer higher in refractive

(6) The optical film as described in any of (1) to (5) above,

wherein the at least one layer of functional layer includes at least one of a low refractive index layer and a hard coat layer.

(7) The optical film as described in any of (1) to (6) above,

wherein the at least one layer of functional layer is at least two layers of functional layers.

(8) An antireflection film, which comprises:

an optical film as described in any of (1) to (7) above; and

an antireflection layer.

(9) A polarizing plate, which comprises:

a pair of protective films; and

a polarizing film between the pair of protective films,

wherein at least one of the pair of protective films is an optical film as described in any of (1) to (7) above or an antireflection film as described in (8) above.

(10) A display apparatus, which comprises:

an antireflection film as described in (8) above or a polarizing plate as described in (9) above,

wherein the antireflection film or the polarizing plate comprises a low refractive index layer that is disposed so as to be on a viewing side.

(11) A method for manufacturing an optical film comprising a transparent support and at least one layer of functional layer, the method comprising:

coating and drying a coating composition; and

curing the coating composition by a heat energy and a light energy so as to form the at least one layer of functional layer.

(12) The manufacturing method as described in (11) above,

wherein the heat energy and the light energy are applied plural times sequentially or simultaneously.

(13) The manufacturing method as described in (11) or (12) above,

wherein the coating composition comprises a heat curable material and a light curable material.

(14) The manufacturing method as described in any of(11) to (13) above,

wherein the coating composition comprises a compound including a heat curable moiety and a light curable moiety in the same molecule.

(15) The manufacturing method as described in any of (11) to (14) above,

wherein the at least one layer of functional layer includes a layer in contact with a surface of the transparent support.

(16) The manufacturing method as described in any of (11) to (15) above,

wherein the at least one layer of functional layer includes at least one of a low refractive index layer and a hard coat layer.

(17) The manufacturing method as described in any of (11) to (16) above,

wherein the at least one layer of functional layer is at least two layers of functional layers.

(18) The manufacturing method as described in any of(11) to (17) above,

wherein the at least two layers of functional layers include a hard coat layer and an antireflection layer.

### BRIEF DESCRIPTION OF THE DRAWINGS

FIG. 1 is one exemplary example of a cross sectional view of an optical film (antireflection film) of the present invention;

FIG. 2 is one exemplary example of another cross sectional view of the optical film (antireflection film) of the invention;

FIG. 3 is one exemplary example of a still other cross sectional view of the optical film (antireflection film) of the invention;

FIG. 4 is one exemplary example of a cross sectional view of an optical film (antireflection film) having an antiglare hard-coat layer of the invention; and

FIG. 5 is one exemplary example of another cross sectional view of an optical film (antireflection film) having an antiglare hard coat layer of the invention.

### DETAILED DESCRIPTION OF THE INVENTION

Below, the present invention will be described in details. Incidentally, in this specification, when the numerical values represent physical property values, characteristic values, or the like, the wording “(numerical value 1) to (numerical value 2)” means “(numerical value 1) or more and (numerical value 2) or less”. Whereas, the term “polymerization” referred to in the invention has a meaning also including copolymerization. Further, the wording “on the support” referred to in the invention has a meaning including both the direct surface of the support, and the surface of some layer (film) provided on the support. Whereas, in this specification, the term “(meth)acrylate” means “at least any of acrylate and methacrylate”. The same goes for “(meth)acrylic acid”, or the like.

### <Optical Film>

An optical film of the invention is an optical film having at least one layer of functional layer on a transparent support, wherein the at least one layer of functional layer is a layer formed by curing the coating composition by a heat energy and a light energy.

The at least one layer of functional layer has no particular restriction. However, it is essential only that it is an optically functioning layer (optical functional layer). The functional layer is preferably a hard coat layer (hard coat layer obtained by curing a monomer) and/or a low refractive index layer. The functional layer may be an antiglare hard coat serving as both a hard coat layer and an antiglare layer. As the functional layer, for example, mention may be made of a layer formed of light transmissive fine particles for imparting an antiglare property or an internally scattering property, and a light transmissive resin for imparting a hard coat property. The functional layer may contain an inorganic filler for achieving a high refractive index, preventing crosslinking shrinkage, and achieving high strength. Alternatively, the functional layer may also be an antistatic hard coat layer serving as both of an antistatic layer and a hard coat layer, or an antistatic antiglare layer serving as both of an antistatic layer and an antiglare layer. In addition, the at least one layer of functional layer is preferably a layer in contact with the surface of a transparent support.

In the invention, the layer formed by curing a coating composition is cured by a heat energy and a light energy. A heat energy and a light energy may be applied thereto sequentially or simultaneously. For example, for the sequential process, there may be adopted any of:
(1) A method in which after application with a heat energy, a light energy is applied thereto,
(2) A method in which after application with a light energy, a heat energy is applied thereto, or
(3) A method in which both of a heat energy and a light energy are applied thereto simultaneously. Alternatively, preferably, the methods (1) to (3) are combined to apply a heat energy and a light energy sequentially or simultaneously plural times. In the invention, preferred is the method in which both of a heat energy and a light energy are applied thereto simultaneously.

When the optical film of the invention has at least two layers of functional layers (upper layer and lower layer), the optical film can be manufactured in the following manner. On the first layer of functional layer (lower layer) on a transparent support, another layer (upper layer) is coated, dried, and cured. It is also acceptable that the upper layer is cured by a different energy from that for the lower layer. Alternatively, it is also acceptable that the lower layer (upper layer) undergoes a curing reaction by the energy for curing the upper layer (lower layer).

The coating composition is preferably a coating composition containing a heat curable material and a light curable material, and/or a coating composition containing a compound including a heat curable moiety and a light curable moiety in the same molecule. index than the base material film and a low refractive index layer lower in refractive index than the base material are combined.

Examples of the structure of the antireflection film may include the one in which on a base material film, a hard coat layer is provided, and further a low refractive index layer is provided, the one in which on a base material film, a hard coat layer is provided, and further two layers of high refractive index layer/low refractive index layer are provided, and the one in which on a hard coat layer, three layers having different refractive indexes, i.e., intermediate refractive index layer (layer higher in refractive index than the base material film or the hard coat layer, and lower in refractive index than the high refractive index layer)/high refractive index layer/low refractive index layer are stacked in this order. A still larger number of antireflection layers may be stacked. Further, the antireflection film of the invention may have functional layers such as an antiglare layer and an antistatic layer.

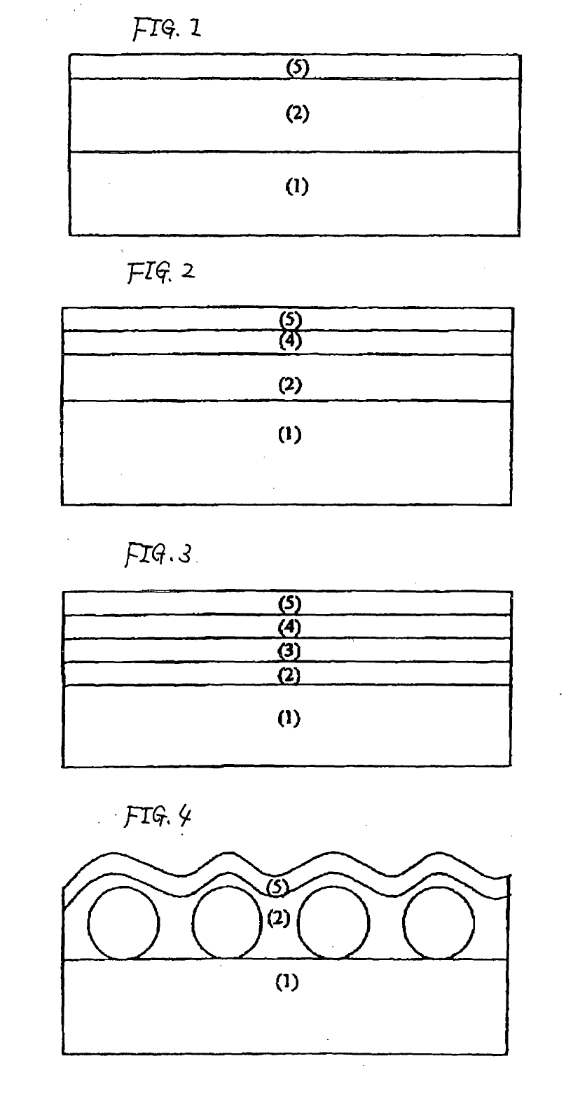

Examples of the preferred structures of the antireflection film of the invention will be shown below. The schematic diagrams are shown in FIGS. 1 to 5.
a. Transparent support/hard coat layer/low refractive index layer (FIG. 1)
b. Transparent support/hard coat layer/antiglare layer/low refractive index layer
c. Transparent support/hard coat layer/high refractive index layer/low refractive index layer (FIG. 2)
d. Transparent support/hard coat layer/intermediate refractive index layer/high refractive index layer/low refractive index layer (FIG. 3)
e. Transparent support/antistatic layer/hard coat layer/intermediate refractive index layer/ high refractive index layer/low refractive index layer
f. Antistatic layer/transparent support/hard coat layer/intermediate refractive index layer/ high refractive index layer/low refractive index layer

As with the foregoing item a (FIG. 1), on the transparent support (1), the hard coat layer (2) is coated, and the low refractive index layer (5) is stacked thereon. The resulting film can be preferably used as an antireflection film. For the low refractive index layer (5), on the hard coat layer (2), the low refractive index layer (5) is formed with a film thickness equal to around ¼ the wavelength of light. As a result, it can reduce the surface reflection by the principle of thin-film interference.

Whereas, as with the item c (FIG. 2), on the transparent support (1), the hard coat layer (2) is coated, and the high refractive index layer (4) and the low refractive index layer (5) are stacked thereon. Even with this configuration, the resulting film can be preferably used as an antireflection film. Further, as with the item d (FIG. 3), by setting the layer structure in which the transparent support (1), the hard coat layer (2), the intermediate refractive index layer (3), the high refractive index layer (4), and the low refractive index layer (5) are stacked in this order, it is possible to set the reflectance to 1% or less.

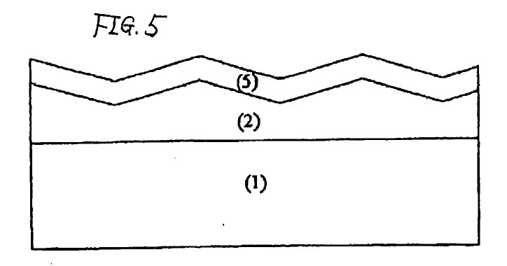

In each layer structure of the antireflection films a to f, the hard coat layer (2) can be an antiglare hard coat layer having an antiglare property. The antiglare property may be imparted by dispersion of mat particles as shown in FIG. 4. Alternatively, it may also be formed by shaping the surface with a process of embossing or the like as shown in FIG. 5. The antiglare hard coat layer formed by dispersion of mat particles includes a binder, and light transmissive particles dispersed in the binder. The antiglare hard coat layer has both the antiglare property and the hard coat property. The hard coat layer may be configured of a plurality of layers such as an antiglare hard coat layer and a smooth hard coat layer. Alternatively, an antiglare layer may also be provided separately from the hard coat layer.

Whereas, as a layer which may be provided between the support and a layer closer to the surface side than that, or on the outermost surface, mention may be made of an interference unevenness (spectral unevenness) preventive layer, an antistatic layer (when a request to reduce the surface resistance value from the display side, or other requests are demanded, and when deposition of dust on the surface or the like becomes troublesome), another hard coat layer (when the hardness is insufficient with only one layer of hard coat layer or antiglare hard coat layer), a gas barrier layer, a water absorption layer (moisture proof layer), an adhesion improvement layer, a stain proof layer (anti-contamination layer), or the like.

The refractive indices of respective layers forming the antireflection film having the antireflection layer in the invention preferably satisfy the following relationship:

Refractive index of hard coat layer>refractive index of transparent support>refractive index of low refractive index layer

The antireflection film of the invention is not particularly limited to these layer structures so long as it can reduce the reflectance due to optical interference.

The high refractive index layer may be a light diffusive layer without an antiglare property. Whereas, the antistatic layer is preferably a layer containing electrically conductive polymer particles or metal oxide fine particles (e.g., SnO₂, ITO). It can be provided by coating, an atmospheric plasma processing, or the like.

### [Hard Coat Layer]

The optical film of the invention has a hard coat layer on a transparent support, and preferably further has a low refractive index layer thereon. Further, it can also be an antireflection film in which the hard coat layer is an antiglare hard coat layer according to the required performances. In the antireflection film of the invention, a non-antiglare hard coat layer can also be further provided as the underlying layer of the antiglare hard coat layer for the purpose of improving the film strength.

The total sum of the film thicknesses of the hard coat layer is preferably 1 to 40 μm. When it is less than 1 μm, the necessary scratch resistance unfavorably tends to be decreased. On the other hand, when the total sum of the layer thicknesses of the hard coat layer exceeds 40 μm, problems unfavorably start to occur in brittleness or film curling.

### [Binder Polymer]

The binder to be used for the hard coat layer is preferably a polymer having a saturated hydrocarbon chain or a polyether chain as the main chain, and further preferably a polymer having a saturated hydrocarbon chain as the main chain. Whereas, the binder polymer preferably has a crosslinked structure.

(Binder polymer having a saturated hydrocarbon chain as the main chain)

The binder polymer having a saturated hydrocarbon chain as the main chain is preferably a polymer of monomers having ethylenically unsaturated groups. The binder polymer having a saturated hydrocarbon chain as the main chain, and having a crosslinked structure is preferably a (co)polymer of monomers each having one or more ethylenically unsaturated groups.

In order for the hard coat layer to have a high refractive index, it is preferable that the monomer structure includes therein an aromatic ring, and at least one atom selected from halogen atoms other than fluorine, a sulfur atom, a phosphorus atom, and a nitrogen atom.

As the monomers each having one or more ethylenically unsaturated groups (multifunctional compounds (a)), mention may be made of (meth)acrylic acid esters of polyhydric alcohols (e.g., ethylene glycol di(meth)acrylate, 1,4-cyclohexanediol di(meth)acrylate, pentaerythritol tetra(meth)acrylate, pentaerythritol tri(meth)acrylate, trimethylolpropane tri(meth)acrylate, trimethylolethane tri(meth)acrylate, dipentaerythritol tetra(meth)acrylate, dipentaerythritol penta(meth)acrylate, dipentaerythritol hexa(meth)acrylate, 1,2,3-cyclohexanetiol tri(meth)acrylate, polyurethane polyacrylate, and polyester polyacrylate), the ethylene oxide-modified products of esters, vinylbenzene and derivatives thereof {e.g., 1,4-divinylbenzene, 4-vinylbenzoic acid-2-acryloylethyl ester, and 1,4-divinylcyclohexanone}, vinylsulfone (e.g., divinylsulfone), and (meth)acrylamide (e.g., methylenebisacrylamide). The monomers may be used in combination of two or more thereof. Alternatively, they may be multifunctional monomers (e.g., dendrimers) of a (three-dimensional) dendric structure.

Specific examples of the high refractive index monomer may include bis(4-methacryloylthiophenyl) sulfide, vinylnaphthalene, vinylphenyl sulfide, and 4-methacryloxyphenyl-4′-methoxyphenylthioether. These monomers may also be used in combination of two or more thereof.

In place of the monomer having one or more ethylenically unsaturated groups, or in addition to this, a crosslinkable functional group is introduced into the polymer using a monomer having a crosslinkable functional group. By the reaction of the crosslinkable functional group, a crosslinked structure may be introduced into the binder polymer.

Examples of the crosslinkable functional group may include an isocyanate group, an epoxy group, an aziridine group, an oxazoline group, an aldehyde group, a carbonyl group, a hydrazine group, a carboxyl group, a methylol group, and an active methylene group. Vinyl sulfonic acid, acid anhydride, a cyano acrylate derivative, melamine, etherified methylol, ester, and urethane, and a metal alkoxide such as tetramethoxysilane can also be utilized as monomers for introducing the crosslinked structure. A functional group showing crosslinkability as a result of the dissolution reaction, such as a blocked isocyanate group, may also be used. Namely, in the invention, the crosslinkable functional group is not required to be the one which immediately shows the reaction, but it may be the one which shows the reactivity as a result of decomposition.

The binder polymers having the crosslinkable functional groups can form a crosslinked structure by heating after coating.

The invention is characterized in that a compound which is cured by a heat energy and a light energy is used in the coating composition. Therefore, it is preferable to use the monomer having one or more ethylenically unsaturated groups and the monomer having a moiety reacting with the crosslinkable functional group in mixture. Further, it is preferable to use the compounds having one or more ethylenically unsaturated groups and a moiety reacting with the crosslinkable functional group in one molecule as shown below. Examples of the compound having one or more ethylenically unsaturated groups and a moiety reacting with the crosslinkable functional group in one molecule are shown below, but not limited thereto.

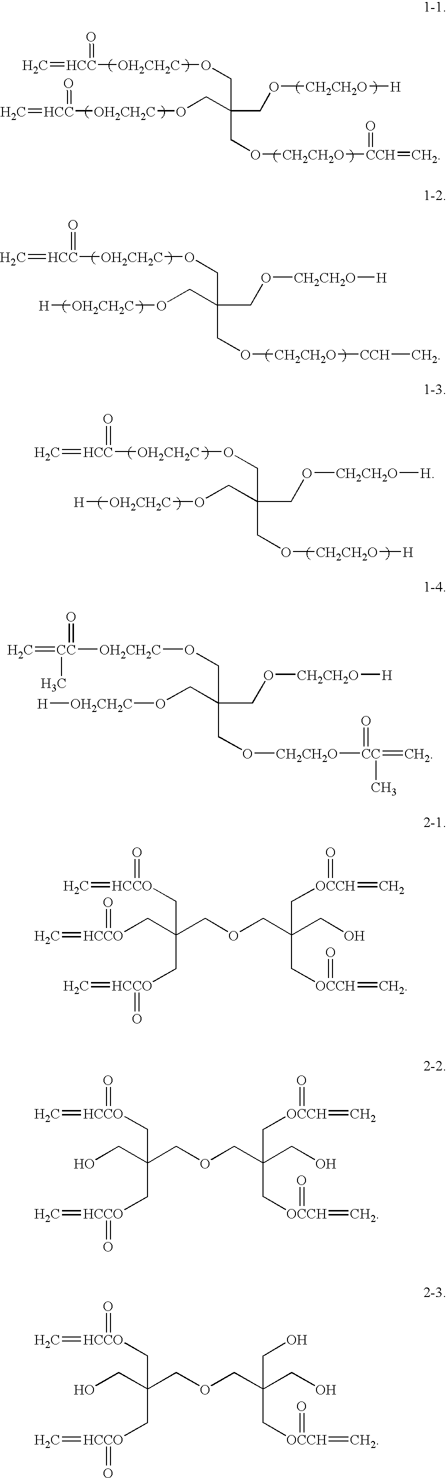

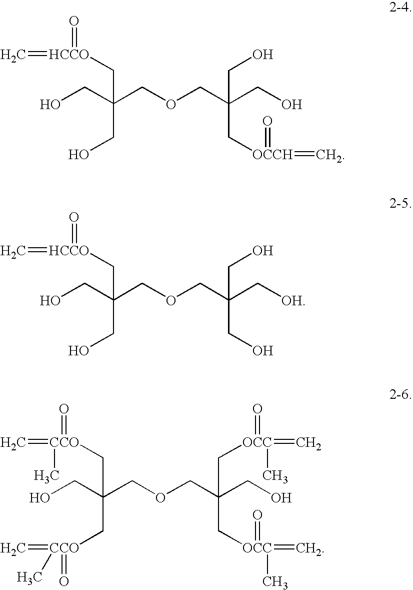

In addition to the exemplified compounds, there can also be preferably used ethylenically unsaturated group-containing compounds containing alcohol moieties (—OH) obtainable by esterification of polyhydric alcohols such as BOLTORN H20, BOLTORN H2003, BOLTORN H2004, BOLTORN H30, BOLTRORN H40, and BOLTORN P1000 from Pesrstorp Co., with (meth)acrylic acid chloride in the presence of Et3N, or hydration and condensation of an ethylenically unsaturated group-containing carboxylic acid in the presence of an acid catalyst. The number of alcohol moieties (—OH) contained therein can be arbitrarily selected by adjusting the synthesis method. The number of alcohol moieties (—OH) is preferably 1 to 60, in particular preferably 1 to 30, and further preferably 1 to 5.

Examples of the ethylenically unsaturated group-containing compounds containing alcohol moieties (—OH), which can be used in the present invention, are shown below, but not limited thereto.

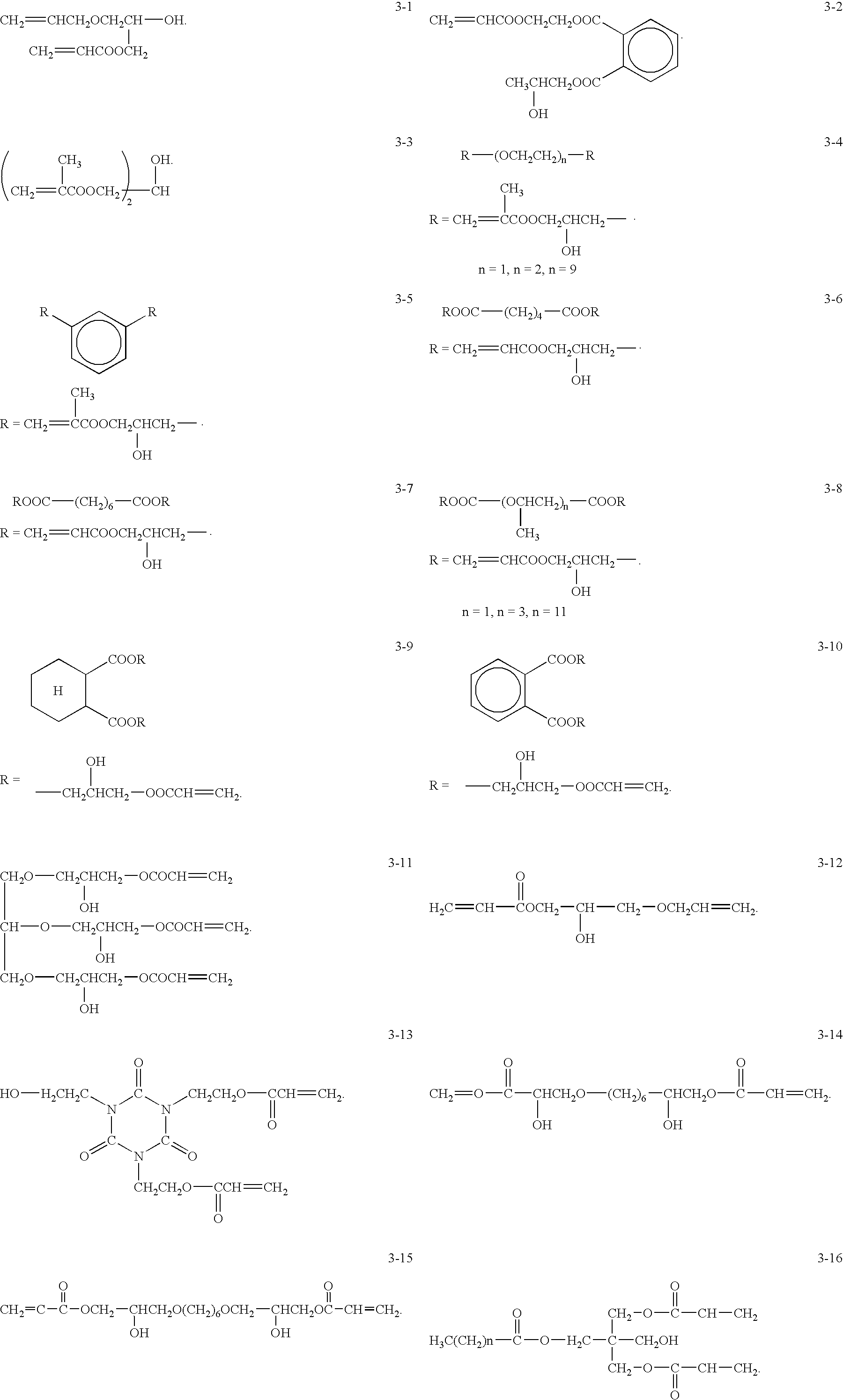

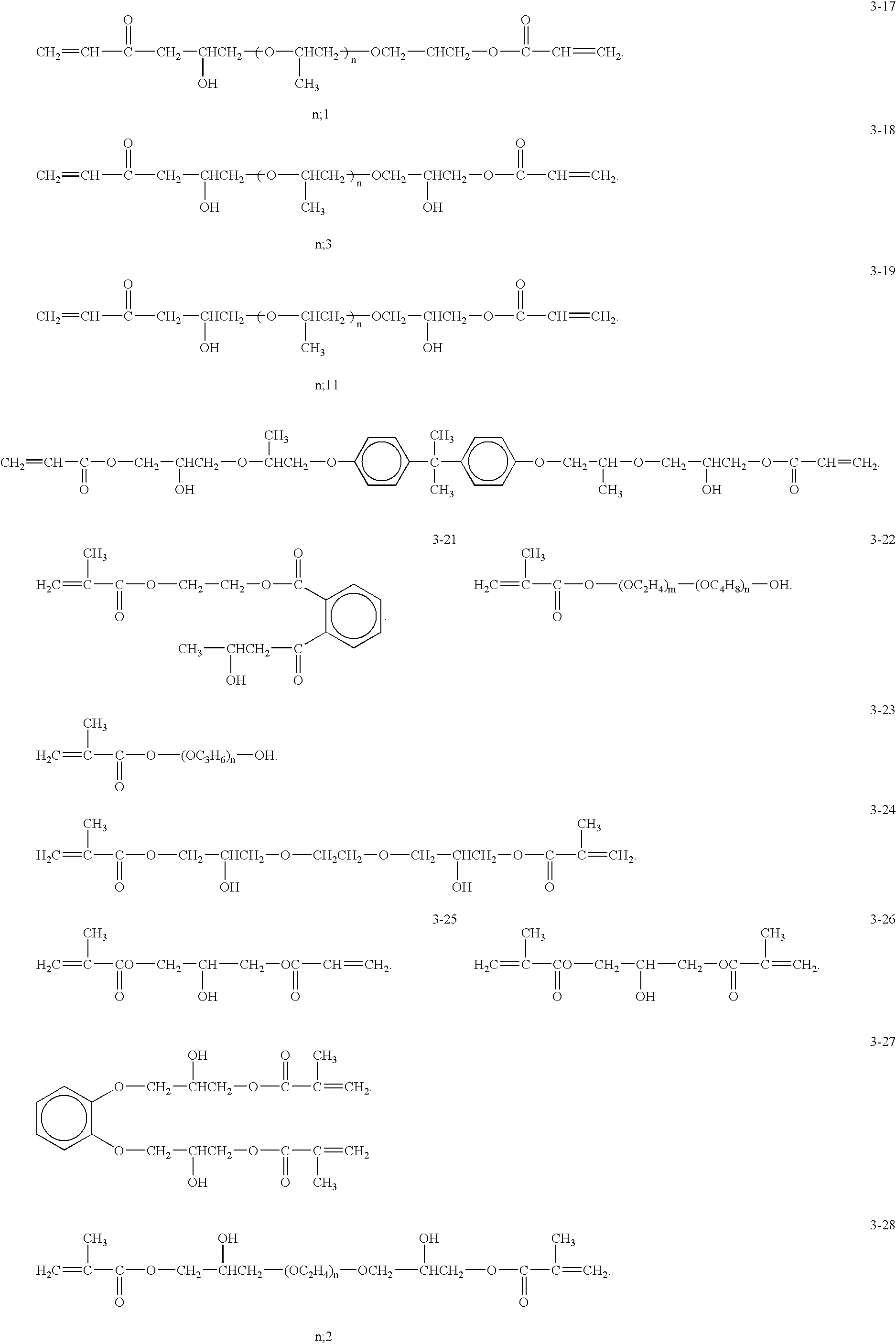

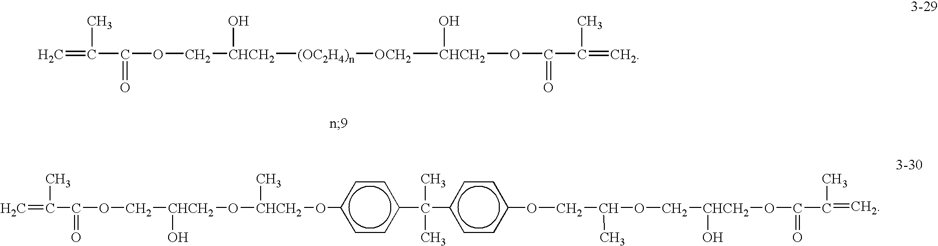

### (Polymerization Initiator)

Polymerization of the monomers having ethylenically unsaturated groups can be carried out through irradiation with ionizing radiation or heating in the presence of a light radical initiator or a heat radical initiator. Therefore, a hard coat layer can be formed in the following manner. A coating solution containing monomers having ethylenically unsaturated groups, a light radical initiator or a heat radical initiator, metal oxide particles, and if required, mat particles is prepared. The coating solution is coated on a transparent support, and then, cured by the polymerization reaction due to ionizing radiation or heat.

(Radical Photopolymerization Initiator)

As radical photopolymerization initiators, mention may be made of acetophenones, benzoins, benzophenones, phosphine oxides, ketals, anthraquinones, thioxanthones, azo compounds, peroxides (the ones described in JP-A-2001-139663, and the like), 2,3-dialkyldione compounds, disulfide compounds, fluoroamine compounds, aromatic sulfoniums, lophine dimers, onium salts, borate salts, active halogen compounds, and the like.

Examples of acetophenones may include: 2,2-diethoxy acetophenone, p-dimethyl acetophenone, 1-hydroxydimethyl phenyl ketone, 1-hydroxy cyclohexyl phenyl ketone, 2-methyl-4-methylthio-2-morpholino propiophenone, and 2-benzyl-2-dimethylamino-1-(4-morpholino phenyl)-butanone.

Examples of benzoins may include benzoin benzenesulfonic acid ester, benzoin toluenesulfonic acid ester, benzoin methyl ether, benzoin ethyl ether, and benzoin isopropyl ether.

Examples of benzophenones may include benzophenone, 2,4-dichlorobenzophenone, 4,4-dichlorobenzophenone, and p-chlorobenzophenone. Examples of phosphine oxides may include 2,4,6-trimethyl benzoyldiphenylphosphine oxide.

Various examples are described in SAISHIN UV KOUKA GIJYUTSU, {publisher; Kazuhiro Takausu, publisher; Technical Information Institute Co., Ltd., published in 1991}, p. 159, and SHIGAISEN KOUKA SYSTEM, (written by Kiyomi Kato, 1989, published by SOGO GIJYUTSU CENTER CO.), p. 65 to 148, and are useful for the invention.

Preferred examples of commercially available light cleavage type radical photopolymerization initiators may include “IRGACURE (651, 184, 907)”, and the like manufactured by Nihon Ciba-Geigy, K. K.

The photopolymerization initiator is used in an amount preferably in the range of 0.1 to 15 parts by mass, and more preferably in the range of 1 to 10 parts by mass per 100 parts by mass of the multifunctional monomer. (In this specification, mass ratio is equal to weight raio.)

### [Photosensitizer]

In addition to the photopolymerization initiator, a photosensitizer may also be used. Specific examples of the photosensitizer may include n-butylamine, triethylamine, tri-n-butylphosphine, Michler's ketone, and thioxanthone.

### (Heat Radical Initiator)

As the heat radical initiators, organic or inorganic peroxides, organic azo and diazo compounds, and the like are usable.

Specifically, mention may be made of: organic peroxides such as benzoyl peroxide, halogen benzoyl peroxide, lauroyl peroxide, acetyl peroxide, dibutyl peroxide, cumene hydroperoxide, and butyl hydroperoxide, inorganic peroxides such as hydrogen peroxide, ammonium persulfate, and potassium persulfate; azo compounds such as 2,2′-azobis(isobutyronitrile), 2,2′-azobis(propionitrile), and 1,1′-azobis(cyclohexanedinitrile); and diazo compounds such as diazoaminobenzene and p-nitrobenzene diazonium, and the like.

### (Binder Polymer having a Polyether as the Main Chain)

The binder polymer having a polyether as the main chain is preferably a ring-opening polymer of a multifunctional epoxy compound. The ring-opening polymerization of a multifunctional epoxy compound can be carried out through irradiation with ionizing radiation or heating in the presence of a light acid generator or a heat acid generator.

Therefore, a coating solution containing a multifunctional epoxy compound, a light acid generator or a heat acid generator, mat particles, and metal oxide particles is prepared. The coating solution is applied on the transparent support, and then, cured by the polymerization reaction by ionizing radiation or heat. Thus, a hard coat layer can be formed.

### [Metal Oxide Particles]

To respective layers including the hard coat layer formed on the support, metal oxide particles are preferably added. Te metal oxide particles to be added to respective layers may be the same or different. The type and the amount of the metal oxide particles to be added are preferably adjusted according to the required performances such as the refractive index, the film strength, the film thickness, and the coatability of each layer.

The shape of the metal oxide particles to be used in the invention has no particular restriction. For example, any of spherical, plate-like, fibrous, rod-like, amorphous, and hollow shapes is preferred.

Specific preferred examples of the particles may include, for example, particles of inorganic compounds such as silica particles and TiO₂ particles; and resin particles such as crosslinked acrylic particles, crosslinked styrene particles, melamine resin particles, and benzoguanamine resin particles.

The silica particles may be spherical particles with a primary particle diameter of 0.5 to 10 μm. Particularly, cohesive silica obtained from formation of agglomerate of particles with a primary particle diameter of several nanometers is preferred in terms of being capable of preventing the whitening and imparting the proper surface haze with stability.

The cohesive silica can be obtained by synthesis by the neutralization reaction of sodium silicate and sulfuric acid, a so-called wet method. However, the method is not limited thereto. The wet method can be further largely classified into a sedimentation method and a gelation method. However, in the invention, either method is acceptable. The secondary particle diameter of the cohesive silica preferably falls within the range of 0.1 to 10.0 μm. However, it is selected in combination with the layer thickness of the hard coat layer containing particles.

The value obtained by dividing the secondary particle diameter of the cohesive silica by the film thickness of the hard coat layer is preferably 0.1 to 1.0, and more preferably 0.3 to 0.8.

Whereas, the type of the metal oxide particles also has no particular restriction. However, amorphous ones are preferably used. The particles preferably include metal oxides, nitrides, sulfides, or halides, and in particular preferably metal oxides. As metal atoms, mention may be made of Zr, Na, K, Mg, Ca, Ba, Al, Zn, Fe, Cu, Ti, Sn, In, W, Y, Sb, Mn, Ga, V, Nb, Ta, Ag, Si, B, Bi, Mo, Ce, Cd, Be, Pb, and Ni.

The average particle diameter of the metal oxide particles is set at a value within the range of, preferably 1 nm to 200 nm, more preferably 1 nm to 100 nm, and further preferably 1 nm to 80 nm in order to obtain a transparent cured film. Herein, the average particle diameter of the particles is measured by means of a Coulter Counter.

The surface of the metal oxide particle is also preferably subjected to a silane coupling treatment or a titanium coupling treatment. On the metal oxide particle surface, a surface treatment agent having a functional group reactable with a binder species is preferably used.

The amount of the metal oxide particles to be added is preferably 10 to 90%, more preferably 20 to 80%, and in particular preferably 30 to 75% based on the total mass of the hard coat layer. The amount of the metal oxide particles to be added can be appropriately selected among the same amount range in either case of an antiglare hard coat layer and a smooth hard coat layer described later.

Incidentally, such a metal oxide particle has a particle diameter sufficiently smaller than the wavelength of light, and hence no scattering occurs. Thus, the dispersion of the filler dispersed in a binder polymer behaves as an optically uniform substance.

The method for using the metal oxide particles in the invention has no particular restriction. The metal oxide particles can be used, for example, in dry state. Alternatively, it can also be used in a state dispersed in water or an organic solvent.

### [Dispersion Stabilizer]

In the invention, for the purpose of inhibiting the sedimentation or precipitation of metal oxide particles, a dispersion stabilizer is preferably used in combination. As the dispersion stabilizers, there can be used polyvinyl alcohol, polyvinyl pyrrolidone, cellulose derivatives, polyamide, phosphoric acid ester, polyether, a surfactant, a hydrolysate and/or partially condensate of an organosilane compound, a silane coupling agent, a titanium coupling agent, and the like. Particularly, the silane coupling agent is preferable because the film after curing is strong.

The amount of the silane coupling agent to be added as a dispersion stabilizer has no particular restriction. However, for example, it is preferably set at a value of 1 part by mass or more per 100 parts by mass of the metal oxide particles. Further, the method for adding the silane coupling agent as a dispersion stabilizer also has no particular restriction. However, the previously hydrolyzed one may be added thereto. Alternatively, the following method can also be adopted: the silane coupling agent as a dispersion stabilizer and metal oxide particles are mixed, further followed by hydrolysis and condensation. However, the latter is more preferred.

As described above, the hydrolysate and/or the partially condensate of an organosilane compound can be used as a dispersion stabilizer of the metal oxide particles. Other than this, further, it can also be used as an additive for preparing the coating solution, as a part of the matrix forming components of respective layers, such as a curable compound of a low refractive index layer forming composition described later. Particularly, in the invention, it is preferable to use a hydrolysate and/or a partial condensate of a specific organosilane compound for the low refractive index layer. This will be described in details later.

### [Antiglare Hard Coat Layer]

Then, an antiglare hard coat layer to be preferably used in the invention will be described. The antiglare hard coat layer is formed of a binder for imparting the hard coat property, mat particles for imparting the antiglare property, metal oxide particles for achieving a high refractive index, preventing crosslinking shrinkage, and achieving high strength, and the like.

### (Mat Particles)

In the antiglare hard coat layer, mat particles having an average particle diameter of 1.0 to 10.0 μm, and preferably 1.5 to 7.0 μm, such as inorganic compound particles or light transmissive resin particles, larger than cohesive silica particles and filler particles, may be allowed to be contained for the purpose of imparting the antiglare property thereto.

Specific preferred examples of the particles may include, for example, particles of inorganic compounds such as silica particles and TiO₂ particles; and resin particles such as crosslinked acrylic particles, crosslinked styrene particles, melamine resin particles, and benzoguanamine resin particles.

The silica particles may be spherical particles with a primary particle diameter of 0.5 to 10 μm. Particularly, cohesive silica obtained from formation of agglomerate of particles with a primary particle diameter of several nanometers is preferred in terms of being capable of preventing the whitening and imparting the proper surface haze with stability.

The cohesive silica can be obtained by synthesis by the neutralization reaction of sodium silicate and sulfuric acid, a so-called wet method. However, the method is not limited thereto. The wet method can be further largely classified into a sedimentation method and a gelation method. However, in the invention, either method is acceptable. The secondary particle diameter of the cohesive silica preferably falls within the range of 0.1 to 10.0 μm. However, it is selected in combination with the layer thickness of the hard coat layer containing particles.

Particularly, the value obtained by dividing the secondary particle diameter of the cohesive silica by the film thickness of the hard coat layer is preferably 0.1 to 1.0, and more preferably 0.3 to 0.8.

The light transmissive resin particles usable in combination with the silica particles, preferably, cohesive silica particles will be described.

Specific preferable examples of the light transmissive resin particles usable in combination may include, for example, resin particles such as ((meth)acrylate) particles, crosslinked poly((meth)acrylate) particles, polystyrene particles, crosslinked polystyrene particles, crosslinked poly(acrylic-styrene) particles, melamine resin particles, and benzoguanamine resin particles. Out of these, crosslinked polystyrene particles, crosslinked poly((meth)acrylate) particles, and crosslinked poly(acrylic-styrene) particles are preferred. Particularly, crosslinked poly((meth)acrylate) particles and crosslinked poly(acrylic-styrene) particles are most preferably used. By adjusting the refractive index and the amount added of the light transmissive resin according to the refractive index of each light transmissive fine particles selected from these particles, it is possible to set the internal haze and the surface haze within a desirable range.

The average particle diameter of the light transmissive resin particles usable in combination is preferably 0.5 to 10 μm, and more preferably 2.0 to 6.0 μm.

As the light transmissive resin particles usable in combination, in order to improve the scratch resistance, the compression strength of the resin particles is preferably 2.2 to 10.0 kgf/mm², and more preferably 2.5 to 8.0 kgf/mm². In order to enhance the compression strength of the resin particles, it is effective to select a crosslinking agent and enhance the crosslinking degree.

The mat particles can be used in any of spherical and amorphous forms. Further, different two or more types of mat particles may be used in combination.

The mat particles are contained in the antiglare hard coat layer so that the amount of the mat particles in the formed antiglare hard coat layer is preferably 10 to 1000 mg/m², and more preferably 30 to 1000 mg/m².

Whereas, a particularly preferred embodiment is an embodiment in which crosslinked styrene particles are used as mat particles, and the crosslinked styrene particles with a larger particle diameter than the half of the film thickness of the antiglare hard coat layer account for 40 to 100% of the total crosslinked styrene particles.

Herein, the particle diameter distribution of the mat particles is measured by a Coulter Counter method, and the measured distribution is converted into the particle count distribution.

Whereas, two or more types of mat particles having different particle diameters may be used in combination.

This enables the following: mat particles with a larger particle diameter impart the antiglare property, while mat particles with a smaller particle diameter impart another optical characteristic. For example, when the antireflection film is bonded onto a high definition display apparatus of 133 dpi or more, it is required to cause no fault in optical performance referred to as glare. This derives from the fact that pixels are enlarged or shrank by the unevenness present on the film surface, resulting in loss of the uniformity of the display performance. This can be largely improved by using mat particles with a particle diameter smaller by 5 to 50% than that of the mat particles imparting the antiglare property.

Further, for the particle diameter distribution of the mat particles, monodispersion is preferred. The closer the particle diameters of all the particles are to the same diameter, the better they are. For example, when particles with a particle diameter different from the average particle diameter by 20% or more are defined as coarse particles, the proportion of the coarse particles is preferably 1% or less, more preferably 0.1% or less, and further preferably 0.01% or less, of the total number of particles. The mat particles having such a particle diameter distribution can be obtained by classification after the general synthesis reaction. By increasing the frequency of classification, or enhancing the degree, it is possible to obtain mat particles having a more preferable distribution.

### (Metal Oxide Particles)

The antiglare hard coat layer preferably contains, in addition to the mat particles, the one including an oxide of at least one metal selected from titanium, zirconium, aluminum, indium, zinc, tin, and antimony, and having an average particle diameter set within the range of 1 nm to 200 nm, more preferably 1 nm to 100 nm, and further preferably 1 nm to 80 nm, in order to increase the refractive index of the layer.

Whereas, conversely, for the antiglare layer using high refractive index mat particles in order to increase the difference in refractive index from the mat particles, an oxide of silicon is also preferably used in order to keep the refractive index of the layer lower. The preferred particle diameter is equal to that of the inorganic filler.

Specific examples of the metal oxide particles for use in the antiglare hard coat layer may include TiO₂, ZrO₂, Al₂O₃, In₂O₃, ZnO, SnO₂, Sb₂O₃, ITO (indium-tin oxide), and SiO₂. TiO₂ and ZrO₂ are particularly preferred in terms of achieving a higher refractive index. The surface of the metal oxide particle is also preferably subjected to a silane coupling treatment or a titanium coupling treatment as described above. On the filler surface, a surface treatment agent having a functional group reactable with a binder is preferably used.

Incidentally, such a metal oxide particle has a particle diameter sufficiently smaller than the wavelength of light, and hence no scattering occurs. Thus, the dispersion of the filler dispersed in a binder polymer behaves as an optically uniform substance.

The total refractive index of the mixture of the binder and the metal oxide particles of the antiglare hard coat layer in the antireflection film of the invention is preferably 1.48 to 2.00, and more preferably 1.50 to 1.80. In order for the refractive index to fall within the foregoing range, it is essential only that the types and the contents of the binder and the metal oxide particles are selected. How they are selected can be previously known experimentally.

### (Surfactant)

To the antiglare hard coat layer in the invention, a surfactant of any of fluorine type and silicone type, or both of them are preferably contained in a coating composition for forming the antiglare hard coat layer in order to suppress the defective surface conditions such as, particularly, uneven coating, uneven drying, and point defects, and ensure the uniformity of surface conditions. Particularly, a fluorine type surfactant in a smaller amount exhibits effects of improving the defective surface conditions of uneven coating, uneven drying, and point defects of the antireflection film of the invention. Therefore, it can be preferably used.

Preferred examples of the fluorine type surfactant may include perfluoroalkyl group-containing oligomers such as “MEGAFAC F-171”, “MEGAFAC F-172”, “MEGAFAC F-173”, and ““MEGAFAC F-176”, (all are trade names), manufactured by Dai-Nippon Ink & Chemicals Inc. As the silicone type surfactants, mention may be made of polydimethylsiloxane and the like, of which the side chains or the ends of the main chains are modified with various substituents of oligomers or the like, such as ethylene glycol and propylene glycol.

However, by using the surfactants as described above, a F atom-containing functional group and/or a Si atom-containing functional group segregates on the antiglare hard coat layer surface. Accordingly, the surface energy of the antiglare hard coat layer is reduced. Thus, when a low refractive index layer is overcoated on the antiglare hard coat layer, the antireflection performance may be reduced. This is presumably due to the fact that visually undetectable microscopic ununiformity of the film thickness of the low refractive index layer is caused by the reduction of the wettability of the coating solution for forming the low refractive index layer onto the antiglare hard coat layer surface.

In order to solve such a problem, it is effective to adjust the structure and the amount added of a fluorine type and/or silicone type surfactant, and thereby to control the surface energy of the antiglare hard coat layer to preferably 25 to 70 mN·m⁻¹, and more preferably 35 to 70 mN·m⁻¹. Further, as described later, it is more effective that a solvent with a boiling point of 100° C. or less accounts for 50 to 100% by mass of the coating solvent for the low refractive index layer.

Whereas, in order to implement the foregoing surface energy, it is preferable to achieve the following: F/C which is the ratio between the peak derived from a fluorine atom and the peak derived from a carbon atom measured with an X-ray photoelectron spectroscopy is 0.40 or less, and/or that Si/C which is the ratio between the peak derived from a silicon atom and the peak derived from a carbon atom is 0.30 or less.

The film thickness of the antiglare hard coat layer is preferably 1 to 10 μm, and more preferably 1.2 to 6 μm.

### [Smooth Hard Coat Layer]

For the antireflection film of the invention, not antiglare but so-called smooth hard coat layer is also preferably used for the purpose of further improving the film strength. The smooth hard coat layer is more preferably used in combination with the antiglare hard coat layer, and it is coated between the transparent support and the antiglare hard coat layer.

The materials to be used for the smooth hard coat layer are the same as those mentioned for the antiglare hard coat layer except for using the mat particles for imparting the antiglare property. The layer is formed of a binder, and preferably metal oxide particles.

For the smooth hard coat layer in the invention, as the metal oxide particles, silica or alumina is preferred in terms of strength and general versatility. Particularly, silica is preferred. Further, the surfaces of the metal oxide particles are preferably subjected to a silane coupling treatment. A surface treatment agent having a functional group reactable with a binder species on the filler surface is preferably used.

The film thickness of the smooth hard coat layer is preferably 1 to 10 μm, and more preferably 1.2 to 6 μm.

### [Low Refractive Index Layer]

The low refractive index layer of the antireflection film of the invention will be described below.

The refractive index of the low refractive index layer usable in the invention falls within the range of preferably 1.38 to 1.49, and more preferably 1.38 to 1.44.

Further, the low refractive index layer preferably satisfies the following mathematical expression (1) in terms of the reduction of the reflectance.

(jλ/4)×0.7<n1d1<(jλ/4)×1.3 Mathematical expression (1):

where in the formula, j is a positive odd number, n1 is the refractive index of the low refractive index layer, and d1 is the film thickness (nm) of the low refractive index layer; and λ is the wavelength, and falls within the range of 500 to 550 nm. The film thickness (d1) of the low refractive index layer is preferably 70 to 150 nm, further preferably 80 to 120 nm, and further, most preferably 85 to 115 nm.

Incidentally, the mathematical expression (1) being satisfied means that j (a positive odd number, generally 1) satisfying the mathematical expression (1) within the foregoing wavelength range is present.

Respective materials for forming the low refractive index layer in the invention will be described below.

The low refractive index layer for use in the invention is formed by a composition for forming a low refractive index layer containing a binder polymer, at least one polymerization initiator, and a curable compound having an ethylenically unsaturated group. Further, it is preferably configured such that the polymerization initiator and the curable compound are localized in the lower part of the low refractive index layer.

Preferably, the polymerization initiator (C) is a heat and/or photo-degradable initiator. Whereas, preferably, the binder polymer (A) is a fluorine-containing polymer having a crosslinkable or polymerizable functional group, and the curable compound (B) is a non-fluorine-containing compound.

### [Binder Polymer] (A)

### {Fluorine-Containing Polymer}

In terms of the improvement of the productivity in the case where a roll film is coated and cured while being transferred in a web form, or other cases, the fluorine-containing polymer is preferably a polymer which is crosslinked by heat or ionizing radiation, and has, in the form of a cured coating film, a kinetic friction coefficient of the film of 0.03 to 0.20, a contact angle with water of 90 to 120°, and a sliding angle of pure water of 70° or less.

Whereas, when the antireflection film of the invention is mounted on a display apparatus, a lower peeling force from a commercially available adhesive tape makes a sticker or a memo sheet more likely to be peeled off after bonding. Therefore, the peeling force is preferably 500 gf or less, more preferably 300 gf or less, and most preferably 100 gf or less. Whereas, the higher the surface hardness measured by means of a micro hardness meter is, the less the surface is likely to be scratched. Therefore, the surface hardness is preferably 0.3 GPa or more, and more preferably 0.5 GPa or more.

The fluorine-containing polymers for use in the low refractive index layer is preferably a fluorine-containing compound containing a crosslinkable or polymerizable functional group. Examples thereof may include hydrolysates and dehydrated condensates of perfluoroalkyl group-containing silane compounds {e.g., (heptadecafluoro-1,1,2,2-tetrahydrodecyl)triethoxysilane}, and in addition, fluorine-containing copolymers of fluorine-containing monomers and monomers for providing crosslinkable groups. For a fluorine-containing copolymer, the main chain is preferably formed of only carbon atoms. Namely, it is preferable that the main chain skeleton does not have an oxygen atom or a nitrogen atom.

The fluorine atom content of the fluorine-containing polymer is preferably 35 to 80 mass %.

As specific examples of the fluorine-containing monomers, for example, mention may be made of fluoroolefins (e.g. fluoroethylene, vinylidene fluoride, tetrafluoroethylene, perfluorooctyl ethylene, hexafluoropropylene, and perfluoro-2,2-dimethyl-1,3-dioxole), partially or fully fluorinated alkyl ester derivatives of (meth)acrylic acid [e.g., “BISCOAT 6FM” {manufactured by Osaka Organic Chemical Industry, Ltd.}, and “M-2020” {manufactured by Daikin Industries, Ltd.}], and fully or partially fluorinated vinyl ethers. However, perfluoroolefins are preferred. Hexafluoropropylene is particularly preferred from the viewpoints of the refractive index, the solubility, the transparency, the availability, and the like. An increase in the composition ratio of the fluorine-containing monomers can reduce the refractive index. However, it reduces the film strength. In the invention, the fluorine-containing monomers are introduced so that the fluorine content of the copolymer is preferably 20 to 60 mass %, more preferably 25 to 55 mass %, and in particular preferably 30 to 50 mass %.

As the structural units for providing a crosslinkable group, mainly, mention may be made of the units shown by the following items (a), (b), and (c):

(a) A structural unit obtained by polymerization of monomers previously having a self-crosslinkable functional group in the molecule, such as glycidyl (meth)acrylate and glycidyl vinyl ether;

(b) A structural unit obtained by polymerization of monomers having a carboxyl group, a hydroxyl group, an amino group, a sulfo group, or the like (e.g., (meth)acrylic acid, methylol (meth)acrylate, hydroxyalkyl (meth)acrylate, allyl acrylate, hydroxyethyl vinyl ether, hydroxybutyl vinyl ether, maleic acid, and crotonic acid). It is described in JP-A-10-25388 and JP-A-10-147739 that a crosslinking structure can be introduced after copolymerization in this case; and

(c) A structural unit obtained by allowing a compound having a group reacting with the functional group (a) or (b), and another crosslinkable functional group in the molecule to react with the structure unit (a) or (b) (a structural unit which can be synthesized, for example, by a technique of allowing acrylic acid chloride to act on a hydroxy group).

The structural unit of the item (c) is preferably configured such that the crosslinkable functional group is a photopolymerizable group particularly in the invention. Examples of the photopolymerizable group may include a (meth)acryloyl group, an alkenyl group, a cinnamoyl group, a cinnamylideneacetyl group, a benzalacetophenone group, a styrylpyridine group, an a-phenylmaleimide group, a phenylazide group, a sulfonylazide group, a carbonylazide group, a diazo group, an o-quinonediazide group, a furylacryloyl group, a cumarine group, a pyrone group, an anthracene group, a benzophenone group, a stilbene group, a dithiocarbamate group, a xanthate group, a 1,2,3-thiadiazole group, a cyclopropene group, and an azadioxabicyclo group. Not only one but also two or more of these may be used. Out of these, a (meth)acryloyl group and a cinnamoyl group are preferred, and a (meth)acryloyl group is in particular preferred.

Non-limiting specific methods for preparing a photopolymerizable group-containing copolymer may include the following methods:

(1) A method in which a crosslinkable functional group-containing copolymer containing a hydroxyl group is allowed to react with (meth)acrylic acid chloride for esterification;

(2) A method in which a crosslinkable functional group-containing copolymer containing a hydroxyl group is allowed to react with a (meth)acrylic acid ester containing an isocyanate group for urethanation;

(3) A method in which a crosslinkable functional group-containing copolymer containing an epoxy group is allowed to react with (meth)acrylic acid for esterification; and

(4) A method in which a crosslinkable functional group-containing copolymer containing a carboxyl group is allowed to react with a (meth)acrylic acid ester containing an epoxy group for esterification.

Incidentally, the amount of the photopolymerizable groups to be introduced can be arbitrarily adjusted. From the viewpoints of the coating film surface condition stability/the reduction of defective surface conditions in the presence of inorganic fine particles/film strength improvement, and the like, it is also preferable that a carboxyl group, a hydroxyl group, or the like is left in a given amount.

Alternatively, there may also be used not only the copolymers of the fluorine-containing monomers and monomers for providing crosslinkable groups, but also copolymers resulting from copolymerization of monomers other than these. A plurality of these vinyl monomers may be combined according to the purposes. The vinyl monomers are introduced in a total amount preferably in the range of 0 to 65 mol %, more preferably in the range of 0 to 40 mol %, and in particular preferably in the range of 0 to 30 mol % based on the amount of the copolymer.

The monomers usable in combination have no particular restriction. Examples thereof may include: olefins (such as ethylene, propylene, isoprene, vinyl chloride, and vinylidene chloride), acrylic acid esters (such as methyl acrylate, ethyl acrylate, and 2-ethylhexyl acrylate), methacrylic acid esters (such as methyl methacrylate, ethyl methacrylate, butyl methacrylate, and ethylene glycol dimethacrylate), styrene derivatives (such as styrene, divinylbenzene, vinyl toluene, and ac-methyl styrene), vinyl ethers (such as methyl vinyl ether, ethyl vinyl ether, cyclohexyl vinyl ether, hydroxyethyl vinyl ether, and hydroxybutyl vinyl ether), vinyl esters (such as vinyl acetate, vinyl propionate, and vinyl cinnamate), unsaturated carboxylic acids (such as acrylic acid, methacrylic acid, crotonic acid, maleic acid, and itaconic acid), acrylamides (such as N-tert-butylacrylamide and N-cyclohexylacrylamide), methacrylamides, and acrylonitrile derivatives.

As binders preferably usable for the low refractive index layer of the antireflection film of the invention, mention may be made of the copolymers described in [0030] to [0047] of JP-A-2004-45462.

The particularly useful fluorine-containing polymers in the invention are random copolymers of perfluoroolefins and vinyl ethers or vinyl esters. In particular, preferably, they each independently have a crosslinkable group {a radical reactive group such as a (meth)acryloyl group, an epoxy group, a ring opening polymerizable group such as an oxetanyl group}, or the like. These crosslinking reactive group-containing polymerization unit accounts for preferably 5 to 70 mol %, and in particular preferably 30 to 60% of the total polymerization units of the polymer.

As preferred polymers, mention may be made of the ones described in JP-A-2002-243907, JP-A-2002-372601, JP-A-2003-26732, JP-A-2003-222702, JP-A-2003-294911, JP-A-2003-329804, JP-A-2004-4444, and JP-A-2004-45462.

Whereas, the fluorine-containing polymer for use in the invention preferably includes a polysiloxane structure introduced therein for the purpose of imparting the stain proof property. The method for introducing a polysiloxane structure has no particular restriction. However, preferred examples thereof may include a method in which polysiloxane block copolymerization components are introduced by the use of a silicone macroazo initiator, as described in each of JP-A-6-93100, JP-A-11-189621, JP-A-11-228631, and JP-A-2000-313709; a method in which polysiloxane graft copolymerization components are introduced by the use of a silicone macromer as described in each of JP-A-2-251555 and JP-A-2-308806. As particularly preferred compounds, mention may be made of the polymers of Examples 1, 2, and 3 of JP-A-11-189621, or the copolymers A-2 and A-3 of JP-A-2-251555. These polysiloxane components are preferably in an amount of preferably 0.5 to 10 mass %, and in particular preferably 1 to 5 mass % in the polymer.

The preferred molecular weight of the polymer preferably usable in the invention is 5000 or more, preferably 10000 to 500000, and most preferably 15000 to 20000 in terms of the mass average molecular weight. Use of polymers having different average molecular weights in combination can improve the coating film surface conditions and improve the scratch resistance.

### (Preferred Form of Fluorine-Containing Polymer)

As the preferred forms of the fluorine-containing polymers usable in the invention, there are preferably used the fluorine-containing polymers described by the following formula 6 or formula 7:

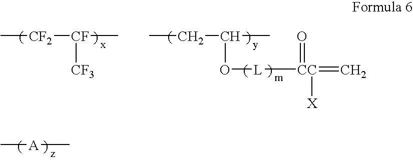

In the formula 6, L denotes a linking group having 1 to 10 carbon atoms, and more preferably a linking group having 1 to 6 carbon atoms, and in particular preferably a linking group having 2 to 4 carbon atoms, which may have a straight chain or branched structure, or may have a ring structure, and may have a hetero atom selected from O, N, and S.

Preferred examples thereof may include: *—(CH₂)₂—O—**, *—(CH₂)₂—NH—**, *—(CH₂)₄—O—**, *—(CH₂)₆—O—**, *—(CH₂)₂—O—(CH₂)₂—O—**, *—CONH—(CH₂)₃—O—**, *—CH₂CH(OH)CH₂—O—**, and *—CH₂CH₂OCONH(CH₂)₃—O—** (* denotes the linking site on the polymer main chain side, and ** denotes the linking site on the (meth)acryloyl group side). m denotes 0 or 1.

In the formula 6, X denotes a hydrogen atom or a methyl group. A hydrogen atom is more preferred from the viewpoint of curing reactivity.

In the formula 6, A denotes a repeating unit derived from a given vinyl monomer, and has no particular restriction so long as it is a constituent component of a monomer copolymerizable with hexafluoropropylene. It can be appropriately selected from various viewpoints including the adhesion to a base material, the Tg of the polymer (which contributes to the film hardness), the solubility in a solvent, the transparency, the slipping property, and the dust proof and stain proof properties. It may comprise a single vinyl monomer or a plurality of vinyl monomers according to the intended purpose.

Preferred examples thereof may include: vinyl ethers such as methyl vinyl ether, ethyl vinyl ether, t-butyl vinyl ether, cyclohexyl vinyl ether, isopropyl vinyl ether, hydroxyethyl vinyl ether, hydroxybutyl vinyl ether, glycidyl vinyl ether, and allyl vinyl ether, vinyl esters such as vinyl acetate, vinyl propionate, and vinyl butyrate, methacrylates such as methyl (meth)acrylate, ethyl (meth)acrylate, hydroxyethyl (meth)acrylate, glycidyl methacrylate, allyl (meth)acrylate, and (meth)acryloyloxypropyl trimethoxysilane, styrene derivatives such as styrene and p-hydroxymethylstyrene, and unsaturated carboxylic acids such as crotonic acid, maleic acid, and itaconic acid, and derivatives thereof. Vinyl ether derivatives and vinyl ester derivatives are more preferred, and vinyl ether derivatives are particularly preferred.

x, y, and z denote the mole percentages of their respective constituent components, and denote the values satisfying 30≦x≦60, 5≦y≦70, and 0≦z≦65, respectively. The case where 35≦x≦55, 30≦y≦60, and 0≦z≦20 is preferred. The case where 40≦x≦55, 40≦y≦55, and 0≦z≦10 is particularly preferred.

As the further preferred form of the copolymer for use in the invention, mention may also be made of the one of the following formula 7:

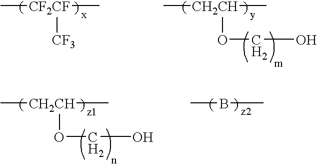

In the formula 7, R may be an alkyl group having 1 to 10 carbon atoms, or an ethylenically unsaturated group (—C(═O)C(—X)═CH₂) as in the formula 6.

m denotes an integer satisfying 1≦n≦10. 1≦n≦6 is preferred, and 1≦n≦4 is particularly preferred.

n denotes an integer satisfying 2≦n≦10. 2≦n≦6 is preferred, and 2≦n≦4 is particularly preferred.

B denotes a repeating unit derived from a given vinyl monomer, and may be formed of a single composition or a plurality of compositions. Further, it may contain a silicone site.

x, y, z1 and z2 denote the mole percentages of their respective repeating units. x and y preferably satisfy 30≦x≦60, and 0≦y≦70, respectively. They further preferably satisfy 35≦x≦55, and 0≦y≦60, respectively, and in particular preferably 40≦x≦55, and 0≦y≦55, respectively. z1 and z2 satisfy preferably 1≦z1≦65, and 1≦z2≦65, respectively, further preferably 1≦z1≦40, and 1≦z2≦10, respectively, and in particular preferably 1≦z1≦30, and 1≦z2≦5. In these cases, however, x+y+z1+z2=100.

The fluorine-containing polymer of the invention preferably has a structural unit having the following polysiloxane structure in order to impart a stain proof property. As the fluorine-containing polymer having a polysiloxane structure useful in the invention, mention may be made of a fluorine-containing polymer which contains at least respective ones of (a) a fluorine-containing vinyl monomer polymerization unit, (b) a hydroxyl group-containing vinyl monomer polymerization unit, and (c) a polymerization unit having a graft moiety including a polysiloxane repeating unit represented by the following formula 1 at the side chain, and has the main chain including only carbon atoms.

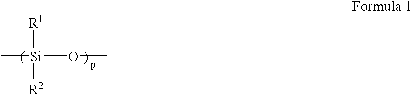

In the formula 1, R¹ and R² may be the same or different, and each represent an alkyl group or an aryl group. The alkyl group preferably has 1 to 4 carbon atoms, examples of which may include a methyl group, a trifluoromethyl group, and an ethyl group. The aryl group preferably has 6 to 20 carbon atoms, examples of which may include a phenyl group and a naphthyl group. Out of these, a methyl group and a phenyl group are preferred and a methyl group is particularly preferred. p represents an integer of 2 to 500, preferably an integer of 5 to 350, and further preferably 8 to 250.

The polymer having a polysiloxane structure represented by the formula 1 at the side chain can be synthesized as described in, for example, J. Appl. Polym. Sci., vol. 2000, 78, 1955, and JP-A-56-28219, by a process in which to a polymer having a reactive group such as an epoxy group, a hydroxyl group, carboxyl, or an acid anhydride group, polysiloxane having a counterpart reactive group (e.g., an amino group, a mercaptro group, a-carboxyl group, or a hydroxyl group for an epoxy group or an acid anhydride group) at the one end (e.g., Silaplane series (manufactured by Chisso Corporation)) is introduced by a polymer reaction, or a process in which polysiloxane-containing siloxane macromers are polymerized. Either process can be preferably used. In the invention, the process in which introduction is carried out by the polymerization of silicone macromers is more preferred.

Any silicone macromer is acceptable so long as it has a polymerizable group copolymerizable with a fluorine-containing olefin, and it preferably has a structure represented by any of the formulae 2 to 5.

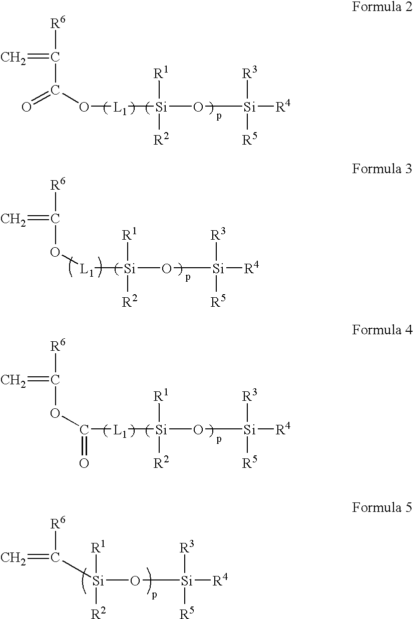

In the formulae 2 to 5, R¹, R², and p represent the same meanings as in the formula 1, and the preferred ranges thereof are also the same as those thereof. R³ to R⁵ each independently represent a substituted or unsubstituted monovalent organic group or a hydrogen atom, and represent preferably an alkyl group having 1 to 10 carbon atoms (e.g., a methyl group, an ethyl group, or an octyl group), an alkoxy group having 1 to 10 carbon atoms (e.g., a methoxy group, an ethoxy group, or a propyloxy group), or an aryl group having 6 to 20 carbon atoms (e.g., a phenyl group or a naphthyl group), and in particular preferably an alkyl group having 1 to 5 carbon atoms. R represents a hydrogen atom or a methyl group. L₁ represents a given linking group having 1 to 20 carbon atoms, and mention may be made of a substituted or unsubstituted straight-chain, branched, or alicyclic alkylene group, or a substituted or unsubstituted arylene group, preferably an unsubstituted straight-chain alkylene group having 1 to 20 carbon atoms, and in particular preferably an ethylene group or a propylene group. These compounds are synthesized by, for example, the method described in JP-A-6-322053.

Any of the compounds represented by the formulae 2 to 5 can be preferably used in the invention. However, out of these, the one of the structure represented by the formula 2, 3, or 4 is preferred from the viewpoint of the copolymerizability with a fluorine-containing olefin. The polysiloxane moiety accounts for preferably 0.01 to 20 mass %, more preferably 0.05 to 15 mass %, and in particular preferably 0.5 to 10 mass % in the graft copolymer.

Below, preferred examples of the polymerization unit of the polymer graft moiety containing a polysiloxane moiety at the side chain useful for the invention will be shown, but the invention is not limited to these.

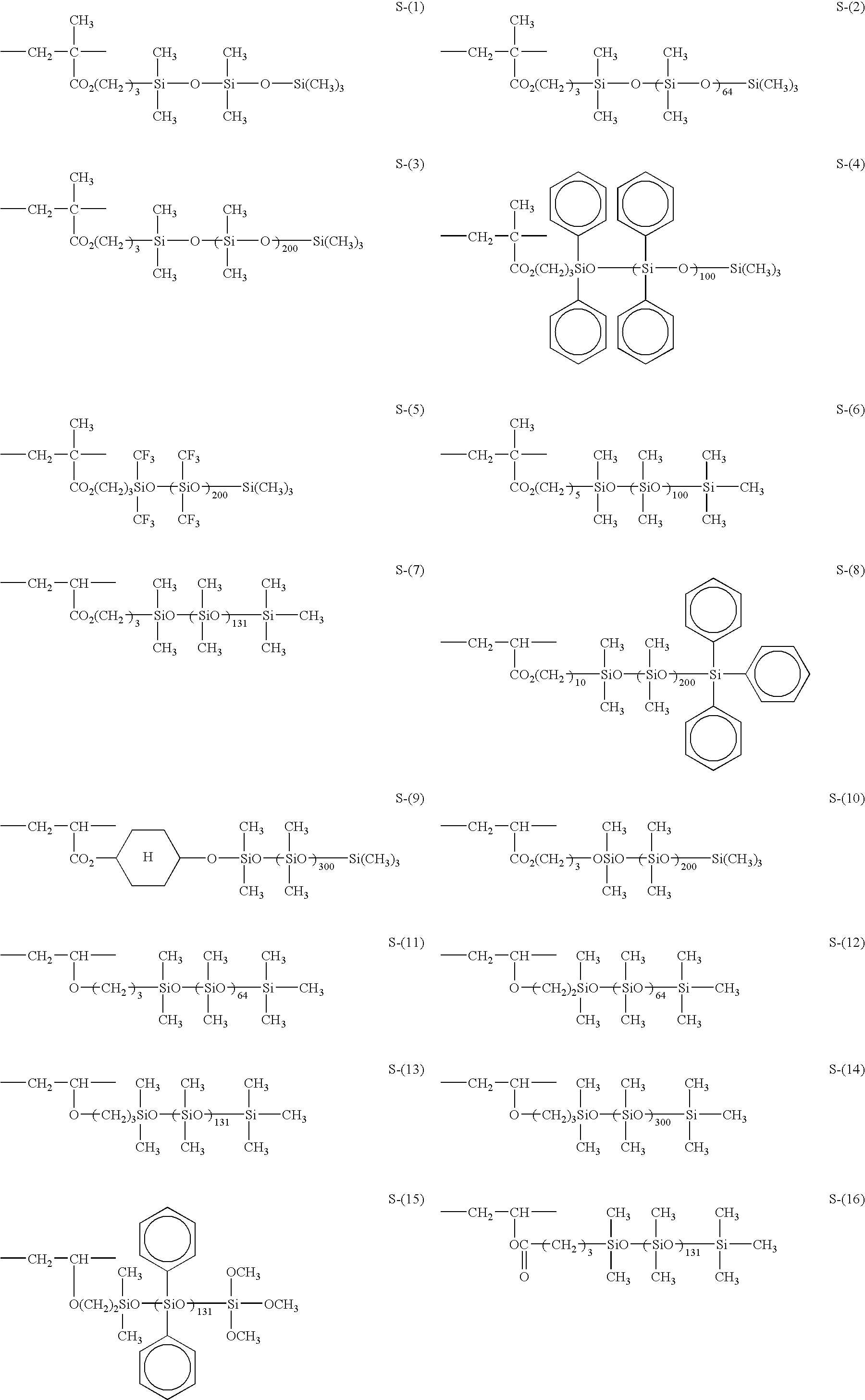

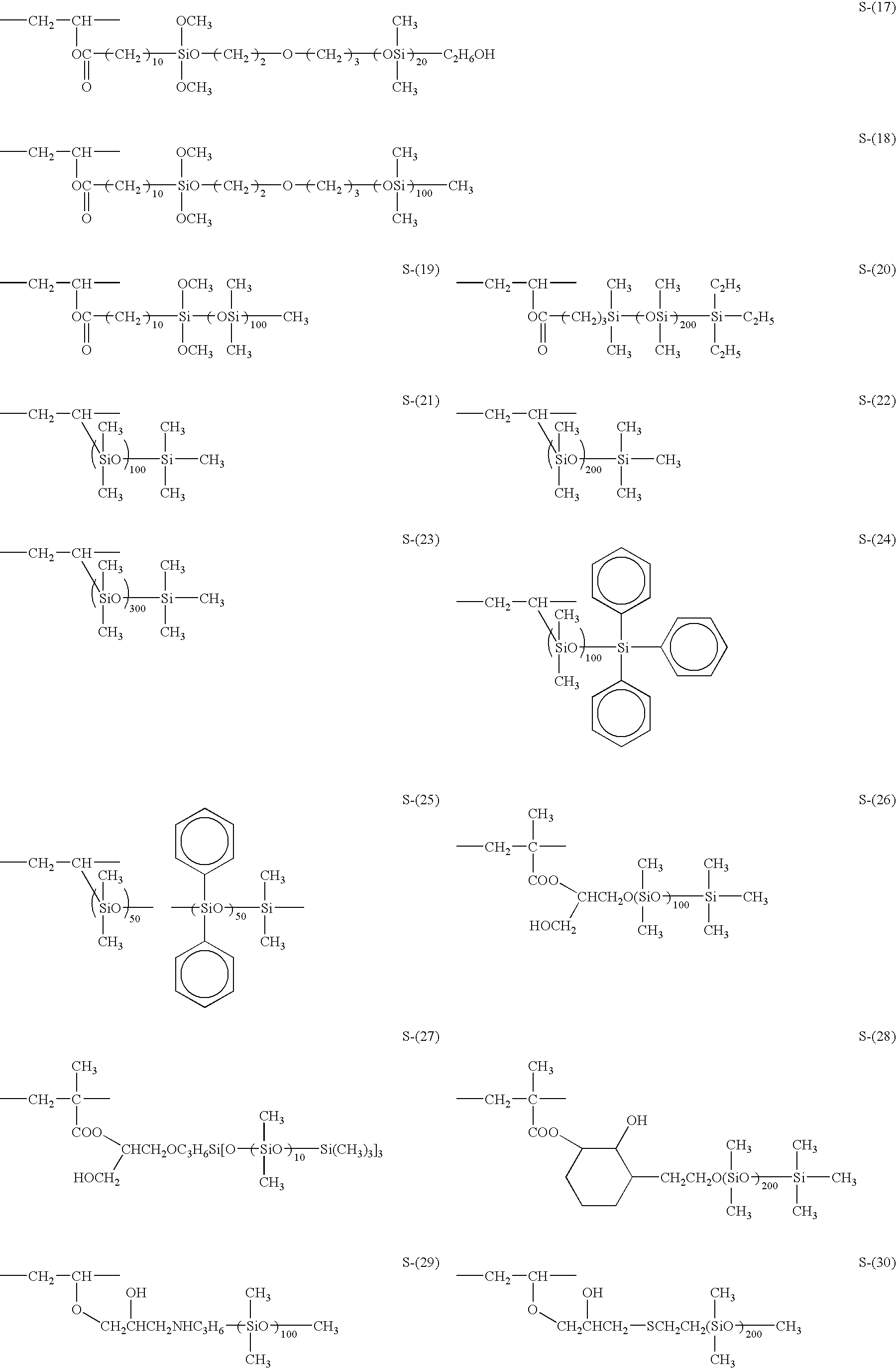

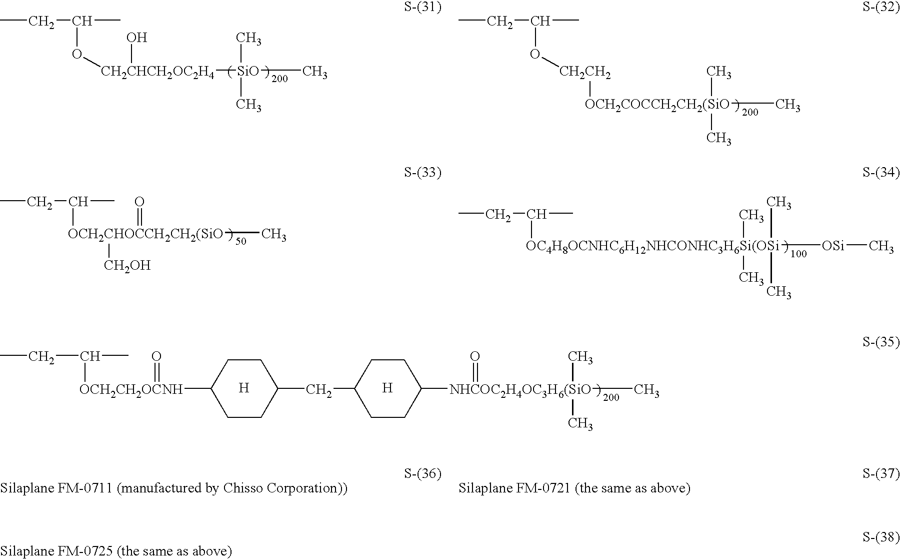

The introduction of the polysiloxane structure imparts the stain proof property and the dust proof property to the film, and also imparts the slipping property to the film surface, also resulting in an advantage for the abrasion resistance.

### (Curing Agent)

By adding a crosslinkable compound to a fluorine-containing polymer as a curing agent, it is possible to further impart a curing property. For example, when the polymer main body contains a hydroxyl group, the compound usable as a curing agent has no particular restriction so long as it is a curing agent having two or more functional groups reactable with a hydroxyl group per molecule. Examples thereof may include polyisocyanates, a partial condensate of an isocyanate compound, multimers, adducts with polyhydric alcohols, low molecular weight polyester films, and the like, a blocked polyisocyanate compound obtained by blocking an isocyanate group by a blocking agent such as phenol, aminoplasts, and polybasic acids or anhydrides thereof. When these curing agents are used, the content of the hydroxyl group-containing monomer units is preferably 1% or more and 65% or.less, and further preferably 1% or more and 50% or less.

Out of the curing agents reacting with a hydroxyl group, in the invention, from the viewpoint of the compatibility between the stability during storage and the activity of the crosslinking reaction, and from the viewpoint of the strength of the film to be formed, aminoplasts which undergo a crosslinking reaction with a hydroxyl group-containing compound under acidic conditions are preferred. Aminoplasts are each a compound containing an amino group reactable with the hydroxyl group present in a fluorine-containing polymer, i.e., a hydroxyalkylamino group or an alkoxyalkylamino group, or a carbon atom adjacent to a nitrogen atom, and substituted with an alkoxy group. Specific examples thereof may include melamine type compounds, urea type compounds, and benzoguanamine type compounds.

The melamine type compounds are generally known as the compounds having a skeleton in which a nitrogen atom is linked to the triazine ring. Specifically, mention may be made of melamine, alkylated melamine, methylol melamine, alkoxylated methyl melamine, and the like. Particularly, methylolated melamine obtained by allowing melamine and formaldehyde to react with each other under basic conditions, alkoxylated methyl melamines, and derivatives thereof are preferred. Particularly, alkoxylated methyl melamines are particularly preferred from the viewpoint of storage stability. Whereas, the methylolated melamines and alkoxylated methyl melamines have no particular restriction, and can be obtained by, for example, the method described in Plastic Zairyo Kouza [8] Urea/Melamine Resin, (Nikkan Kogyo Shimbun Ltd.). Various resins can also be used.

Whereas, as the urea compounds, other than urea, polymethylolated urea and alkoxylated methylurea which is a derivative thereof, and further compounds having a glycol uryl skeleton or 2-imidazolidinone skeleton which is a cyclic urea structure are also preferred. Also for the amino compounds such as the urea derivatives, various resins described in the Urea/Melamine Resin, and the like can be used.

In the invention, as the compounds to be preferably used as a crosslinking agent, particularly melamine compounds or glycol uryl compounds are preferred from the viewpoint of the compatibility with a fluorine-containing copolymer. Out of these, from the viewpoint of the reactivity, the crosslinking agent is preferably a compound containing nitrogen atoms in the molecule, and containing two or more carbon atoms, each substituted with an alkoxy group adjacent to each of the nitrogen atoms. Particularly preferred compounds are the compounds having the structures represented by the following (H-1) and (H-2), and partial condensates thereof. In the formulae, R³¹ and R³² each independently represents an alkyl group having 1 to 6 carbon atoms or a hydroxyl group.

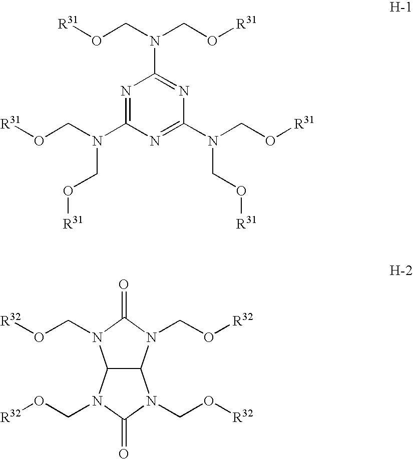

The amount of aminoplast to be added to the fluorine-containing polymer is 1 to 50 parts by mass, preferably 3 to 40 parts by mass, and further preferably 5 to 30 parts by mass per 100 parts by mass of the copolymer. When the amount is 1 part by mass or more, the durability as a thin film which is a feature of the invention can be sufficiently exerted. When the amount is 50 parts by mass or less, the low refractive index which is a feature of the low refractive index layer in the invention can be kept for being employed for optical use, and hence the amount is preferred. From the viewpoint of keeping the refractive index low even when a curing agent is added, a curing agent which causes less increase in refractive index even when added is preferred. From the viewpoint, out of the foregoing compounds, the compounds having the skeleton represented by H-2 are more preferred.

(Curing Catalyst)

For the antireflection film of the invention, when the film is cured by the crosslinking reaction of the hydroxyl group of the fluorine-containing polymer and the curing agent with heating, in this system, curing is promoted by an acid. Therefore, to a curable resin composition, an acidic substance is desirably added. However, addition of a general acid promotes the crosslinking reaction even in the coating solution, which causes failures (such as inconsistencies or cissing). Therefore, in order to ensure the compatibility of the storage stability and the curing activity in the thermal curing system, it is more preferable that a compound generating an acid by heating is added as a curing catalyst.

The curing catalyst is preferably a salt formed from an acid and an organic base. As the acids, mention may be made of organic acids such as sulfonic acid, phosphonic acid, and carboxylic acid, and inorganic acids such as sulfuric acid and phosphoric acid. From the viewpoint of the compatibility with a polymer, organic acids are more preferred, sulfonic acid and phosphonic acid are further preferred, and sulfonic acid is most preferred. As preferred sulfonic acids, mention may be made of p-toluenesulfonic acid (PTS), benzenesulfonic acid (BS), p-dodecyl benzenesulfonic acid (DBS), p-chlorobenzenesulfonic acid (CBS), 1,4-naphthalene disulfonic acid (NDS), methanesulfonic acid (MsOH), nonafluorobutane-1-sulfonic acid (NFBS), and the like. All can be preferably used (the term in the parentheses is the abbreviation).

The curing catalyst largely changes according to the basicity and the boiling point of the organic base to be combined with an acid. Below, the curing catalysts to be preferably used in the invention will be described from respective points of view.

A lower basicity of the organic base results in higher acid generation efficiency upon heating, and it is preferred from the viewpoint of the curing activity. However, too low basicity results in insufficient storage stability. Therefore, an organic base having a proper basicity is preferably used. When the basicity is expressed with the pKa of the conjugate acid as an index thereof, the pKa of the organic base for use in the invention is required to be 5.0 to 10.5, more preferably 6.0 to 10.0, and further preferably 6.5 to 10.0. The values of the pKa of organic bases are described in terms of the values in an aqueous solution in Kagaku Binran Kiso Hen (revised 5 edition, edited by the Chemical Society of Japan, Maruzen, 2004), vol. 2, II-pages 334 to 340. Therefore, it is possible to select an organic base having a proper pKa therefrom. Whereas, it is also possible to preferably use a compound which can be supposed to have the proper pKa even when there is no description thereon in the document. Table 1 shows the compounds having proper pKa's described in the document. However, the compounds preferably usable in the invention are not limited thereto.

TABLE 1

Organic base

| No. | Chemical name | pKa |
|---|---|---|
| b-1 | N,N-Dimethyl aniline | 5.1 |
| b-2 | Benzimidazole | 5.5 |
| b-3 | Pyridine | 5.7 |
| b-4 | 3-methylpyridine | 5.8 |
| b-5 | 2,9-Dimethyl-1,10-phenanthroline | 5.9 |
| b-6 | 4,7-Dimethyl-1,10-phenanthroline | 5.9 |
| b-7 | 2-Methylpyridine | 6.1 |
| b-8 | 4-Methylpyridine | 6.1 |
| b-9 | 3-(N,N-Dimethylamino)pyridine | 6.5 |
| b-10 | 2,6-Dimethylpyridine | 7.0 |
| b-11 | Imidazole | 7.0 |
| b-12 | 2-Methyl imidazole | 7.6 |
| b-13 | 2-Ethyl morpholine | 7.7 |
| b-14 | 2-Methyl morpholine | 7.8 |
| b-15 | Bis(2-methoxyethyl)amine | 8.9 |
| b-16 | 2,2-Iminodiethanol | 9.1 |
| b-17 | N,N-dimethyl-2-aminoethanol | 9.5 |
| b-18 | Trimethylamine | 9.9 |
| b-19 | Triethylamine | 10.7 |

A lower boiling point of the organic base results in higher acid generation efficiency upon heating, and it is preferred from the viewpoint of the curing activity. Therefore, it is preferable to use an organic base having a proper boiling point. The boiling point of the base is preferably 120° C. or less, more preferably 80° C. or less, and further preferably 70° C. or less.

Non-limiting examples of the organic base preferably usable in the invention may include the following compounds. The boiling points are shown in the parentheses.

b-3: pyridine (115° C.), b-14: 4-methylmorpholine (115° C.), b-20: diallyl methylamine (111° C.), b-19: triethylamine (88.8° C.), b-21: t-butylmethylamine (67 to 69° C. ), b-22: dimethylisopropylamine (66° C.), b-23: diethylmethylamine (63 to 65° C.), b-24: dimethylethylamine (36 to 38° C.), b-18: trimethylamine (3 to 5° C.).

The boiling point of the organic base preferably usable in the invention is 35° C. or more and 85° C. or less. When it is equal to, or more than this temperature, deterioration of the scratch resistance is caused. Whereas, when the boiling point is less than 35° C., the coating solution becomes unstable. The boiling point is further preferably 45° C. or more and 80° C. or less, and most preferably 55° C. or more and 75° C. or less.

When used as an acid catalyst in the invention, the salt formed from an acid and an organic base may be isolated and used. Alternatively, an acid and an organic base are mixed to form a salt in a solution, and the resulting solution may be used. Further, both acids and organic bases may be used alone respectively, or may be used in mixture of a plurality thereof. When an acid and an organic base are mixed to be used, these are mixed so that the equivalent ratio of the acid and the organic base is preferably 1:0.9 to 1.5, more preferably 1:0.95 to 1.3, and preferably 1:1.0 to 1.1.

The ratio of the acid catalyst to be used is preferably 0.01 to 10 parts by mass, more preferably 0.1 to 5 parts by mass, and further preferably 0.2 to 3 parts by mass per 100 parts by mass of the fluorine-containing polymer in the curable resin composition.

In the invention, other than the foregoing compound generating an acid by heating, i.e., a thermal acid generator, a compound generating an acid by light irradiation, i.e., a photosensitive acid generator may be further added. As the photosensitive acid generator, mention may be made of known compounds and mixtures thereof such as a photoinitiator for cation photopolymerization, a light decolorizing agent of dyes, a light discoloring agent, or known acid generators used in a microresist, or the like. The photosensitive acid generator imparts the photosensitivity to the curable resin composition-coated film. For example, it is a substance which enables the film to be photocured by irradiation with radiation such as light.

Examples of the photosensitive acid generator may include (1) various onium salts such as iodonium salts, sulfonium salts, phosphonium salts, diazonium salts, ammonium salts, iminium salts, pyridinium salts, arsonium salts, and selenonium salts, (preferably diazonium salts, iodonium salts, sulfonium salts, and iminium salts); (2) sulfone compounds such as P-keto ester and 3-sulfonylsulfone, and cc-diazo compounds thereof; (3) sulfonic acid esters such as alkyl sulfonic acid ester, haloalkyl sulfonic acid ester, aryl sulfonic acid ester, and imino sulfonate; (4) sulfonimide compounds; (5) diazomethane compounds; and (6) trihalomethyltriazines. These can be appropriately used. Examples of the foregoing (1) may include the compounds described in paragraph Nos. [0058] to [0059] of JP-A-2002-29162.

In addition, as specific compounds and use methods, the contents described in JP-A-2005-43876, and the like can be used.

The photosensitive acid generators may be used alone, or in combination of two or more thereof. Further, they can also be used in combination with the heat acid generator. The ratio of the photosensitive acid generator to be used is preferably 0 to 20 parts by mass, and more preferably 0.01 to 10 parts by mass per 100 parts by mass of the fluorine-containing polymer in the composition for forming a low refractive index layer. When the ratio of the photosensitive acid generator is equal to, or less than the upper limit value, the resulting cured film becomes excellent in strength, and also is favorable in transparency. Therefore, such a ratio is preferred.

Preferably, the foregoing curing agent and curing catalyst are used with the initiator, and the monomer having one or more ethylenically unsaturated groups and the monomer having a moiety reacting with the crosslinkable functional group in mixture. Whereas, these are preferably used in combination with the initiator and a compound having one or more ethylenically unsaturated groups and a moiety reacting with the crosslinkable functional group in one molecule

Then, the curable compound having an ethylenically unsaturated group (B) will be described.

### {Curable Compound Having an Ethylenically Unsaturated Group (B)}

As the curable compound (B), mention may be made of a monomer having two or more ethylenically unsaturated groups. The monomer can be appropriately selected from various monomers exemplified in the (binder polymer having a saturated hydrocarbon chain as the main chain) in the [Binder polymer] of the [Hard coat layer]. These monomers can increase the density of the crosslinked group, and can form a high hardness cured film. However, the refractive index is not lower as compared with the fluorine-containing polymer binder. However, use of these monomers with inorganic fine particles having a hollow structure in combination can provide sufficiently effective refractive index as the low refractive index layer of the antireflection film of the invention.

### (Hydrolysate and/or Partial Condensate of Organosilane Compound)

Whereas, the curable compounds are preferably non-fluorine-containing compounds from the viewpoint of desiring to have a higher surface free energy than that of the fluorine-containing compound in order to be localized at the lower part than the fluorine-containing binder. Out of these, particularly preferred is a hydrolysate and/or a partial condensate of an organosilane compound which has an ethylenically unsaturated group, and in which a hydroxyl group or a hydrolyzable group is directly bonded to silicon, a so-called sol component.

The organosilane compound is preferably the one expressed by the following formula (b):

(R³¹)ₘ₃−Si(X³¹)₄₋ₘ₃ Formula (b):

In the formula (b), R³¹ represents a substituted or unsubstituted alkyl group, or a substituted or unsubstituted aryl group. As alkyl groups, mention may be made of methyl, ethyl, propyl, isopropyl, hexyl, decyl, hexadecyl, and the like. As alkyl groups, mention may be made of preferably the ones with 1 to 30 carbon atoms, more preferably the ones with 1 to 16 carbon atoms, and in particular preferably the ones with 1 to 6 carbon atoms. As aryl groups, mention may be made of phenyl, naphthyl, and the like, and preferably a phenyl group.

X³¹ represents a hydroxyl group or a hydrolyzable group. Examples thereof may include an alkoxy group (an alkoxy group having 1 to 5 carbon atoms is preferred, and examples thereof may include a methoxy group and an ethoxy group), a halogen atom (e.g., Cl, Br, or I), and a group represented by R³²COO (where R³² is preferably a hydrogen atom, or an alkyl group having 1 to 5 carbon atoms, examples of which may include CH₃COO and C₂H₅COO). It is preferably an alkoxy group, and in particular preferably a methoxy group or an ethoxy group.

m3 represents an integer of 0 to 3, and preferably 1 or 2.

When a plurality of R³¹'s or X³¹'s are present, a plurality of R³¹'s or X³¹'s may be respectively the same or different.

The substituent contained in R³¹ has no particular restriction. However, mention may be made of a halogen atom (such as fluorine, chlorine, or bromine), a hydroxyl group, a mercapto group, a carboxyl group, an epoxy group, an alkyl group (such as methyl, ethyl, i-propyl, propyl, or t-butyl), an aryl group (such as phenyl or naphthyl), an aromatic heterocyclic group (such as furyl, pyrazolyl, or pyridyl), an alkoxy group (such as methoxy, ethoxy, i-propoxy, or hexyloxy), an aryloxy group (such as phenoxy), an alkylthio group (such as methylthio or ethylthio), an arylthio group (such as phenylthio), an alkenyl group (such as vinyl or 1-propenyl), an acyloxy group (such as acetoxy, acryloyloxy, or (meth)acryloyl), an alkoxycarbonyl group (such as methoxycarbonyl or ethoxycarbonyl), an aryloxycarbonyl group (such as phenoxycarbonyl), a carbamoyl group (such as carbamoyl, N-methylcarbamoyl, N,N-dimethylcarbamoyl, or N-methyl-N-octylcarbamoyl), an acylamino group (such as acetylamino, benzoylamino, acrylamino, or methacrylamino), or the like. These substituents may be further substituted.

When a plurality of R³¹'s are present, it is preferable that at least one is a substituted alkyl group or a substituted aryl group.

The organosilane compounds may be used alone or in plurality to prepare a hydrolysate and/or a partial condensate thereof.

The hydrolysate and/or partial condensate of an organosilane compound to be preferably used as the curable compound (B) contains an ethylenically unsaturated group. This can be prepared by using an organosilane compound of the formula (b), where R³¹ has an ethylenically unsaturated group as at least one of the organosilane compounds to be used for preparation of a sol component.

In order to obtain the effects of the invention, the content of the organosilane compound having an ethylenically unsaturated group in the hydrolysate and/or partial condensate of an organosilane compound is preferably 30 mass % to 100 mass %, more preferably 50 mass % to 100 mass %, and further preferably 70 mass % to 95 mass %. A content of the organosilane compound having an ethylenically unsaturated group of 30 mass % or more is preferred because the following deficiencies, and the like do not occur: an undissolved matter occurs, the solution becomes turbid, the pot life is deteriorated, the control of the molecular weight is difficult (increase in molecular weight), and the content of the polymerizable groups is small, and hence the improvement of the performances (such as abrasion resistance of the antireflection film) is difficult to obtain upon carrying out the polymerization treatment.

At least any of the hydrolysate and/or partial condensate of the organosilane compound for use in the invention is preferably suppressed in volatility for stabilizing the coated product performances. Specifically, the amount of volatilation per hour at 105° C. is preferably 5 mass % or less, more preferably 3 mass % or less, and in particular preferably 1 mass % or less.

### (Method for Preparing Organosilane Sol)

Then, a method for preparing an organosilane sol will be described.

The hydrolysis and/or condensation reaction of the organosilane compound is carried out in the following manner. For example, water is added in an amount of 0.3 to 2.0 mol, and preferably 0.5 to 1.0 mol per mole of a hydrolyzable group. Then, the mixture is stirred at 25 to 100° C. in the presence of a metal chelate compound. However it is prefer to control the condition depending on the reactivity of the used organosilane compound.

The mass average molecular weight of the resulting organosilane sol is preferably 450 to 20000, more preferably 500 to 10000, further preferably 550 to 5000, in particular preferably 600 to 3000, and most preferably 1000 to 2000, except for the components having a molecular weight of less than 300. Whereas, the component having a molecular weight of more than 20000 out of the components having a molecular weight of 300 or more in the organosilane sol is preferably in an amount of 20 mass % or less, more preferably 15 mass % or less, further preferably 10 mass % or less, still further preferably 6 mass % or less, and in particular preferably 5 mass % or less. When the component having a molecular weight of more than 20000 is in an amount of 20 mass % or less, the cured film obtained by curing a composition containing a hydrolysate and/or a partial condensate of such an organosilane is excellent in transparency and adhesion with a substrate. Thus, this is preferable.

Further, out of the components having a molecular weight of 300 or more in the organosilane sol, the component having a molecular weight of 450 to 20000 is preferably in an amount of 80 mass % or more. When the component having a molecular weight of 450 to 20000 is an amount equal to, or more than the lower limit value, the cured film obtained by curing a composition containing such an organosilane sol is excellent in transparency and adhesion with a substrate. Thus, this is preferable.

Herein, the number average molecular weights and the molecular weights are the molecular weights expressed in polystyrene equivalents based on solvent tetrahydrofuran (THF), differential refractometer detection by means of a GPC analysis apparatus using columns of “TSK gel GMH×L”, “TSK gel G400H×L”, and “TSK gel G2000 H×L” {all are trade names of the products manufactured by Tosoh Corporation}. The content is the area percentage of the peak within the molecular weight range, where the peak area of the components having a molecular weight of 300 or more is 100%.

The degree of dispersion (mass average molecular weight/number average molecular weight) is preferably 3.0 to 1.1, more preferably 2.5 to 1.1, further preferably 2.0 to 1.1, and in particular preferably 1.5 to 1.1.

The hydrolysis and/or condensation reaction of the organosilane compound can be carried out either without a solvent, or in a solvent. By this reaction, a curable compound can be manufactured.

### (Solvent)

When a solvent is used, it is possible to appropriately determine the concentration of the organosilane sol. As the solvent, an organic solvent is preferably used for uniformly mixing components. For example, alcohols, aromatic hydrocarbons, ethers, ketones, esters, and the like are preferred. Whereas, the solvent is preferably the one which dissolves organosilane and a catalyst. Further, the organic solvent is preferably used as the coating solution or a part of the coating solution in terms of the step. Preferred is the one which does not degrade the solubility or the dispersibility when mixed with other materials.

Out of these, examples of alcohols may include monohydric alcohols or dihydric alcohols. Out of these, the monohydric alcohols are preferably saturated aliphatic alcohols having 1 to 8 carbon atoms. Specific examples of the alcohols may include methanol, ethanol, n-propyl alcohol, i-propyl alcohol, n-butyl alcohol, s-butyl alcohol, t-butyl alcohol, ethylene glycol, diethylene glycol, and triethylene glycol.

Whereas, specific examples of the aromatic hydrocarbons may include benzene, toluene, and xylene; specific examples of the ethers, tetrahydrofuran, dioxane, and ethylene glycol monobutyl ether; specific examples of the ketones, acetone, methyl ethyl ketone, methyl isobutyl ketone, and diisobutyl ketone; and specific examples of the esters, ethyl acetate, propyl acetate, butyl acetate, propylene carbonate, and ethylene glycol monoethyl ether acetic acid ester.

These organic solvents may be used alone or in mixture of two or more thereof. The concentration of the solid content with respect to the solvent in the reaction has no particular restriction. However, it is generally within the range of 1 to 90 mass %, and preferably within the range of 20 to 70 mass %.

### (Catalyst)

The hydrolysis and/or condensation reaction of the organosilane compound is preferably carried out in the presence of a catalyst. As the catalysts, mention may be made of inorganic acids such as hydrochloric acid, sulfuric acid, and nitric acid; organic acids such as oxalic acid, acetic acid, formic acid, methanesulfonic acid, and toluenesulfonic acid; inorganic bases such as sodium hydroxide, potassium hydroxide, and ammonia; organic bases such as triethylamine and pyridine; metal alkoxides such as triisopropoxy aluminum and tetrabutoxy zirconium; and the like. In the invention, however, acid catalysts (inorganic acids and organic acids) are used from the viewpoint of the manufacturing stability of the sol solution and the storage stability of the sol solution. In the inorganic acids, hydrochloric acid and sulfuric acid are preferred. In the organic acids, the ones having an acid dissociation constant in water {pKa value (25° C.)} of 4.5 or less are preferred. Hydrochloric acid, sulfuric acid, an organic acid having an acid dissociation constant in water of 3.0 or less are more preferred. Hydrochloric acid, sulfuric acid, an organic acid having an acid dissociation constant in water of 2.5 or less are further preferred. An organic acid having an acid dissociation constant in water of 2.5 or less is further preferred. Methanesulfonic acid, oxalic acid, phthalic acid, and malonic acid are further preferred, and oxalic acid is particularly preferred.

The hydrolysis and/or condensation reaction is carried out generally in the following manner. Water is added in an amount of 0.3 to 2 mol, and preferably 0.5 to 1 mol per mole of the hydrolyzable group of the organosilane compound. In the presence of, or absence of the solvent, and in the presence of an acid catalyst and a metal chelate compound, stirring is carried out at 25 to 100° C.

When the hydrolyzable group is an alkoxy group, and the acid catalyst is an organic acid, the carboxyl group or the sulfo group of the organic acid supplies protons, and hence the amount of water to be added can be reduced. The amount of water to be added per mole of the hydrolyzable group such as the alkoxy group of the organosilane compound is 0 to 2 mol, preferably 0 to 1.5 mol, more preferably 0 to 1 mol, and in particular preferably 0 to 0.5 mol. When alcohol is used as the solvent, the case where water is substantially not added is also preferred.

The amount of the acid catalyst to be used is 0.01 to 10 mol %, and preferably 0.1 to 5 mol % based on the amount of the hydrolyzable group when the acid catalyst is an inorganic acid. When the acid catalyst is an organic acid, the optimum amount of the acid catalyst to be used varies according to the amount of water to be added. However, the amount is 0.01 to 10 mol %, and preferably 0.1 to 5 mol % based on the amount of the hydrolyzable group when water is added. When water is substantially not added, the amount is 1 to 500 mol %, preferably 10 to 200 mol %, more preferably 20 to 200 mol %, further preferably 50 to 150 mol %, and in particular preferably 50 to 120 mol % based on the amount of the hydrolyzable group.

### (Metal Chelate Compound)

A metal chelate compound can be preferably used without particular restriction so long as it has alcohol represented by the formula R⁴¹OH (where in the formula, R⁴¹ represents an alkyl group having 1 to 10 carbon atoms), and a compound represented by R⁴²COCH₂COR⁴³ (where in the formula, R⁴² represents an alkyl group having 1 to 10 carbon atoms, and R⁴³ represents an alkyl group having 1 to 10 carbon atoms or an alkoxy group having 1 to 10 carbon atoms) as ligands, and has a metal selected from Zr, Ti, and Al as a center metal. Within this scope, two or more metal chelate compounds may be used in combination.

The metal chelate compound for use in the invention is preferably the one selected from the compound group represented by the formulae Zr(OR⁴¹)ₚ₁, (R⁴²COCHCOR⁴³)ₚ₂, Ti(OR⁴¹)_{q1}(R⁴²COCHCOR⁴³)_{q2}, and Al(OR⁴¹)ᵣ₁(R⁴²COCHCOR⁴³)ᵣ₂, and has an action of promoting the condensation reaction of the organosilane compound.

R⁴¹ and R⁴² in the metal chelate compound may be the same or different, and are each an alkyl group having 1 to 10 carbon atoms (specifically, an ethyl group, a n-propyl group, a 1-propyl group, a n-butyl group, a s-butyl group, a t-butyl group, or a n-pentyl group), a phenyl group, or the like. Whereas, R⁴³ is, other than the same alkyl group having 1 to 10 carbon atoms as described above, an alkoxy group having 1 to 10 carbon atoms, such as a methoxy group, an ethoxy group, a n-propoxy group, a 1-propoxy group, a n-butoxy group, a s-butoxy group, a t-butoxy group, or the like. Whereas, p1, p2, q1, q2, r1, and r2 in the metal chelate compound respectively represent integers determined so as to achieve tetra- or hexa-dentate coordination.

Specific examples of the metal chelate compounds may include zirconium chelate compounds such as zirconium tri-n-butoxy ethyl acetoacetate, zirconium di-n-butoxy bis(ethyl acetoacetate), zirconium n-butoxy tris(ethyl acetoacetate), zirconium tetrakis(n-propyl acetoacetate), zirconium tetrakis(acetyl acetoacetate), and zirconium tetrakis(ethyl acetoacetate); titanium chelate compounds such as titanium diisopropoxy bis(ethyl acetoacetate), titanium diisopropoxy bis(acetyl acetoacetate), and titanium diisopropoxy bis(acetyl acetonate); and aluminum chelate compounds such as aluminum diisopropoxy ethyl acetoacetate, aluminum diisopropoxy acetyl acetonate, aluminum isoprpoxy bis(ethyl acetoacetate), aluminum isoprpoxy bis(acetyl acetonate), aluminum tris(ethyl acetoacetate), aluminum tris(acetyl acetonate), and aluminum monoacetyl acetonate bis(ethyl acetoacetate).

Out of these metal chelate compounds, zirconium tri-n-butoxy ethyl acetoacetate, titanium diisopropoxy bis(acetyl acetonate), aluminum diisopropoxy ethyl acetoacetate, and aluminum tris(ethyl acetoacetate) are preferred. These metal chelate compounds can be used singly alone, or in mixture of two or more thereof. Whereas, the partial hydrolysates of these metal chelate compounds can also be used.

The metal chelate compound is used in a ratio of preferably 0.01 to 50 mass %, more preferably 0.1 to 50 mass %, and further preferably 0.5 to 10 mass % based on the amount of the organosilane compound represented by the formula (b). When the amount of the metal chelate compound component is equal to or more than the lower limit value, the condensation reaction of the organosilane compound well proceeds. The durability of the resulting film is also excellent. On the other hand, when the amount is equal to or less than the upper limit value, the problems such as the reduction of the storage stability of the composition including the organosilane compound and the metal chelate compound component do not occur. Thus, the amount within such a range is preferable.

The hydrolysis and/or condensation reaction of the organosilane compound is carried out by stirring at 25 to 100° C. However, it is preferably controlled according to the reactivity of an individual organosilane compound to be used.

The amount of the organosilane sol to be added to the low refractive index layer is preferably 0.1 to 50 mass %, more preferably 0.5 to 20 mass %, and in particular preferably 1 to 10 mass % based on the total solid content of the low refractive index layer.

Incidentally, the organosilane sol can also be added to the layers other than the low refractive index layer. The amount added in that case is preferably 0.001 to 50 mass %, more preferably 0.01 to 20 mass %, further preferably 0.05 to 10 mass %, and in particular preferably 0.1 to 5 mass % based on the total solid content of the receiving layer.

The amount (ratio) of the organosilane sol is, for example, preferably 5 to 100 mass %, more preferably 5 to 40 mass %, further preferably 8 to 35 mass %, and in particular preferably 10 to 30 mass % based on the amount of the fluorine-containing polymer in the low refractive index layer. When the amount of the organosilane sol to be used is equal to, or more than the lower limit value, the effects of the invention are sufficiently exerted. Whereas, when the amount is equal to, or less than the upper limit value, the problems such as the increase in refractive index and the deterioration of the shape/surface conditions of the film do not occur. Thus, the amount within such a range is preferred

The polymerization initiator (C) contained in the composition for forming the low refractive index layer is, as described above, preferably a heat and/or photo-degradable initiator. As the polymerization initiator (C), any material can be used without particular restriction so long as it is generally used.

### (Radical Photopolymerization Initiator Skeleton)

As the radical photopolymerization initiator skeleton, any skeleton may be adopted so long as it is the same compound as the radical photopolymerization initiator shown in the item of the binder polymer for forming the hard coat layer.

### (Heat Radical Initiator Skeleton)

Also for the heat radical initiator skeleton, any skeleton may be adopted so long as it is the same compound as the heat radical polymerization initiator shown in the item of the binder polymer for forming the hard coat layer.

These initiators may be used alone, or in mixture.

The initiators preferably usable in the invention will be shown below. However, these are non-limiting.

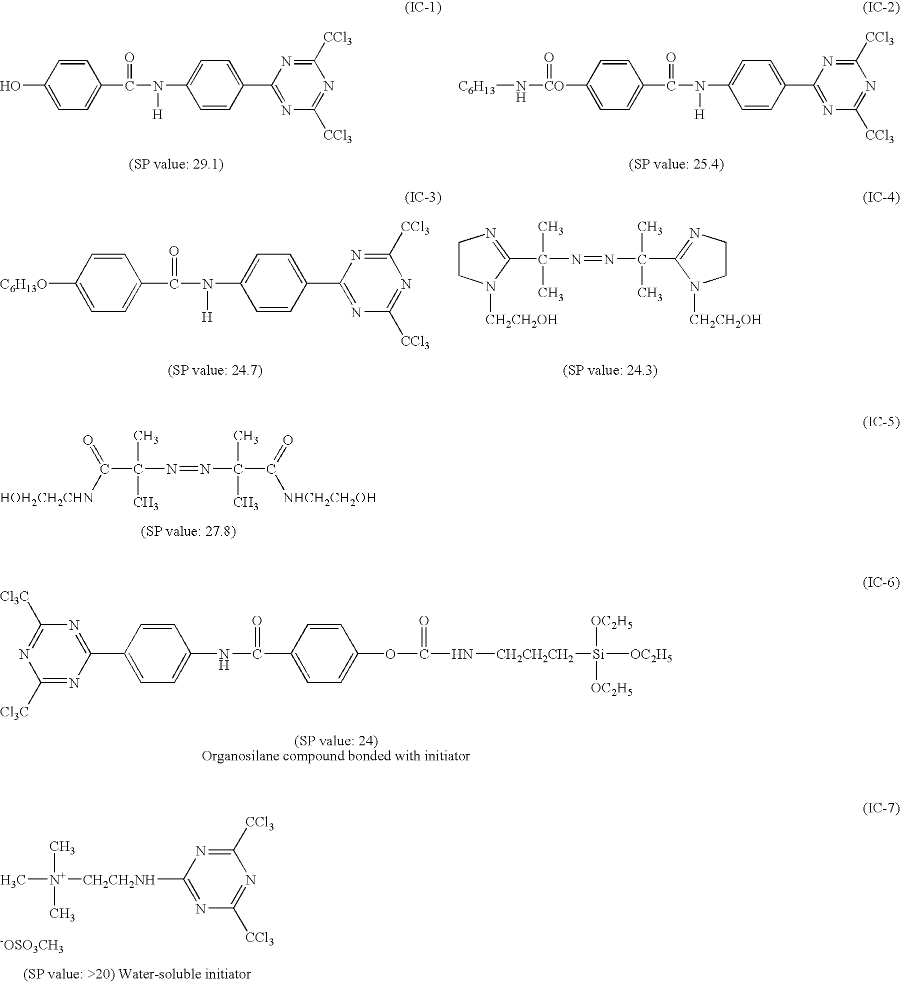

Whereas, self-polymerization initiatable curable compounds in which a curable compound having an ethylenically unsaturated group is linked with a polymerization initiating site in the molecule will be shown below. (IC-8) (SP value: 25.7) Compound in which (IC-1) and a polymerization initiator are linked.

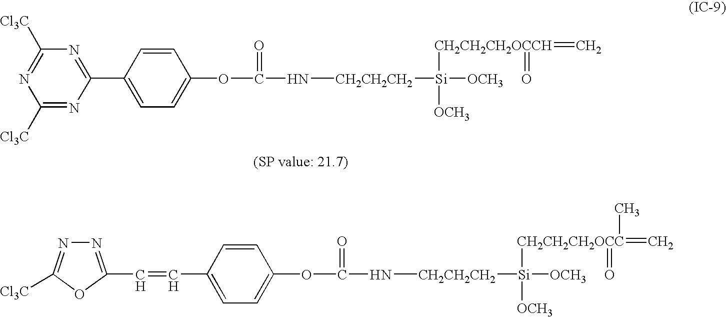

The amount of the polymerization initiators to be used has no particular restriction. However, the polymerization initiator is used in an amount within the range of preferably 0.1 to 20 parts by mass, and more preferably 1 to 10 parts by mass per 100 parts by mass of the curable compound to be used in combination.

Whereas, these polymerization initiator compounds may be used alone, or in plurality, or may also be used in combination with other photosensitizers or the like. Specific examples of the photosensitizer may include n-butylamine, triethylamine, tri-n-butylphosphine, Michler's ketone, and thioxanthone. Further, aids such as an azide compound, a thiourea compound, and a mercaptro compound may also be used in combination of one or more thereof.

### [Stain Proof Agent]

To the antireflection film of the invention, particularly, to the low refractive index layer which is the uppermost layer thereof, it is preferable to appropriately add a known stain proof agent, slipping agent, and the like of a compound having a polysiloxane structure or a fluorine type compound for the purpose of imparting the characteristics such as the stain proof property, the water resistance, the chemical resistance, and the slipping property.

### (Compound Having Polysiloxane Structure)

The compound having a polysiloxane structure can be added to the low refractive index layer, thereby to impart the slipping property, resulting in improvements of the scratch resistance and the stain proof property. The structure of the compound has no particular restriction, and mention may be made of the ones having a plurality of dimethylsilyloxy units as repeating units, and having a substituent at the terminal of the compound chain and/or the side chain thereof. Whereas, the compound chain containing dimethylsilyloxy as a repeating unit may contain therein other structural unit than dimethylsilyloxy.

The molecular weight of the compound having a polysiloxane structure has no particular restriction. However, it is preferably 100,000 or less, in particular preferably 50,000 or less, and most preferably 3000 to 30000.

In general, onto the antireflection film, a protective film is bonded via a self-adhesive layer for the purpose of protecting the surface. Then, the film is wound to be a product. Therefore, the compound having a polysiloxane structure contained in the low refractive index layer tends to be transferred to the self-adhesive layer or the protective film. Further, the compound tends to move to the layer underlying the low refractive index layer, for example, the high refractive index layer or the hard coat layer. From the viewpoint of preventing such transfer or movement, it is preferable that the compound contains a hydroxyl group, or a functional group which reacts with a hydroxyl group to form a bond.

This bond formation reaction preferably proceeds promptly under heating conditions and/or in the presence of a catalyst. As such a substituent, mention may be made of an epoxy group, a carboxyl group, or the like. Non-limiting preferred examples of the compound having a polysiloxane structure may include the following ones.

### (The Ones Containing a Hydroxyl Group)

“X-22-160AS”, “KF-6001”, “KF-6002”, “KF-6003”, “X-22-170DX”, “X-22-176DX”, “X-22-176D”, and “X-22-176F” (all, manufactured by Shin-Etsu Chemical Co., Ltd.); “FM-4411”, “FM-4421”, “FM-4425”, “FM-0411”, “FM-0421”, “FM-0425”, “FM-DA11”, “FM-DA21”, and “FM-DA25” (all manufactured by Chisso Corporation); and “CMS-626” and “CMS-222” {all manufactured by Gelest Co.}.

### (The Ones Containing a Functional Group Which Reacts with a Hydroxyl Group)

“X-22-162C” and “KF-105” {all, manufactured by Shin-Etsu Chemical Co., Ltd.}; “FM-5511”, “FM-5521”, “FM-5525”, “FM-6611”, “FM-6621”, and “FM-6625”, {all manufactured by Chisso Corporation}.

In addition to the polysiloxane type compound, another polysiloxane type compound can also be further used. Preferred examples thereof may include the ones having a plurality of dimethylsilyloxy units as repeating units, and having a substituent at the terminal of the compound chain and/or the side chain thereof. The compound chain containing dimethylsilyloxy as a repeating unit may include other structure units than dimethylsilyloxy. The substituents may be the same or different, and a plurality of the substituents are preferably present. Preferred examples of the substituent may include the groups containing an acryloyl group, a methacryloyl group, a vinyl group, an aryl group, a cinnamoyl group, an oxetanyl group, a fluoroalkyl group, a polyoxyalkylene group, a carboxyl group, and an amino group.

The molecular weight has no particular restriction. However, it is preferably 100,000 or less, more preferably 50,000 or less, in particular preferably 3000 to 30000, and most preferably 10000 to 20000.

The silicon atom content of the silicone type compound has no particular restriction. However, it is preferably 18.0 mass % or more, in particular preferably 25.0 to 37.8 mass %, and most preferably 30.0 to 37.0 mass %.

### (Fluorine Type Compound)

The fluorine type compound for use as a stain proof agent is preferably a compound having a fluoroalkyl group. The fluoroalkyl group has preferably 1 to 20 carbon atoms, and more preferably 1 to 10 carbon atoms. It may be a straight chain {e.g., —CF₂CF₃, —CH₂(CF₂)₄H, —CH₂(CF₂)₈CF₃, or —CH₂CH₂(CF₂)₄H}, a branched structure {e.g., CH(CF₃)₂, CH₂CF(CF₃)₂, CH(CH₃)CF₂CF₃, or CH(CH₃)(CF₂)₅CF₂H), or an alicyclic structure (preferably a 5-membered ring or a 6-membered ring, e.g., a perfluorocyclohexyl group, a perfluorocyclopentyl group, or an alkyl group substituted therewith), and may have an ether linkage (e.g., CH₂OCH₂CF₂CF₃, CH₂CH₂OCH₂C₄F₈H, CH₂CH₂OCH₂CH₂C₈F₁₇, or CH₂CH₂OCF₂CF₂OCF₂CF₂H). A plurality of the fluoroalkyl groups may be contained in the same molecule.

These fluorine type compounds preferably further have a substituent which contributes to the formation of bonding with the low refractive index layer film, or the compatibility. The substituents may be the same or different, and a plurality of the substituents are preferably present. Preferred examples of the substituent may include an acryloyl group, a methacryloyl group, a vinyl group, an aryl group, a cinnamoyl group, an epoxy group, an oxetanyl group, a hydroxyl group, a polyoxyalkylene group, a carboxyl group, and an amino group.

The fluorine type compound may be a polymer or an oligomer with a compound not containing a fluorine atom, and has no particular restriction on the molecular weight. The fluorine atom content of the fluorine type compound has no particular restriction. However, it is preferably 20 mass % or more, in particular preferably 30 to 70 mass %, and most preferably 40 to 70 mass %.

Preferred non-limiting examples of the fluorine type compound may include “R-2020”, “M-2020”, “R-3833”, and “M-3833” (all are trade names) manufactured by DAIKIN Industries Ltd.; and “MEGAFAC F-171”, “MEGAFACF-172”, “MEGAFACF-179A”, and “DEFENSA MCF-300” (all are trade names), manufactured by Dai-Nippon Ink & Chemicals Inc.

When these stain proof agents are added, they are preferabiy added in an amount within the range of 0.01 to 20 mass %, more preferably added in an amount within the range of 0.05 to 10 mass %, and in particular preferably 0.1 to 5 mass % based on the total solid content of the low refractive index layer.

### [Dust Proof Agent, Antistatic Agent, and the Like]

For the purpose of imparting the characteristics such as dust proof property and antistatic property, a dust proof agent such as a known cationic surfactant or a polyoxyalkylene type compound, an antistatic agent, and the like can also be appropriately added. The dust proof agent or the antistatic agent may have the structural unit contained in the silicone type compound or the fluorine type compound as a part of the function.

When these are added as additives, these are preferably added in an amount in the range of 0.01 to 20 mass %, more preferably in an amount in the range of 0.05 to 10 mass %, and in particular preferably 0.1 to 5 mass % based on the total solid content of the low refractive index layer. Preferred non-limiting examples of the compound may include “MEGAFACF-150” (trade name) manufactured by Dai-Nippon Ink & Chemicals Inc., and “SH-3748” (trade name) manufactured by Dow Corning Toray Company Limited.

### [Metal Oxide Particles]

As the metal oxide particles for use in the low refractive index layer, the ones with a low refractive index are preferably used. The preferred metal oxide particles are silica particles and hollow silica particles. Particularly, the hollow silica particles are preferred. The average particle diameter of the metal oxide particles is within the range of, preferably 1 nm to 200 nm, more preferably 1 nm to 100 nm, and further preferably 1 nm to 80 nm. The particle diameter of the filler is preferably as uniform as possible (monodisperse).

### (Silica Particles)

The average particle diameter of the silica particles is preferably 30% or more and 150% or less, more preferably 35% or more and 80% or less, and further preferably 40% or more and 60% or less, of the thickness of the low refractive index layer. Namely, when the thickness of the low refractive index layer is 100 nm, the particle diameter of the silica particles is preferably 30 nm or more and 150 nm or less, more preferably 35 nm or more and 80 nm or less, and further preferably 40 nm or more and 60 nm or less. When the particle diameter of the silica particles is equal to or more than the lower limit value, the effect of improving the scratch resistance is exerted. When the particle diameter is equal to or less than the upper limit value, fine unevenness is formed on the low refractive index layer surface. Thus, disadvantages including degradation of the outward appearances such as tightness of black, or the integral reflectance, and the like do not occur. Thus, the value within such a range is preferable.

The silica particles may be any of crystalline and amorphous, or may be monodispersible particles, or cohesive particles so long as they satisfy a prescribed particle diameter. The particle is most preferably in a spherical form, but even an amorphous particle does not matter. Herein, the average particle diameter of inorganic fine particles is measured by a Coulter Counter

### (Hollow Silica Particles)

For the purpose of reducing the refractive index of the low refractive index layer, hollow silica particles are preferably used. The hollow silica particles has a refractive index of preferably 1.15 to 1.40, further preferably 1.17 to 1.35, and most preferably 1.17 to 1.30. The refractive index herein denotes the refractive index of the whole particles, and does not denote the refractive index of only the silica of the shell forming the hollow silica particle. In this case, the void ratio X is expressed by the following mathematical expression (2):

X={(4πrᵢ³/3)/(4πrₒ³/3)}×100 Mathematical expression (2):

where rᵢ denotes the radius of the void in the particle, and rₒ denotes the radius of the particle shell. The void ratio X of the hollow silica particle is preferably 10 to 60%, further preferably 20 to 60%, and most preferably 30 to 60%.

In order to achieve a sufficiently large thickness of the shell and a high strength as the particle, a particle with a refractive index of 1.15 or more is preferred from the viewpoint of the scratch resistance.

The methods for manufacturing hollow silica particles are described in, for example, JP-A-2001-233611 and JP-A-2002-79616. Particularly preferred is a particle having a void inside the shell, of which the pores are closed. Incidentally, the refractive index of these hollow silica particles can be calculated by the method described in JP-A-2002-79616.

The coating amount of the hollow silica is preferably 1 mg/M² to 100 mg/m², more preferably 5 mg/m² to 80 mg/m², and further preferably 10 mg/m² to 60 mg/m². When the coating amount of the hollow silica is equal to or more than the lower limit value, effects of reducing the refractive index and effects of improving the scratch resistance are exerted. When the coating amount is equal to or less than the upper limit value, fine unevenness is formed on the low refractive index layer surface. Thus, disadvantages including degradation of the outward appearances such as tightness of black, or the integral reflectance, and the like do not occur. Therefore, such a coating amount is preferred.

The average particle diameter of the hollow silica particles is preferably 30% or more and 150% or less, more preferably 35% or more and 80% or less, and further preferably 40% or more and 60% or less, of the thickness of the low refractive index layer. Namely, when the thickness of the low refractive index layer is 100 nm, the particle diameter of the hollow silica particles is preferably 30 nm or more and 150 nm or less, more preferably 35 nm or more and 100 nm or less, and further preferably 40 nm or more and 65 nm or less. When the particle diameter of the silica particles is equal to or more than the lower limit value, the ratio of the void portion does not become too small, and hence the effect of reducing the refractive index is exerted. When the particle diameter is equal to or less than the upper limit value, fine unevenness is formed on the low refractive index layer surface. Thus, disadvantages including degradation of the outward appearances such as tightness of black, or the integral reflectance, and the like do not occur. Thus, such a particle diameter is preferable.

The hollow silica particles may be any of crystalline and amorphous, or is preferably monodispersible particles. The particle is most preferably in a spherical form, but even an amorphous particle does not matter.

Whereas, hollow silica particles different in particle average particle size can be used in combination of two or more thereof. Herein, the average particle diameter of the hollow silica can be determined from an electron micrograph.

In the invention, the specific surface area of the hollow silica particles is preferably 20 to 300 m²/g, further preferably 30 to 120 m²/g, and most preferably 40 to 90 m²/g. The surface area can be determined by using nitrogen with a BET method.

In the invention, void-free silica particles can be used in combination with hollow silica particles. The particle size of the void-free silica is preferably 30 nm or more and 150 nm or less, further preferably 35 nm or more and 100 nm or less, and most preferably 40 nm or more and 80 nm or less.

Whereas, at least one type of silica particles with an average particle diameter which is less than 25% of the thickness of the low refractive index layer (which are referred to as “silica particles with a small particle diameter”) are preferably used in combination with the silica particles with the foregoing particle diameter (which are referred to as “silica particles with a large particle diameter”).

The silica particles with a small particle diameter can exist in the gaps between the silica particles with a large particle diameter, and hence can serve as a holding agent for the silica particles with a large particle diameter.

The average particle diameter of the silica particles with a small particle diameter is preferably 1 nm or more and 20 nm or less, further preferably 5 nm or more and 15 nm or less, and particularly preferably 10 nm or more and 15 nm or less. Use of such silica particles is preferred in terms of the raw material cost and the holding agent effect.

(Surface Treatment)

The silica particles and the hollow silica particles may be subjected to a physical surface treatment such as a plasma discharge treatment or a corona discharge treatment, or a chemical surface treatment by a surfactant or a coupling agent, in order to stabilize the dispersion in the dispersion or in the coating solution, or in order to enhance the affinity or the bonding property with the binder component. These surface treatment agents are added for the treatment in an amount of 0.1 mass % to 100 mass %, further preferably in an amount of 1.0 mass % to 50 mass %, and in particular further preferably in an amount of 5.0 mass % to 35 mass % based on the amount of the metal oxide particles.

As the coupling agent, an alkoxymethane compound (e.g., a titanium coupling agent, or a silane coupling agent) is preferably used. Especially, at least any one of the inorganic fine particles and the hollow silica particles are preferably surface treated by the organosilane compound expressed by the following formula (a):

(R¹¹)ₘ₁−Si(X¹¹)₄₋ₘ₁ Formula (a):

In the formula (a), R¹¹ represents a substituted or unsubstituted alkyl group, or a substituted or unsubstituted aryl group. As alkyl groups, mention may be made of methyl, ethyl, propyl, isopropyl, hexyl, decyl, hexadecyl, and the like. As alkyl groups, mention may be made of preferably the ones with 1 to 30 carbon atoms, more preferably the ones with 1 to 16 carbon atoms, and in particular preferably the ones with 1 to 6 carbon atoms. As aryl groups, mention may be made of phenyl, naphthyl, and the like, and preferably a phenyl group.

X¹¹ represents a hydroxyl group or a hydrolyzable group. Examples thereof may include an alkoxy group (an alkoxy group having 1 to 5 carbon atoms is preferred, and examples thereof may include a methoxy group and an ethoxy group), a halogen atom (e.g., Cl, Br, or I), and a group represented by R¹²COO (where R¹² is preferably a hydrogen atom, or an alkyl group having 1 to 5 carbon atoms, examples of which may include CH₃COO and C₂H₅COO). It is preferably an alkoxy group, and in particular preferably a methoxy group or an ethoxy group.

m1 represents an integer of 0 to 3, and preferably 1 or 2.

When a plurality of R¹¹'s or X¹¹'s are present, a plurality of R¹¹'s or X¹¹'s may be respectively the same or different.

The substituent contained in R¹¹ has no particular restriction. However, mention may be made of a halogen atom (such as fluorine, chlorine, or bromine), a hydroxyl group, a mercapto group, a carboxyl group, an epoxy group, an alkyl group (such as methyl, ethyl, i-propyl, propyl, or t-butyl), an aryl group (such as phenyl or naphthyl), an aromatic heterocyclic group (such as furyl, pyrazolyl, or pyridyl), an alkoxy group (such as methoxy, ethoxy, i-propoxy, or hexyloxy), aryloxy (such as phenoxy), an alkylthio group (such as methylthio or ethylthio), an arylthio group (such as phenylthio), an alkenyl group (such as vinyl or 1-propenyl), an acyloxy group (such as acetoxy, acryloyloxy, or methacryloyl), an alkoxycarbonyl group (such as methoxycarbonyl or ethoxycarbonyl), an aryloxycarbonyl group (such as phenoxycarbonyl), a carbamoyl group (such as carbamoyl, N-methylcarbamoyl, N,N-dimethylcarbamoyl, or N-methyl-N-octylcarbamoyl), an acylamino group (such as acetylamino, benzoylamino, acrylamino, or methacrylamino), or the like. These substituents may be further substituted.

When a plurality of R¹¹'s are present, it is preferable that at least one is a substituted alkyl group or a substituted aryl group.

In the invention, the organosilane compounds in particular preferably usable are organosilane compounds having a vinyl polymerizable substituent out of the organosilane compounds represented by the formula (a). Especially, it is in particular preferable that R¹¹ in the formula (a) is a group containing a (meth)acryloyl group, i.e., that the substituent contained in R¹¹ is a (meth)acryloyloxy group.

Alternatively, the organosilane compound of the formula (a) where R¹¹ is a group containing an epoxy group, i.e., the substituent contained in R¹¹ is an epoxy group can also be in particular preferably used similarly.

It is preferable for the reduction of the load of the surface treatment that silica particles have been previously dispersed in the medium prior to the surface treatment. As the specific compounds of the surface treatment agents and catalysts preferably usable in the invention, for example, mention may be made of the organosilane compounds and the catalysts described in the WO 04/017105 pamphlet.

As the metal oxide particles for use in the low refractive index layer, two types of metal oxide particles having different particle diameters may be used in combination. Particularly, by using metal oxide particles having a particle diameter of 20 nm to 80 nm and metal oxide particles having a particle diameter of 20 nm or less in combination, it is possible to implement both the reflectance and the scratch resistance. I is possible to allow the ratio of the respective amounts of the two types of metal oxide particles having different particle diameters to freely vary between 0 and 1 according to the balance between the desirable reflectance and scratch resistance. When the reflectance is desired to be reduced, it is preferable that the metal oxide particles having a small particle diameter occupy the most part thereof. Whereas, when the scratch resistance is desired to be intensified, it is preferable that the ratio of the metal oxide particles having a large particle diameter is increased.

The amount of the metal oxide particles to be added is preferably 5 to 90 mass %, further preferably 10 to 70 mass %, and in particular preferably 10 to 50 mass % based on the total mass of the low refractive index layer.

### [Dispersion Stabilizer]

In the invention, it is also preferable that a dispersion stabilizer is used in combination for the purpose of inhibiting the sedimentation or precipitation of metal oxide particles in the low refractive index layer. As the dispersion stabilizers herein, there can be used the same ones as the dispersion stabilizers used in the hard coat layer with the same method. The preferred amounts added and the like are also the same.

### [Solvent for Coating Solution for Forming each Layer]

As the solvent composition of the coating solutions to be used for forming the hard coat layer and the low refractive index layer in accordance with the invention, the solvents may be used alone, or in mixture. When in mixture, the solvent with a boiling point of 100° C. or less is in an amount of preferably 50 to 100 mass %, more preferably 80 to 100 mass %, more preferably 90 to 100 mass %, and further preferably 100 mass % based on the total amount of the solvent. When the solvent with a boiling point of 100° C. or less is in an amount equal to or more than the lower limit value, the drying rate does not become too slow. Thus, the coated surface conditions are not deteriorated, or unevenness of the coated film thickness does not occur. Accordingly, favorably, the problems such as deterioration of the optical characteristics such as reflectance do not occur. In the invention, by using a coating solution containing a large amount of solvents with a boiling point of 100° C. or less, these problems can be solved.

Examples of the solvent with a boiling point of 100° C. or less may include hydrocarbons such as hexane (boiling point 68.7, below, “° C.” will be omitted), heptane (98.4), cyclohexane (80.7), and benzene (80.1); hydrocarbon halides such as dichloromethane (39.8), chloroform (61.2), carbon tetrachloride (76.8), 1,2-dichloroethane (83.5), and trichloroethylene (87.2); ethers such as diethyl ether (34.6), diisopropyl ether (68.5), dipropyl ether (90.5), and tetrahydrofuran (66); esters such as ethyl formate (54.2), methyl acetate (57.8), ethyl acetate (77.1), and isopropyl acetate (89); ketones such as acetone (56.1) and 2-butanone (methyl ethyl ketone=MEK, 79.6); alcohols such as methanol (64.5), ethanol (78.3), 2-propanol (82.4), and 1-propanol (97.2); cyano compounds such as acetonitrile (81.6) and propionitrile (97.4); and carbon disulfide(46.2). Out of these, ketones and esters are preferred, and ketones are particularly preferred. Out of the ketones, 2-butanone is particularly preferred.

Examples of the solvent with a boiling point of 100° C. or more may include octane (125.7), toluene (110.6), xylene (138), tetrachloroethylene (121.2), chlorobenzene (131.7), dioxane (101.3), dibutyl ether (142.4), isobutyl acetate (118), cyclohexanone (155.7), 2-methyl-4-pentanone (methyl isobutyl ketone=MIBK, 115.9), 1-butanol (117.7), N,N-dimethylformamide (153), N,N-dimethylacetamide (166), and dimethylsulfoxide (189). Cyclohexanone and 2-methyl-4-pentanone are preferred.

By diluting the hard coat layer and low refractive index layer components in accordance with the invention with the solvent of the foregoing composition, the coating solutions for the formation of the layers are prepared. The coating solution concentration is preferably adjusted in view of the viscosity of the coating solution, the specific gravity of the layer material, and the like. However, it is preferably 0.1 to 20 mass %, and more preferably 1 to 10 mass %.

### [Transparent Support]

As the transparent support of the antireflection film of the invention, a plastic film is preferably used. As the polymer for forming a plastic film, mention may be made of cellulose ester {e.g., triacetyl cellulose or diacetyl cellulose, typically, “TAC-TD80U”, “TAC-TD80U”, or “TAC-TD80UF” manufactured by Fuji Photo Film, Co., Ltd., (all trade names)}, polyamide, polycarbonate, polyester (e.g., polyethylene terephthalate, or polyethylene naphthalate), polystyrene, polyolefin, norbornene type resin {“ARTON” (trade name), manufactured by JSR Co., Ltd.}, amorphous polyolefin {“ZEONEX” (trade name), manufactured by ZEON Corporation}, or the like. Out of these, triacetyl cellulose, polyethylene terephthalate, and polyethylene naphthalate are preferred. Triacetyl cellulose is particularly preferred.

The triacetyl cellulose film is formed of a single layer or a plurality of layers. The single-layer triacetyl cellulose film is manufactured by drum casting, band casting, or the like disclosed in JP-A-7-11055, and the like, and the latter triacetyl cellulose film formed of a plurality of layers is manufactured by a so-called co-casting method disclosed in JP-A-61-94725, JP-B-62-43846, and the like.

Namely, the method includes the following steps. Raw material flakes are dissolved in solvents such as hydrocarbon halides (e.g., dichloromethane), alcohols (e.g., methanol, ethanol, and butanol), esters (e.g., methyl formate, and methyl acetate), and ethers (e.g., dioxane, dioxolane, and diethyl ether). To this, were added, if required, various additives such as a plasticizer, an ultraviolet absorber, a deterioration inhibitor, a slipping agent, and a release accelerator. The resulting solution (referred to as a dope) is cast on a support formed of a horizontal endless metal belt or a rotating drum with a dope feed means (referred to as a die). In this step, for a single layer, a single dope is cast to a single layer, and for a multilayer, a low-concentration dope is co-cast in both sides of a high-concentration cellulose ester dope. The dope is then dried to a certain degree on the support to impart rigidity to the resulting film. The film is released from the support, and then passed through a drying zone with various transportation means to remove the solvents.

The foregoing solvent for dissolving triacetyl cellulose is typically dichloromethane. However, from the viewpoints of global environment and working environment, it is preferable that the solvent substantially does not contain hydrocarbon halide such as dichloromethane. The wording “substantially does not contain” denotes that the proportion of hydrocarbon halide in the organic solvent is less than 5 mass % (preferably less than 2 mass %). When a dope of triacetyl cellulose is prepared using a solvent substantially not containing dichloromethane or the like, the following specific dissolution method becomes essential.

A first method is referred to as a cooling dissolution method, and will be described below.

First, triacetyl cellulose is gradually added into a solvent with stirring at a temperature in the vicinity of room temperature (−10 to 40° C.). Then, the mixture is cooled to −100 to −10° C. (preferably from −80 to −10° C., more preferably from −50 to −20° C., and most preferably from −50 to −30° C.). The cooling may be performed, for example, in a dry ice/methanol bath (−75° C.) or in a cooled diethylene glycol solution (−30 to −20° C.). Such cooling causes the mixture of triacetyl cellulose and the solvent to be solidified. This is further heated to 0 to 200° C. (preferably from 0 to 150° C., more preferably from 0 to 120° C., and most preferably from 0 to 50° C.), thereby to turn into a solution where triacetyl cellulose flows in the solvent. The temperature may be elevated by only allowing the solidified mixture to stand at room temperature, or may also be elevated in a warm bath.

A second method is referred to as a high-temperature dissolution method, and will be described below.

First, triacetyl cellulose is gradually added into a solvent with stirring at a temperature in the vicinity of room temperature (−10 to 40° C.). The triacetyl cellulose solution for use in the invention is preferably swelled in advance by adding triacetyl cellulose to a mixed solvent containing various solvents. In this method, the triacetyl cellulose is preferably dissolved to a concentration of 30 mass % or less, however, in view of the drying efficiency for film formation, the concentration is preferably as high as possible. Then, the organic solvent mixed solution is heated to 70 to 240° C. (preferably from 80 to 220° C., more preferably from 100 to 200° C., and most preferably from 100 to 190° C.) under a pressure of 0.2 MPa to 30 MPa. The heated solution cannot be coated as it is, and hence it is then required to be cooled to a temperature equal to, or lower than the lowest boiling point of the solvents used. In this case, the solution is generally cooled to −10 to 50° C., and returned to normal pressure. The cooling may be performed only by allowing a high-pressure high-temperature container or line in which the triacetyl cellulose solution is stored to stand at room temperature. More preferably, the device may also be cooled using a refrigerant such as cooling water.

The cellulose acetate film substantially not containing hydrocarbon halide such as dichloromethane, and a manufacturing method thereof are described in Journal of Technical Disclosure (KOUKAI GIHOU) from Japan Institute of Invention and Innovation (Technical Disclosure No. 2001-1745, published on Mar. 15, 2001, which will be abbreviated as Technical Disclosure No. 2001-1745).

### [Production Process of Optical Film]

The production process of an optical film of the present invention is a production process of an optical film having at least one layer of functional layer on a transparent support, and comprises a step of forming the at least one layer of functional layer by coating and drying a coating composition, and curing it by a heat energy and a light energy.

In the production process of the present invention, the foregoing coating composition can be used.

The at least one layer of functional layer is preferably a layer in contact with the surface of a transparent support. And the at least one layer of functional layer is preferably a low refractive index layer and/or a hard coat layer.

The at least one layer of functional layer may be at least two layers of functional layers, and the at least two layers of functional layers are preferably a hard coat layer and an antireflection layer.

The respective layers of the optical film in a multilayer configuration can be formed by coating with a dip coating method, an air knife coating method, a curtain coating method, a roller coating method, a die coating method, a wire bar coating method, a gravure coating method, or an extrusion coating method (see, U.S. Pat. No. 2,681,294). However, coating is preferably carried out with a die coating method. Further, coating is more preferably carried out by means of a novel die coater described later. It is also acceptable that two or more layers are simultaneously coated. The simultaneous coating method is described in U.S. Pat. Nos. 2,761,791, 2,941,898, 3,508,947, and 3,526,528, and KOUTINGU KOUGAKU, written by Yuji Harasaki, ASAKURA Publishing Co., Ltd., (1973), p. 253.

In order to continuously manufacture the optical film of the invention, for example, a step of continuously uncoiling and feeding a roll-like support film (transparent support), a step of coating/drying the coating solution, a step of curing the coating film, and a step of coiling the base material film having the cured layer are carried out.

Specifically, the steps are carried out in the following manner.

A base material film is continuously uncoiled and fed from the base material film in a roll film to a clean chamber. In the clean chamber, electrostatic charges accumulated on the base material film are eliminated by an electrostatic charge eliminating device. Subsequently, foreign matters deposited on the base material film are removed by a dust removing device. Subsequently, at a coating part set in the clean chamber, a coating solution is coated on the base material film, and the coated film support is fed to a drying chamber, and dried.

The base material film having the dried coating layer is fed from the drying chamber to a heat curing chamber, and heated and cured. Then, it is fed into a radiation curing chamber, and irradiated with radiation. Thus, the monomers contained in the coating layer are polymerized and cured. If required, it is directly fed to the radiation curing chamber, and irradiated with radiation. Thus, the monomers contained in the coating layer are polymerized, so that the curing is completed. The base material film having the completely cured layer is coiled in a roll.

In the invention, from the viewpoint of higher production speed, as the coating method, a die coating method is preferably used. The die coating method is preferably used because it can implement both of the productivity and the surface conditions without uneven coating on a high level.

### [Curing Method]

In the invention, to the curing method with a plurality of energies of a heat energy and a light energy, any of the following methods, or a combination of the following methods is preferably applicable.

The heat energy and the light energy are preferably sequentially or simultaneously applied more than once.

(a) On a transparent support, a coating composition is coated, and dried, and then, ionizing radiation is directly applied thereto, followed by a heat treatment;

(b) On a transparent support, a coating composition is coated, and dried, followed by a heat treatment, and then ionizing radiation is applied thereto;

(c) On a transparent support, a coating composition is coated, and dried, and then ionizing radiation is directly applied thereto while heating;

(d) On a transparent support, a coating composition is coated, and dried, and then ionizing radiation is directly applied thereto. Then, further, a second layer is coated and dried, and further subjected to a heat treatment;

(e) On a transparent support, a coating composition is coated, and dried, and then, ionizing radiation is directly applied thereto. Then, further, a second layer is coated and dried, and subjected to a heat treatment, and then, ionizing radiation is applied thereto;

(f) On a transparent support, a coating composition is coated, and dried, followed by a heat treatment. Then, a second layer is coated and dried, and ionizing radiation is applied thereto;

(g) On a transparent support, a coating composition is coated, and dried, followed by a heat treatment. Then, further, a second layer is coated and dried, and subjected to a heat treatment. Then, further, ionizing radiation is applied thereto; and

(h) On a transparent support, a coating composition is coated, and dried, and then, ionizing radiation is directly applied thereto. Then, further, a second layer is coated and dried, and subjected to a heat treatment. Then, further, ionizing radiation is applied thereto while heating.

In the manufacturing method of the optical film of the invention, out of the curing methods (a) to (h), the curing methods (a) to (c) are preferred for the optical film having at least one layer of functional layer. Whereas, for the optical film having at least two layers of functional layers, the curing methods (d) to (h) are preferred, and further, the curing methods (e) and (h) are preferred.

In the foregoing description, when a thermal polymerization initiator and a thermal crosslinking agent are used in combination, only a heat treatment after drying causes polymerization and thermal crosslinking curing simultaneously. Thus, this case is efficient.

Further, in the foregoing case, for curing through irradiation with ionizing radiation, curing is preferably accomplished by the following step. Ionizing radiation is applied in an atmosphere with an oxygen concentration of 3% by volume or less, and the film is held in an atmosphere with an oxygen concentration of 3% by volume or less for 0.5 second or more from the start of irradiation with ionizing radiation. By setting the conditions in which inert gases are supplied to an ionizing radiation exposure chamber, and slightly blows toward the web inlet of the exposure chamber, the transferred air guided with web transfer is eliminated, which can effectively reduce the oxygen concentration of the reaction chamber, and can efficiently reduce the substantial oxygen concentration on the top surface on which high inhibition on curing due to oxygen is caused. The direction of flow of inert gases on the web inlet side of the exposure chamber can be controlled by adjusting the balance between air supply and exhaust of the exposure chamber, and the like.

Direct blowing of inert gases onto the web surface is also preferably used as a method for eliminating the transferred air. Particularly, it is preferable that the low refractive index layer which is the outermost layer and has a small film thickness is cured with this method.

Further, by providing a front room in front of the reaction chamber, and previously eliminating the oxygen on the web surface, it is possible to promote curing with more efficiency. Whereas, with the side forming the web inlet side of the ionizing radiation reaction chamber or the front chamber, the gap from the web surface is preferably 0.2 to 15 mm, more preferably 0.2 to 10 mm, and most preferably 0.2 to 5 mm in order to use inert gases with efficiency.

However, in order to continuously manufacture webs, the webs are required to be bonded together, and connected. For bonding, a method for bonding with a bonding tape is widely used. Thus, when the gap between the inlet side of the ionizing radiation reaction chamber or the front chamber and the web is set to be too narrow, unfavorably, a bonding member such as a bonding tape is caught therein. For this reason, for narrowing the gap, preferably, at least a part of the inlet side of the ionizing radiation reaction chamber or the front chamber is set movable. Thus, when the bonded part enters, the gap is expanded by the bonding thickness. For implementing this, there can be employed a method in which the inlet side of the ionizing radiation reaction chamber or the front chamber is set movable to and fro along the direction of advance, so that the inlet side moves to and fro when the bonded part passes therethrough, thereby to expand the gap; and a method in which the inlet side of the ionizing radiation reaction chamber or the front chamber is set movable perpendicularly to the web side, so that the inlet side moves vertically when the bonded part passes therethrough, thereby to expand the gap.

The oxygen concentration of the atmosphere when ionizing radiation is applied is 3% by volume or less, preferably 1% by volume or less, and further preferably 0.5% by volume or less. The reduction of the oxygen concentration requires a large quantity of inert gases such as nitrogen. Therefore it is preferable that the oxygen concentration is not reduced more than necessary from the viewpoint of the manufacturing cost. The means for reducing the oxygen concentration is as follows: the air (nitrogen concentration: about 79% by volume, oxygen concentration: about 21% by volume) is preferably replaced with another inert gas, and in particular preferably replaced with nitrogen (purged with nitrogen).

In the invention, preferably, at least one layer stacked on the transparent base material is irradiated with ionizing radiation in an atmosphere with an oxygen concentration of 3% by volume or less, and held in an atmosphere with an oxygen concentration of 3% by volume or less for 0.5 second or more from the start of irradiation with ionizing radiation. The time during which the layer is held in the low oxygen concentration atmosphere is preferably 0.7 second or more and 60 seconds or less, and more preferably 0.7 second or more and 10 seconds or less. When the low oxygen concentration holding time is 0.5 second or more, the curing reaction sufficiently proceeds, and sufficient curing can be carried out. Thus, this case is preferable. Whereas, the low oxygen conditions are held for a long time results in large scale equipment, which requires a large quantity of inert gases. Therefore, the time is preferably 60 seconds or less.

In the invention, at least one layer stacked on the transparent support can be cured through a plurality of cycles of ionizing radiation exposure. In this case, at least two cycles of ionizing radiation exposure are preferably carried out in continuous reaction chambers with an oxygen concentration of not more than 20% by volume. By carrying out a plurality of cycles of ionizing radiation exposure in the reaction chambers with the same low oxygen concentration, it is possible to effectively ensure the reaction time required for curing. Especially when the manufacturing rate is raised for the high productivity, a plurality of cycles of ionizing radiation exposure are preferably carried out for ensuring the energy of ionizing radiation required for the curing reaction. Thus, together with ensuring of the reaction time necessary for the curing reaction, the foregoing embodiment is effective.

The ionizing radiation species in the invention has no particular restriction. It can be appropriately selected from ultraviolet ray, electron beam, near-ultraviolet ray, visible light, near-infrared ray, infrared ray, X ray, and the like according to the type of the curable composition forming the film. However, irradiation with an ultraviolet ray is preferred in the invention. Ultraviolet ray curing is preferred because the polymerization rate is high and the equipment can be made compact, and the selectable compound species are abundant and low-priced.

For an ultraviolet ray, there can be used a super high pressure mercury lamp, a high pressure mercury lamp, a low pressure mercury lamp, carbon arc, xenon arc, a metal halide lamp, or the like. Whereas, for electron beam irradiation, there are used electron beams having an energy of 50 to 1000 keV, emitted from various electron beam accelerators of Cockroft Walton type, van de Graaff type, resonance transform type, insulating core transformer type, linear type, Dynamitron type, high frequency type, and the like.

### [Use of Antireflection Film]

When the antireflection film of the invention is used for, for example, a liquid crystal display apparatus, it can be disposed on the outermost surface of the display apparatus by disposing a self-adhesive layer on one side, or the like. Whereas, as a protective film for protecting a polarizing film of a polarizing plate, a triacetyl cellulose film is often used. However, when the transparent support of the antireflection film of the invention is a triacetyl cellulose film, it is preferable in cost to use the antireflection film as the protective film as it is.

### [Saponification Treatment]

For the antireflection film of the invention, when a self-adhesive layer is disposed on one side, or the like, and the film is disposed on the outermost surface of the display apparatus, or used as it is as a protective film for a polarizing plate, it is preferable in order to achieve sufficient adhesion that a saponification treatment is carried out after the formation of the outermost layer on the transparent support.

The saponification treatment is carried out by a known technique, for example, by immersing the antireflection film in an alkali solution for a proper time. After immersion in the alkali solution, preferably, the film is sufficiently washed with water, or immersed in a dilute acid to neutralize the alkali component for preventing the alkali component from remaining in the film. By carrying out the saponification treatment, the surface of the transparent support opposite from the side having the outermost layer is made hydrophilic.

The surface which has been made hydrophilic is particularly effective for improving the adhesion with the polarizing film containing polyvinyl alcohol as a main component. Further, on the surface which has been made hydrophilic, dust in the air becomes less likely to be deposited. Therefore, for adhesion with the polarizing film, dust is less likely to enter between the polarizing film and the antireflection film, which is effective for preventing the point defects due to dust.

The saponification treatment is carried out so that the contact angle to water of the surface of the transparent support opposite from the side having the outermost layer is preferably 40° or less, further preferably 30° or less, and in particular preferably 20° or less.

Specific means of an alkali saponification treatment can be selected from the following two. The following method (1) is excellent in that the treatment can be carried out by the same step as for a general-purpose triacetyl cellulose film. However, the saponification treatment is carried out even on the antireflection film surface. Therefore, the surface is alkali hydrolyzed, so that the film is deteriorated; and when the saponification treatment solution remains, it becomes stain. These points may become problems. In that case, the following method (2) is excellent, although it is a specific step.

(1) On a transparent support, an antireflection film is formed. Then, it is immersed in an alkali solution at least one time. As a result, the back side of the film is subjected to a saponification treatment; and

(2) Before or after the formation of an antireflection film on a transparent support, an alkali solution is coated to the side of the antireflection film opposite from the side on which the antireflection film is formed, followed by heating, washing with water and/or neutralization. As a result, only the back side of the film is subjected to a saponification treatment.

### <Use of Antireflection Film>

### [Polarizing Plate]

The polarizing plate is mainly formed of two sheets of protective films interposing the polarizing film from the opposite sides. The antireflection film of the invention is preferably used for at least one of two protective films interposing the polarizing film from the opposite sides. The antireflection film of the invention also serves as a protective film. This can reduce the manufacturing cost of the polarizing plate. Further, by using the antireflection film of the invention for the outermost layer, glare of external light or the like is prevented. This can result in a polarizing plate also excellent in scratch resistance, stain proof property, and the like.

### [Polarizing Film]

As the polarizing films, there may be used known polarizing film, and a polarizing film cut out from a long length of polarizing film of which the absorption axis is not in parallel with, nor perpendicular to the longitudinal direction. The long length of the polarizing film of which the absorption axis is not in parallel with, nor perpendicular to the longitudinal direction is fabricated in the following manner.

Namely, it is a polarizing film obtained by drawing a continuously fed polymer film under a tension while holding the opposite sides of the film by a holding means. It can be manufactured by the following drawing method. The film is drawn at least to 1.1 to 20.0 times its original length in the direction of film width; the difference in advance speed along the longitudinal direction of the holding device for the film opposite sides falls within 3%; and the direction of advance of the film is bent with the film opposite sides being held so that the angle of inclination formed between the direction of advance of the film at the outlet in the step of holding the film opposite sides and the substantial drawing direction of the film is 20 to 70°.

The drawing method of the polymer film is described in details in paragraph Nos. 0020 to 0030 of JP-A-2002-86554.

It is also preferable that out of the two protective films of the polarizing film, the other film than the antireflection film is an optical compensation film including an optically anisotropic layer. The optical compensation film (phase film) can improve the viewing angle characteristics of the liquid crystal display screen. As the optical compensation films, known ones can be used. However, the optical compensation film described in JP-A-2001-100042 is preferred in terms of expansion of the viewing angle.

### [Display Apparatus]

The antireflection film of the invention is used for a display apparatus such as a liquid crystal display apparatus (LCD), a plasma display panel (PDP), an electroluminescence display (ELD), or a cathode ray tube display apparatus (CRT).

### [Liquid Crystal Display Apparatus]

The antireflection film of the invention, and a polarizing plate using the same can be advantageously used for a display apparatus such as a liquid crystal display apparatus, and they are preferably used for the outermost layer of the display.

The liquid crystal display apparatus has a liquid crystal cell, and two polarizing plates disposed on the opposite sides thereof. The liquid crystal cell carries a liquid crystal between two electrode substrates. Further, one optically anisotropic layer is disposed between the liquid crystal cell and one polarizing plate, or two layers may be disposed between the liquid crystal cell and both the polarizing plates.

The liquid crystal cell is preferably of the TN mode, the VA mode, the OCB mode, the IPS mode or the ECB mode.

(TN mode)

In the TN mode liquid crystal cell, when applied with no voltage, rod-like liquid crystalline molecules are substantially horizontally oriented, and further twistedly oriented at 60 to 120°.

The TN mode liquid crystal cells are most often used for color TFT liquid crystal display apparatuses, and described in a large number of documents.

### [VA Mode]

In the VA mode liquid crystal cell, when applied with no voltage, rod-like liquid crystalline molecules are substantially vertically oriented.

The VA mode liquid crystal cells include:
(1) a VA mode liquid crystal cell in a narrow sense (described in JP-A-2-176625) in which rod-like liquid crystalline molecules are substantially vertically oriented when applied with no voltage, and substantially horizontally oriented when applied with a voltage; in addition to this,
(2) (MVA mode) liquid crystal cell in which the VA mode has been rendered in a multidomain alignment for expanding the viewing angle {described in SID97, Digest of tech. Papers (Digest of Papers), 28th, (1997), p. 845};
(3) Liquid crystal cell of the monde (n-ASM mode) in which rod-like liquid crystalline molecules are substantially vertically oriented when applied with no voltage, and oriented in a twisted multidomain alignment when applied with a voltage (described in Digest of Papers of the Japanese Liquid Crystal Forum, 58 to 59 (1998)); and
(4) SURVAIVAL mode liquid crystal cell (published in “LCD International 98”). (OCB mode)

The OCB mode liquid crystal cell is a liquid crystal cell of the bend orientation mode in which rod-like liquid crystalline molecules are oriented substantially in opposite directions (symmetrically) at the upper portion and at the lower portion of the liquid crystal cell. It is disclosed in each specification of U.S. Pat. Nos. 4,583,825 and 5,410,422. The rod-like liquid crystalline molecules are symmetrically oriented at the upper portion and the lower portion of the liquid crystal cell, and hence the bend orientation mode liquid crystal cell has a self optical compensatory function. For this reason, this liquid crystal mode is also referred to as OCB (Optically Compensatory Bend) liquid crystal mode. The bend orientation mode liquid crystal display apparatus has an advantage of having a high response speed.

(IPS Mode)

The IPS mode liquid crystal cell is of a system of applying a nematic liquid crystal with a horizontal electric field for switching. It is described in details in Proc. IDRC (Asia Display '95), p. 577 to 580, and p. 707 to 710.

(ECB Mode)

In the ECB mode liquid crystal cell, rod-like liquid crystalline molecules are substantially horizontally oriented when applied with no voltage. The ECB mode is one of the liquid crystal display modes having the simplest structure, and it is described in details, for example, JP-A-5-203946.

[Other Display than Liquid Crystal Display Apparatuses]

### (PDP)

A plasma display panel (PDP) generally includes a gas, glass substrates, electrodes, an electrode lead material, a thick film printing material, and a phosphor. The glass substrates include two substrates of a front glass substrate and a rear glass substrate. On the two glass substrates, electrodes and insulating layers are formed. On the rear glass substrate, a phosphor layer is further formed. The two glass substrates are assembled, and a gas is filled therebetween.

The plasma display panels (PDPs) have been already commercially available. The plasma display panels are described in each publication of JP-A-5-205643 and JP-A-9-306366.

The front panel may be disposed at the front of the plasma display panel. The front panel preferably has a sufficient strength for protecting the plasma display panel. The front panel can be used on the plasma display panel with a gap interposed therebetween, or it can also be directly bonded to the plasma main body for use.

For an image display apparatus such as a plasma display panel, as an optical filter, the antireflection film of the invention can be directly bonded to the display surface. Whereas, when a front panel is provided in front of a display, to the surface side (outer side) or the rear side (display side) of the front panel, an antireflection film as an optical filter can also be boded.

(Touch Panel)

The antireflection film of the invention can be applied to the touch panel, or the like described in JP-A-5-127822, JP-A-2002-48913, or the like.

(Organic EL Element)

The antireflection film of the invention can be used as a protective film of an organic EL element, or the like.

When the antireflection film of the invention is used for an organic EL element, or the like, the contents described in respective publications of JP-A-11-335661, JP-A-11-335368, JP-A-2001-192651, JP-A-2001-192652, JP-A-2001-192653, JP-A-2001-335776, JP-A-2001-247859, JP-A-2001-181616, JP-A-2001-181617, JP-A-2002-181816, JP-A-2002-181617, JP-A-2002-056976, and the like are applicable. Further, these are preferably used in combination with the contents described in respective publications of JP-A-2001-148291, JP-A-2001-221916, and JP-A-2001-231443.

### [Various Characteristic Values]

Below, various measuring methods and the preferred characteristic values for the antireflection film of the invention will be shown.

### [Reflectance]

The mirror reflectance and the color taste can be measured in the following manner. A spectro photometer “V-550” [manufactured by JASCO Corporation] is equipped with an adaptor “ARV-474”. Thus, the mirror reflectance at an output angle of −5° with an incident angle of 50 within a wavelength region of 380 to 780 nm is measured. Then, the average reflectance over 450 to 650 nm is calculated. As a result, the antireflection property can be evaluated.

The integral reflectance can be measured in the following manner. The sample is mounted on an integrating sphere of a spectro photometer “V-550” [manufactured by JASCO Corporation], and the integral reflectance in a wavelength region of from 380 to 780 nm is measured, and then the average reflectance over 450 to 650 nm is calculated.

### [Color Taste]

As for a polarizing plate using the antireflection film of the invention as the protective film, the color taste can-be evaluated in the following manner. The color taste of the regular reflection light, i.e., the L*, a*, and b* values in the CIE 1976 L*a* b* color space are determined for the incident light at an incident angle of 5° within a wavelength region of from 380 nm to 780 nm of the CIE standard source D₆₅.

The L*, a*, and b* values preferably fall within the ranges of 3≦L*≦20, −7≦a≦7, and −10≦b*≦10, respectively. By setting the values within these ranges, respectively, the color taste of the red-purple to blue-purple reflection light, which has become a problem for a conventional polarizing plate, is reduced. Further, it is largely reduced by setting the values within the ranges of 3≦L*≦10, 0≦a*≦5, and −7≦b*≦0, respectively. In the case where the film is applied to a liquid crystal display apparatus, the color taste when an external light with a high luminance such as a light from an indoor fluorescent lamp has been slightly reflected therein is neutral, and not annoying. Specifically, when a*≦7, the red tinge does not become too intense. When a*≧−7, the cyan tinge does not become too intense. Thus, these cases are preferable. Whereas, when b*≧−7, the blue tinge does not become too intense. When b*≦0, the yellow tinge does not become too intense. Thus, these cases are preferable.

Further, the color taste uniformity of a reflection light can be obtained as the rate of change in color taste according to the following mathematical expression (3) from a*, and b* on the L*a*b* chromaticity diagram determined by the reflection spectrum at 380 nm to 680 nm of the reflected light.

Mathematical expression (3):

$$Rate of change in color taste ( {a}^{*} ) = \frac{{a}_{max}^{*} - {a}_{min}^{*}}{{a}_{av}^{*}} \times 100$$

$$Rate of change in color taste ( {b}^{*} ) = \frac{{b}_{max}^{*} - {b}_{min}^{*}}{{b}_{av}^{*}} \times 100$$

where a*ₘₐₓ and a*ₘᵢₙ are the maximum value and the minimum value of the a* value, respectively; b*ₘₐₓ and b*ₘᵢₙ are the maximum value and the minimum value of the b* value, respectively; and a*ₐᵥ and b*ₐᵥ are the average values of the a* values and the b* values, respectively. Each rate of change in color is preferably 30% or less, more preferably 20% or less, and most preferably 8% or less.

Whereas, for the antireflection film of the invention, the ΔE_{w}, which is the change in color taste between before and after the weather resistance test, is preferably 15 or less, more preferably 10 or less, and most preferably 5 or less. Within this range, it is possible to implement both low reflection and reduction of color taste of reflected light. Therefore, for example, when the film is applied to the outermost surface of a display apparatus, the color taste when an external light with a high luminance such as a light from an indoor fluorescent lamp has been slightly reflected therein is neutral, and the quality of the displayed images is favorable. Thus, such a case is preferable.

The change in color taste ΔE_{w} can be determined according to the following mathematical expression (4).

ΔE_{w}=[(ΔL_{w})²+(Δa_{w})²+(Δb_{w})²]^{1/2} Mathematical expression (4).

where ΔL_{w}, Δa_{w}, and Δb_{w} are the amounts of changes in L* value, a* value, and b* value between before and after the weather resistance test, respectively.

### [Transmitted Image Visibility]

The transmitted image visibility can be measured by the use of an optical comb with a slit width of 0.5 mm with an image clarity measuring device “ICM-2D model” manufactured by SUGA TEST Instruments Co., Ltd., according to JIS K-7105.

The transmitted image visibility of the antireflection film of the invention is preferably 60% or more. The transmitted image visibility is generally an index indicative of the degree of blur of the image seen through the film. A larger value thereof indicates that the image shown through the film is clearer and better. The transmitted image visibility is preferably 70% or more, and further preferably 80% or more.

### [Surface Roughness]

The measurement of the centerline average roughness (Ra) in the antireflection film of the invention can be carried out according to JIS B-0601.

### [Haze]

For the haze of the antireflection film of the invention, there was used the automatically measured value as haze=(diffused light/entire transmitted light)×100 (%) measured by means of a turbidity meter “NDH-1001DP” manufactured by Nippon Denshoku Industries Co., Ltd.

The haze of the antireflection film of the invention is preferably 1.5% or less, further preferably 1.2% or less, and most preferably 1.0% or less.

### [Goniophotometer Scattering Intensity Ratio]

By means of an automatic variable angle photometer (GP-5 model) {manufactured by MURAKAMI COLOR RESEARCH LABORATORY Co., Ltd.}, an antireflection film was disposed vertically to the incident light, and the scattered light profile was measured in every direction. It can be determined from the scattered light intensity at an output angle of 30° to the light intensity at an output angle of 0°.

### [Scratch Resistance]

### (Steel Wool Abrasion Resistance Evaluation)

A rubbing test is carried out by means of a “rubbing tester” under the following conditions, so that the index of the scratch resistance can be obtained.

Evaluation environment conditions: 25° C., 60% RH

Rubbing material: steel wool {grade No. 0000 manufactured by Japan Steel Wool Co., Ltd.} is wound around the rubbing tip (1 cm×1 cm) of the tester to be in contact with a sample, and fixed with a band.

Stroke (one way): 13 cm

Rubbing speed: 13 cm/sec,

Load: 500 g/cm², and 200 g/cm²

Tip contact area: 1 cm×1 cm, and

Number of cycles of rubbing: 10 reciprocations.

To the back side of the sample which has been completely rubbed, an oil-based black ink is applied. Thus, the scratches at the rubbed part are visually observed with reflected light, or the difference in reflected light amount from the part other than the rubbed part is visually observed. Thus, the evaluation is carried out.

(Eraser Scratch Resistance Evaluation)

A rubbing test is carried out by means of a “rubbing tester” under the following conditions, so that the index of the scratch resistance can be obtained.

Evaluation environment conditions: 25° C., 60% RH

Rubbing material: plastic eraser {MONO manufactured by Tombow Pencil Co., Ltd.} is fixed at the rubbing tip (1 cm×1 cm) of the tester to be in contact with a sample.

Stroke (one way): 4 cm

Rubbing speed: 2 cm/sec,

Load: 500 g/cm²

Tip contact area: 1 cm×1 cm, and

Number of cycles of rubbing: 100 reciprocations.

To the back side of the sample which has been completely rubbed, an oil-based black ink is applied. Thus, the scratches at the rubbed part are visually observed with reflected light, and the difference in reflected light amount from the part other than the rubbed part is visually observed. Thus, the evaluation is carried out.

### [Taber Test]

With the taber test according to JIS K-5400, it is possible to evaluate the scratch susceptibility from the abrasion loss of a test piece before and after the test. The smaller abrasion loss is more preferred.

[Hardness]

### (Pencil Hardness)

The hardness of the antireflection film of the invention can be evaluated with the pencil hardness test according to JIS K-5400. The pencil hardness is preferably H or more, further preferably 2H or more, most preferably 3H or more.

[Surface Elastic Modulus]

The surface elastic modulus of the antireflection film of the invention is the value determined by the use of a micro surface harness meter {“Fischer scope H100VP-HCU”: manufactured by Fischer Instruments K. K.}. Specifically, it is the elastic modulus determined in the following manner. By the use of a quadrangular pyramid indenter made of diamond (apex angle between opposite faces; 136°), the indentation depth under an appropriate test load is measured so long as the indentation depth does not exceed 1 μm. Thus, the elastic modulus is determined from the changes in load and displacement with the load being removed.

### [Universal Hardness]

Alternatively, the surface hardness can also be determined as a universal hardness by the use of the micro surface meter. The universal hardness is the value determined in the following manner. The indentation depth under a test load of a quadrangular pyramid indenter is measured. The surface area of the indentation formed under the test load is calculated from the geometrical form of the indention. Then, the test load is divided by the surface area of the indentation. It is known that the surface elastic modulus and the universal hardness have a positive correlation.

### [Stain Proof Property Test]

### (Magic Ink Wiping Property)

An antireflection film is fixed on a glass side with a self adhesive. Under the conditions of 25° C., 60 RH %, a 5-mm dia circle is drawn three times with a pen tip (fine) of a black “Magic Ink” (“McKee extra fine”) {trade name: manufactured by Zebra Co., Ltd.}. After 5 seconds, it is wiped off through 20 reciprocations of “BEMCOT” folded in ten layers {trade name: manufactured by Asahi Kasei Corporation} under such a degree of load that the bundle of “BEMCOT” is dented. Until the “Magic Ink” mark is eliminated with wiping off, the writing and the wiping off are repeated under the same conditions. Thus, the stain proof property can be evaluated by the number of cycles of wiping off whereby the wiping off can be completed.

The number of cycles required until the wiping operation becomes incapable of elimination is preferably 5 or more, and further preferably 10 or more.

For the black “Magic Ink”, “Magic Ink No. 700 (M700-T1 black) extra fine” is used. On a sample, a 1-cm dia circle is drawn and filled in, and it is rubbed with “BEMCOT” after 24-hour standing. Then, the evaluation can also be made based on whether the “Magic Ink” can be wiped off, or not.

### [Surface Tension]

In the invention, the surface tension of a coating solution for forming a functional layer such as a low refractive index layer can be measured by means of a surface tension meter under an environment of a temperature of 25° C. {“KYOWA CBVP SURFACE TENSIOMETER A3”, manufactured by KYOWA INTERFACE SCIENCE Co., Ltd.}.

### [Contact Angle]

By the use of a contact angle meter [“CA-X” model contact angle meter, manufactured by KYOWA INTERFACE SCIENCE Co., Ltd.], a droplet with a diameter of 1.0 mm is formed on the needle tip using pure water as a liquid in dry state (20° C., 65% RH). This is brought in contact with the surface of the antireflection film to form a droplet on the film. Out of the angles formed between the tangent to the liquid surface and the antireflection film surface at a point at which the antireflection film comes in contact with the liquid, the angle on the side inclusive of the liquid is referred to as a contact angle.

### [Surface Free Energy]

The surface energy can be determined by a contact angle method, a wet heat method, and an adsorption method, as described in NURE NO KISO TO OUYOU, {published by REALIZE Inc., issued in 1989, December, 10}. For the film of the invention, the contact angle method is preferably used. Specifically, two solutions having known surface energies are added dropwise on a cellulose acylate film. Out of the angles formed between the tangent drawn to the droplet and the film surface at the point of intersection of the droplet surface and the film surface, the angle inclusive of the droplet is defined as the contact angle. It is possible to calculate the surface energy of the film by calculation.

The surface free energy (γs^{v}: unit, mN/m) of the antireflection film of the invention represents the surface tension of the antireflection film defined as the value γs^{v} (=γs^{d}+γs^{h}) expressed as the sum of the values γs^{d} and γs^{h} determined by the following simultaneous equations a and b {mathematical expression (5)}, from the respective contact angles θ_{H2O} and θ_{CH2I2} of pure water H₂O and methylene iodide CH₂I₂ experimentally determined on the antireflection film, using for reference, J. Appl. Polym. Sci., vol. 13, p. 1741 (1961) of D. K. Owens. A smaller γS^{v} and a lower surface free energy result in higher surface repellency, so that the stain proof property is generally excellent.

a. 1+cos θH2O=2√γs^{d}(√γH2O^{d}/γH2O^{v})+2√γs^{h}(√γH2O^{h}/γH2O^{v})

b. 1+cos θCH2I2=2√γs^{d}(√γCH2I2^{d}/γCH2I2^{v})+2√γs^{h}(√γCH2I2^{h}/γH2O^{v})

γH2O^{d}=21.8, γH2O^{h}=51.0, γH2O^{v}=72.8,

γCH2I2^{d}=49.5, γCH2I2^{h}=1.3, γCH2I2^{v}=50.8 Mathematical expression (5);

The measurement of the contact angle was carried out in the following manner. The antireflection film was humidity controlled under the conditions of 25° C., 60% RH for 1 hour or more. Then, by the use of an automatic contact angle meter “CA-V150 model”, manufactured by KYOWA INTERFACE SCIENCE Co., Ltd., 2 μL of droplets was added dropwise on the film. Then, after 30 seconds, the contact angle was determined.

The surface free energy of the antireflection film of the invention is preferably 25 mN/m or less, and in particular preferably 20 mN/m or less.

### [Curl]

The measurement of the curl is carried out using a template for curl measurement of the method A in Method for measuring the curl of a photographic film of JIS K-7619-1988.

The measurement conditions are 25° C., 60% RH, and a humidity control time of 10 hours.

For the antireflection film in the invention, the value indicative of the curl expressed as the following mathematical expression (6) preferably falls within a range of −15 to +15, more preferably in a range of −12 to +12, and further preferably −10 to +10. The measuring direction in the sample for curl is along the direction of transfer of the base material when coating is carried out in the web form.

Curl=1/R Mathematical expression (6):

where R represents the radius of curvature (m)

This is an important characteristic for preventing crack or film peeling from occurring in film manufacturing or processing, or handling in the market. It is preferable that the curl value falls within the foregoing range, and that the curl is small. Herein, the curl being “+” represents the curl such that the coated side of the film is the inside of the curve. Whereas, “−” represents the curl such that the coated side is the outside of the curve.

Whereas, for the film in the invention, the absolute value of the difference between respective curl values when only the relative humidity has been changed to 80% and 10% based on the curl measuring method is preferably 24 to 0, further preferably 15 to 0, and most preferably 8 to 0. This is the characteristic related to the handling property, peeling, and crack when the film has been bonded under various humidities.

### [Adhesion Evaluation]

The adhesion between layers of the antireflection film, or between the support and the coating layer can be evaluated in the following manner.

In the surface on the side having the coating layer, 11 incisions and 11 incisions are made longitudinally and transversely, respectively, at an interval of 1 mm in a grid with a cutter knife to scribe a total of 100 square cells. Then, a polyester adhesive tape “No. 31B” manufactured by NITTO DENKO Corporation is pressure bonded thereon. After 24-hour standing, it is peeled off therefrom. This test is repeated 3 times at the same position. Then, whether peeling has occurred or not is visually observed. Peeling occurs preferably in 10 or less cells, and further preferably in 2 or less cells out of the 100 cells.

### [Brittleness Test (Crack Resistance)]

The crack resistance is an important characteristic for preventing a fracture defect from occurring due to handling such as coating, processing, or cutting of the antireflection film, coating of a self-adhesive, or bonding to various objects.

The antireflection film sample is cut into pieces of 35 mm×140 mm, and allowed to stand for 2 hours under the conditions of a temperature of 25° C., and 60% RH. Then, the diameter of curvature with which cracking starts to occur when the film is rolled in a tube is measured. Thus, the cracking of the surface can be evaluated.

As for the crack resistance of the film of the invention, the diameter of curvature with which cracking occurs when the film is rolled with the coating layer side facing outwardly is preferably 50 mm or less, more preferably 40 mm or less, and most preferably 30 mm or less. As for the cracking at the edge portion, it is preferable that there is no crack, or that the length of the crack is less than 1 mm on an average.

### [Surface Resistance]

The film surface resistance of the invention was measured under the conditions of a temperature of 25° C., and 60% RH by means of a super-insulating resistance/microammeter “TR8601” {manufactured by Advantest Co., Ltd.}. The common logarithm of the surface resistance (Ω/□) is taken to calculate the value of logSR.

### [Dust Removability]

The antireflection film of the invention is bonded onto a monitor. Dust (fiber wastes of padded mattress and clothes) is sprinkled on the monitor surface, and the dust is wiped off with a cleaning cloth. Thus, the dust removability can be evaluated.

It is preferable that the dust can be completely removed through 6 cycles of wiping operations, and it is further preferable that the dust can be completely removed through 3 or less cycles of wiping operations.

### [Drawing Performance of Liquid Crystal Display Apparatus]

Below, a description will be given to the characteristic evaluation method and the preferred conditions when the antireflection film of the invention is used on the display apparatus.

The polarizing plate on the visible side provided in a liquid crystal display apparatus “TH-15TA2” {manufactured by Matsushita Electric Industrial Co., Ltd.} using a TN type liquid crystal cell is peeled off. Instead, the antireflection film or the polarizing plate of the invention is bonded via a self-adhesive so that the coating side is the visible side, and that the transmission axis of the polarizing plate is in alignment with that of the polarizing plate bonded onto the product. In a 500-Lx bright room, the liquid crystal display apparatus is set in a black display state, so that the following various characteristics can be evaluated visually from various visual angles.

### [Evaluation of Nonuniformity of Drawn Image and Color Taste]

By the use of a measuring device (“EZ-Contrast 160D”, manufactured by ELDIM Co.), the drawing nonuniformity and color taste changes during black display (L1) are visually evaluated by a plurality of observers.

When 10 observers evaluate them, the number of observers, who can recognize the nonuniformity, the left and right color taste changes, the color taste changes due to temperature and humidity, and white blur, is preferably 3 or less. It is more preferable that no observer can recognize them.

Whereas, the glare of external light is caused by the use of a fluorescent lamp, and the changes in glare can be relatively visually evaluated.

### (Light Leakage During Black Display)

The light leakage rate during black display at an orientation of 45° from the front of the liquid crystal display apparatus, and at a polar angle direction of 70° is measured. The light leakage rate is preferably 0.4% or less, and more preferably 0.1% or less.

### [Contrast and Viewing Angle]

As for the contrast and the viewing angle, by the use of a measuring machine “EZ-Contrast 160D” (manufactured by ELDIM Co.), the contrast ratio, and the viewing angles in the lateral direction (the direction orthogonal to the rubbing direction of the cell) (the extent of the range of angle resulting in a contrast ratio of 10 or more) can be examined.

### EXAMPLES

Below, the invention will be further described in details by way of examples, which should not be construed as limiting the scope of the invention.

### <Manufacturing of Antireflection Film>

### [Preparation of Coating Solution for Forming Each Layer]

### [Preparation of Sol Solution (a-1)]

Into a 1000-mL reactor equipped with a thermometer, a nitrogen inlet tube, and a dropping funnel, 187 g (0.80 mol) of 3-acryloxyoxypropyl trimethoxysilane, 27.2 g (0.20 mol) of methyltrimethoxysilane, 320 g (10 mol) of methanol, and 0.06 g (0.001 mol) of potassium fluoride (KF) were charged. Then, 15.1 g (0.86 mol) of water was slowly added dropwise under stirring at room temperature. After the completion of the dropwise addition, stirring was carried out for 3 hours at room temperature. Then, heating and stirring were carried out for 2 hours under methanol reflux. Then, the low boiling point component was distilled off under reduced pressure, further followed by filtration. As a result, 120 g of a sol solution (a-1) was obtained.

The substance thus obtained was measured by GPC. As a result, the mass average molecular weight was found to be 1500. Out of the components equal to or larger than oligomer components in size, the components with a molecular weight of 1000 to 20000 were found to account for 30 mass %. Whereas, from the measurement results of 1H-NMR, the structure of the resulting substance was found to be the structure represented by the following formula.

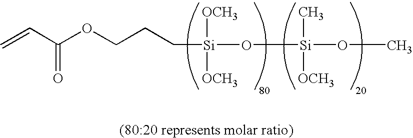

Further, the condensation ratio a by ²⁹Si-NMR measurement was found to be 0.56. This analysis result indicated that the silane coupling agent sol of this example was mostly formed of a straight chain-like structure portion. Whereas, the gas chromatography analysis indicated that the remaining ratio of the raw material acryloxypropyl trimethoxysilane was 5 mass % or less.

### [Preparation of Sol Solution (b-1)]

In a reactor equipped with a stirrer and a reflux condenser, 119 parts by mass of methyl ethyl ketone, 101 parts by mass of 3-acryloyloxypropyl trimethoxysilane {KBM-5103, silane coupling agent, manufactured by Shin-Etsu Chemical Co., Ltd.}, and 3 parts by mass of diisopropoxy aluminum ethyl acetoacetate were added and mixed. Then, 30 parts by mass of ion exchange water was added thereto. The resulting mixture was allowed to react at 60° C. for 4 hours, and then cooled down to room temperature, resulting in a sol solution (b-1).

The mass average molecular weight of the sol solution (b-1) was 1600. Out of the components equal to or larger than oligomer components in size, the components with a molecular weight of 1000 to 20000 were found to account for 100 mass %. Whereas, the gas chromatography analysis indicated that no acryloyloxypropyl trimethoxysilane of the raw material remained at all. The SP value of the sol solution (b-1) was found to be 22.4.

### [Preparation of Hard Coat Layer Coating Solution]

TABLE 2

| | | HC-1 | HC-2 | HC-3 | HC-4 | HC-5 | HC-6 | HC-7 | HC-8 |
|---|---|---|---|---|---|---|---|---|---|
| Binder | DPHA | 4.45 | 4.45 | 4.45 | 4.45 | 4.45 | 4.45 | | 82 |
| | PETA | 40.1 | 30 | 30 | 30 | 30 | 30 | 200 | |
| | Light + heat material 1-1 | | 10 | 10 | | | | | |
| | Light + heat material 2-2 | | | | 10 | 10 | 10 | 85 | 45 |
| | DeSolite Z7410 (containing silica) | | | | | | | | 150 |
| Metal oxide particles | MEK-ST (silica particles) (30 | | | 101 | 101 | 101 | 101 | | |
| | mass %) | | | | | | | | |
| | cohesive silica | | | | | | | 1.7 | |
| | (Secondary agglomerate diameter | | | | | | | | |
| | 1.5 μm) | | | | | | | | |
| | SX-350-crosslinked polystyrene | 1.7 | 1.7 | 1.7 | 1.7 | 1.7 | 1.7 | | 1.7 |
| | particles (30 mass %) | | | | | | | | |
| | Crosslinked acrylic / styrene particles | 13.3 | 13.3 | 13.3 | 13.3 | 13.3 | 13.3 | | |
| | (30 mass %) | | | | | | | | |
| Curing agent | Methylolated melamine | | 2.5 | 2.5 | 2.5 | 2.5 | 2.5 | 20 | 8 |
| | P-toluenesulfonic acid / triethylamine | | 0.25 | 0.25 | 0.25 | 0.25 | 0.25 | 2 | 0.8 |
| | salt | | | | | | | | |
| Photopolymerization | IRGACURE 184 | 1.34 | 1.34 | 1.34 | 1.34 | | | 15 | 1.34 |
| initiator | IRGACURE 907 | 0.24 | 0.24 | 0.24 | 0.24 | | | | 0.24 |
| | 1C-3 (trihalomethyltriazine) | | | | | 1.5 | | | |
| Thermal polymerization | 2,2′-azobis(isobutyronitrile) | | | | | | 1.5 | | |
| initiator | | | | | | | | | |
| Leveling agent | FP-132 | 0.08 | 0.08 | 0.08 | 0.08 | 0.08 | 0.08 | | |
| | R-30 | | | | | | | 0.5 | |
| Silane coupling agent | Sol solution (a-1) | | | | | | | 25.8 | 25.8 |
| Solvent | Methyl ethyl ketone | | | | | | | | 184 |
| | Methyl isobutyl ketone | 38 | 38 | 38 | 38 | 38 | 38 | 175 | |
| | Cyclohexanone | 16.1 | 16.1 | 16.1 | 16.1 | 16.1 | 16.1 | | 184 |

HC-1 to HC-8 of the hard coat layer coating solution were prepared by filtering respective solutions each sufficiently mixed
according to the table through a filter made of polypropylene with a pore diameter of 30 μm. The numerical values in the
table represent the mass (g). Incidentally, the expressions in the table are as follows.
PETA: a mixture of pentaerythritol acrylate and pentaerythritol tetraacrylate, manufactured by NIPPON KAYAKU Co., Ltd.,
DPHA: a mixture of dipentaerythritol hexaacrylate and dipentaerythritol pentaacrylate [manufactured by NIPPON KAYAKU Co., Ltd.],
“DeSolite Z7410”: commercially available silica-containing UV-curable hard coat solution, solid content concentration 70.1 mass %,
silica content 35 mass %, average particle diameter 22 nm, manufactured by JSR Corporation,
“MEK-ST”: silica sol, average particle diameter 15 nm, solid content concentration 30 mass %, manufactured by Nissan Chemical
Industries,
cohesive silica: secondary agglomerate diameter 1.5 μm (primary particle diameter, several tens nanometers) [manufactured
by NIHON SILICA Co., Ltd.],
“SX-350”: average particle diameter 3.5 μm, crosslinked polystyrene particles (refractive index 1.60), a 30 mass %
toluene dispersion, manufactured by Soken Chemicals & Engineering Co., Ltd., a 30% toluene dispersion. To be used after
dispersion at 10000 rpm by means of a POLYTRON dispersing apparatus for 20 minutes,
crosslinked acrylic-styrene particles: average particle diameter 3.5 μm, (refractive index 1.55), a 30 mass % toluene
dispersion, manufactured by Soken Chemicals & Engineering Co., Ltd.,
IRGACURE 184: polymerization initiator [manufactured by Ciba Specialty Chemicals, Ltd.],
IRGACURE 907: polymerization initiator [manufactured by Ciba Specialty Chemicals, Ltd.], and
“FP-132”: fluorine type surface modifier of the following structural formula:

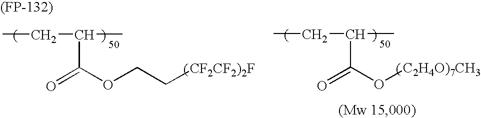

“R-30”: Fluorine type leveling agent, manufactured by Dainippon Ink And Chemicals, Incorporated (commercially available product)

### (Coating of Hard Coat Layer)

A 80 μm-thick triacetyl cellulose film (TAC-TD80U, manufactured by Fuji Photo Film, Co., Ltd., (now, FUJIFILM Corporation) refractive index: 1.49) was uncoiled and fed in a roll form by means of a slot die coater described in FIG. 1 of JP-A-2003-211052. Then, the hard coat layer coating solutions HC-1 to HC-8 were coated so that each coating amount was 16 cc/m². Drying was carried out at 30° C. for 15 seconds, and at 90° C. for 20 seconds. Then, each film was treated with any method of the foregoing curing methods a to c. At this step, for ionizing radiation curing, the following treatment was carried out. An ultraviolet ray with an exposure dose of 50 mJ/cm² was applied thereto using a 160 W/cm air cooled metal halide lamp (manufactured by EYEGRAPHICS Co., Ltd.) under nitrogen purge to cure the coating layer. When heat curing was adopted in combination, a heat treatment at 100° C. was carried out for 8 minutes, respectively. When ionizing radiation curing was carried out while further heating, an ultraviolet ray was applied thereto while heating at 100° C. As a result of the treatment, an optical film having a hard coat layer with a thickness of 2.5 to 6.0 μm was manufactured, and coiled.

### [Preparation of Low Refractive Index Layer Coating Solution]

The low refractive index layer coating solutions LN-1 to LN-9 were prepared according to the following table. The numeric values in the table are the expressions for the part by mass. Incidentally, the b-14 salt compound of p-toluenesulfonic acid in the table represents the salt (curing catalyst) formed from the foregoing acid and organic base.

TABLE 3

| Coating | | LN-1 | LN-2 | LN-3 | LN-4 | LN-5 | LN-6 |
|---|---|---|---|---|---|---|---|
| Fluorine-containing | B-1 | 53 | 53 | | 55.6 | — | — |
| binder | B-2 | | | 53 | | | |
| | P-3 | — | — | — | — | 6 | 6 |
| Binder | Light + heat material | | | | | 1.5 | 1.5 |
| | 2-2 | | | | | | |
| Oligomer | Sol (b-1) | — | 2.58 | 2.58 | 1.92 | 0.95 | 0.95 |
| Metal oxide | MEK-ST-L | — | 5.57 | 5.57 | 5.57 | 6.12 | |
| particles | Hollow silica | | | | | | 6.12 |
| Initiator | 1C-1 | — | — | — | 2.08 | 0.05 | 0.05 |
| | Compound solution | | | | | | |
| | MP-triazine | — | — | — | — | 0.09 | 0.09 |
| Additive | RMS-033 | — | — | — | — | 2.75 | 2.75 |
| | b-14 compound in | — | — | — | 0.07 | — | — |
| | Table 1 | | | | | | |
| Solvent | Methyl ehtyl ketone | 44.2 | 36 | 36 | 32 | 75.1 | 75.1 |
| | Cyclohexanone | 2.83 | 2.83 | 2.83 | 2.83 | 7.51 | 7.51 |

| | | | | | | |
|---|---|---|---|---|---|---|
| Total | 100 | 100 | 100 | 100 | 100 | 100 |

The foregoing respective coating solutions were filtrated through a filter made of polypropylene with a pore diameter of 1 μm to complete the low refractive index layer coating solutions (LN-1 to −5).
The compounds used for manufacturing of the respective coating solutions will be shown below.
“B-1”: 80 g of fluorine-containing heat curable polymer described in Example 1 of JP-A-11-189621, 20 g of CYMEL 303 (manufactured by Japan Cytec Industries Inc.) as curing agent and 2.0 g of CATALYST 4050 (manufactured by Japan Cytec Industries Inc.) as curing catalyst are dissolved in methyl ethyl ketone, so as to make solid content concentration 6 mass %,
“B-2”: Ethylenically unsaturated group-containing flourine polymer A-1 described in Example 1 of JP-A-2003-183322, solid content concentration 15.2 mass %, solvent methyl isobutyl ketone,
“P-3”: Fluorine-containing copolymer (P-3) described in JP-A-2004-45462, mass average molecular weight about 50000, solid content concentration 23.8 mass %, solvent methyl ethyl ketone,
Silica particle dispersion of “MEK-ST”, average particle diameter 15 nm, solid content concentration 30 mass %, dispersion solvent methyl ethyl ketone, manufactured by Nissan Chemical Industries,
“MEK-ST-L”: silica particle dispersion, average particle diameter 45 nm, solid content concentration 30 mass %, dispersion solvent methyl ethyl ketone, manufactured by Nissan Chemical Industries,
Hollow silica dispersion: CS-60 IPA (manufactured by CATALYSTS & CHEMICALS IND., CO., LTD.) refractive index 1.31, average particle diameter 60 nm, shell thickness 10 nm, solid content concentration 18.2%, “KBM-5103” surface modified hollow silica sol (surface modification ratio based on silica 30 mass %),
“1C-1 compound solution”: solid content concentration 2 mass %, solvent methyl ethyl ketone,
“MP-triazine”: polymerization photoinitiator, manufactured by Sanwa Chemical Co., Ltd.,
“RMS-033”: reactive silicone resin, manufactured by Gelest Co. (Coating of low refractive index layer-1)

Respective hard coat layers of the invention were coated. Then, further, the coating solutions LN-1 to LN-8 for a low refractive index layer were wet coated so that the dry film thickness of each low refractive index layer was 95 nm. Subsequently, drying was carried out at 120° C. for 150 seconds. Then, each film was treated with any method of the foregoing curing methods d to h. At this step, for heat curing, a heat treatment at 100° C. was carried out for 8 minutes, respectively. For the subsequent ionizing radiation curing, the following treatment was carried out. An ultraviolet ray with an exposure dose of 110 mJ/cm² was applied thereto using a 240 W/cm air cooled metal halide lamp (manufactured by EYEGRAPHICS Co., Ltd.) in an atmosphere with an oxygen concentration of 100 ppm by nitrogen purge. When ionizing radiation curing was carried out first, an ultraviolet ray with an exposure dose of 400 mJ/cm² was applied thereto using a 240 W/cm air cooled metal halide lamp (manufactured by EYEGRAPHICS Co., Ltd.) under an atmosphere with an oxygen concentration of 100 ppm, and then, a heat treatment at 100° C. was carried out for 8 minutes. When ionizing radiation curing was carried out while further heating, an ultraviolet ray was applied thereto while heating at 100° C. In the foregoing manner, each antireflection film including a low refractive index layer stacked thereon was formed.

### [Evaluation of Antireflection Film Sample]

Each resulting antireflection film sample was evaluated for the following items. The results are shown in Table 4.

### [Mirror Reflectance]

A spectro hardness meter “V-550” {manufactured by JASCO Corporation} was equipped with an adaptor “ARV-474”. Thus, the mirror reflectance at an output angle of −5° with an incident angle of 5° within a wavelength region of 380 to 780 nm was measured. Then, the average reflectance over 450 to 650 nm was calculated. As a result, the antireflection property was evaluated.

The sample was mounted on an integrating sphere of a spectro photometer “V-550” [manufactured by JASCO Corporation], and the integral reflectance in a wavelength region of from 380 to 780 nm was measured, and then the average reflectance over 450 to 650 nm was calculated.

### (Pencil Hardness)

The pencil hardness evaluation according to JIS K-5400 was carried out.

Each antireflection film was humidity controlled at a temperature of 25° C. and at 60% RH. Then, evaluation was carried out based on the following criteria under a load of 500 g by the use of pencils for test of H to 5H specified according to JIS S-600. The highest hardness judged as OK was taken as a judgment value.

No scratch to one scratch at the evaluation of n=5: OK

3 or more scratches at the evaluation of n=5: NG

### (Steel Wool Rubbing Resistance)

A steel wool of #0000 was applied with a load of 200 g/cm². Then, the state of scratches upon 10 reciprocations was observed, and rated on the following five scales.

AA: The one having no scratch at all thereon;

A: The one having a few hardly observable scratches thereon;

B: The one having clearly observable scratches thereon;

C: The one remarkably having clearly observable scratches thereon; and

CC: The one which has undergone peeling of the film

TABLE 4

| | | | Low | | | | |
|---|---|---|---|---|---|---|---|
| | Hard | | refractive | | Integral | | |
| | coat | Curing | index | Curing | reflectance | Pencil | Steel wool |
| | layer | method | layer | method | (%) | hardness | resistance |
| Comparative | HC-1 | Only | LN-1 | Only | 2.81 | 2H | C |
| Example 1 | | light | | heat | | | |
| Comparative | HC-1 | Only | LN-2 | Only | 2.79 | 2H | C |
| Example 2 | | light | | heat | | | |
| Example 1 | HC-1 | Only | LN-2 | e | 2.8 | 3H | A |
| | | light | | | | | |
| Example 2 | HC-2 | a | LN-2 | e | 2.82 | 4H | AA |
| Example 3 | HC-2 | a | LN-2 | f | 2.81 | 4H | AA |
| Example 4 | HC-2 | a | LN-3 | e | 2.81 | 4H | AA |
| Example 5 | HC-2 | a | LN-4 | e | 2.8 | 4H | AA |
| Example 6 | HC-2 | a | LN-5 | f | 2.82 | 4H | AA |
| Example 7 | HC-2 | a | LN-6 | f | 1.5 | 4H | AA |
| Example 8 | HC-2 | a | LN-6 | h | 1.5 | 4H | AA |
| Example 9 | HC-2 | c | LN-6 | h | 1.51 | 4H | AA |
| Example 10 | HC-2 | b | LN-2 | e | 2.79 | 4H | AA |
| Example 11 | HC-2 | c | LN-2 | e | 2.8 | 4H | AA |
| Example 12 | HC-6 | g | LN-2 | e | 2.79 | 4H | AA |
| Example 13 | HC-3 | c | LN-3 | e | 2.81 | 4H | AA |
| Example 14 | HC-4 | c | LN-3 | e | 2.81 | 4H | AA |
| Example 15 | HC-5 | c | LN-3 | e | 2.82 | 4H | AA |
| Example 16 | HC-6 | c | LN-3 | e | 2.83 | 4H | AA |
| Example 17 | HC-7 | c | LN-3 | e | 2.81 | 4H | AA |
| Example 18 | HC-8 | c | LN-3 | e | 2.81 | 4H | AA |

As indicated from Table 4, it has been shown that curing of the coating composition on the transparent support with a plurality of energies can provide a film excellent in scratch resistance while having sufficient antireflection performance.

### <Manufacturing of Protective Film for Polarizing Plate>

### Example 19

A saponification solution prepared by keeping a 1.5 mol/L sodium hydroxide aqueous solution at 50° C. was prepared. Further, a 0.005 mol/L dilute sulfuric acid aqueous solution was prepared.

For each antireflection films manufactured in Examples 1 to 18, the surface of the transparent support opposite from the side having the low refractive index layer of the antireflection film was subjected to a saponification treatment by the use of the saponification solution. Then, the sodium hydroxide aqueous solution on the transparent support surface subjected to a saponification treatment was sufficiently washed with water, followed by washing with the dilute sulfuric acid aqueous solution. Further, the dilute sulfuric acid aqueous solution was sufficiently washed with water, and sufficiently dried at 100° C.

The contact angle to water of the surface of the transparent support on the side subjected to the saponification treatment of the antireflection film was evaluated and found to be 40° or less. In this manner, each protective film for a polarizing plate was manufactured.

### [Manufacturing of Polarizing Plate]

### [Manufacturing of Polarizing Film]

A 75 μm-thick polyvinyl alcohol film {manufactured by Kuraray Co., Ltd.} was dipped in an aqueous solution including 1000 parts by mass of water, 7 parts by mass of iodine, and 105 parts by mass of potassium iodide for 5 minutes, and allowed to adsorb iodine. Then, the film was uniaxially drawn to 4.4 times its original length longitudinally in a 4 mass % boric acid aqueous solution, and then dried still in a stretched form, thereby to manufacture a polarizing film.

Using a polyvinyl alcohol type adhesive as an adhesive, the triacetyl cellulose side of the antireflection film (protective film for a polarizing plate), subjected to a saponification treatment, was bonded to one surface of the polarizing film. Further, to the other side of the polarizing film, a triacetyl cellulose film, which had been subjected to a saponification treatment in the same manner as described above, was bonded using the same polyvinyl alcohol type adhesive.

### [Evaluation at Display Apparatus]

Each polarizing plate of Example 3 of the invention thus manufactured was mounted so that the antireflection film was the outermost surface of the display. The TN, STN, IPS, VA, or OCB mode transmission type, reflection type, or semi-transmission type liquid crystal display apparatus was excellent in antireflection performance, and very excellent in visibility. Particularly, the effects thereof were noticeable for the VA mode.

### Example 20

### [Manufacturing of Polarizing Plate]

As for an optical compensation film having an optical compensation layer “Wide View Film SA-12B”, {manufactured by Fuji Photo Film, Co., Ltd.}, the surface opposite from the side having the optical compensation layer was subjected to a saponification treatment under the same conditions as in Example 19.

For each polarizing film manufactured in Example 19, the saponification treated side of the antireflection film (protective film for a polarizing plate) manufactured in Examples 1 and 2 was each bonded to one side of the polarizing film using the same polyvinyl alcohol type adhesive as an adhesive. Further, to the other side of the polarizing film, the surface of the saponification treated optical compensation film opposite from the side having the optical compensation layer was bonded using the same polyvinyl alcohol type adhesive.

### [Evaluation at Display Apparatus]

Each polarizing plate of Example 22 thus manufactured was mounted so that the antireflection film was the outermost surface of the display. The TN, STN, IPS, VA, or OCB mode transmission type, reflection type, or semi-transmission type liquid crystal display apparatus was excellent in contrast in a bright room than with a liquid crystal display apparatus mounting thereon a polarizing plate not using an optical compensation film, and has very wide vertical and lateral viewing angles, and further excellent in antireflection performance and very excellent in visibility and display quality. Particularly, the effects thereof were noticeable for the VA mode.

In accordance with the present invention, curing the coating composition with a plurality of energies of a heat energy and a light energy (preferably, a plurality of cycles of sequential or simultaneous application with a heat energy and a light energy) can provide an optical film high in film strength at a low cost. Further, this can manufacture an antireflection film which has been more improved in scratch resistance while having a sufficient antireflection property. Curing of the coating composition on a transparent support with a plurality of energies can provide rapid curing, and an optical film which has been accordingly improved in scratch resistance. Further, in the case of an at least two- or more layered structure as with the antireflection film, desirable performances can be exerted by carrying out the hardness improvement in the layers and the promotion of bonding between the layers. Further, a display apparatus (image display apparatus) having an antireflection film or a polarizing plate manufactured by the invention is characterized by being less susceptible to glare of external light and glare of the background, and very high in visibility.

The entire disclosure of each and every foreign patent application from which the benefit of foreign priority has been claimed in the present application is incorporated herein by reference, as if fully set forth.

What is claimed is:

1. An optical film, which comprises:
a transparent support; and
at least one layer of functional layer formed from a coating composition,
wherein the at least one layer of functional layer is formed by curing the coating composition by a heat energy and a light energy.

2. The optical film according to claim 1,
wherein the at least one layer of functional layer is formed by a plurality of cycles of sequential or simultaneous application with the heat energy and the light energy.

3. The optical film according to claim 1,
wherein the coating composition comprises a heat curable material and a light curable material.

4. The optical film according to claim 1,
wherein the coating composition comprises a compound including a heat curable moiety and a light curable moiety in the same molecule.

5. The optical film according to claim 1,
wherein the at least one layer of functional layer includes a layer in contact with a surface of the transparent support.

6. The optical film according to claim 1,
wherein the at least one layer of functional layer includes at least one of a low refractive index layer and a hard coat layer.

7. The optical film according to claim 1,
wherein the at least one layer of functional layer is at least two layers of functional layers.

8. An antireflection film, which comprises:
an optical film according to claim 1; and
an antireflection layer.

9. A polarizing plate, which comprises:
a pair of protective films; and
a polarizing film between the pair of protective films,
wherein at least one of the pair of protective films is an optical film according to claim 1.

10. A display apparatus, which comprises:
an antireflection film according to claim 8,
wherein the antireflection film comprises a low refractive index layer that is disposed so as to be on a viewing side.

11. A method for manufacturing an optical film comprising a transparent support and at least one layer of functional layer, the method comprising:
coating and drying a coating composition; and
curing the coating composition by a heat energy and a light energy so as to form the at least one layer of functional layer.

12. The manufacturing method according to claim 11,
wherein the heat energy and the light energy are applied plural times sequentially or simultaneously.

13. The manufacturing method according to claim 1 1,
wherein the coating composition comprises a heat curable material and a light curable material.

14. The manufacturing method according to claim 11,
wherein the coating composition comprises a compound including a heat curable moiety and a light curable moiety in the same molecule.

15. The manufacturing method according to claim 1 1,
wherein the at least one layer of functional layer includes a layer in contact with a surface of the transparent support.

16. The manufacturing method according to claim 11,
wherein the at least one layer of functional layer includes at least one of a low refractive index layer and a hard coat layer.

17. The manufacturing method according to claim 11,
wherein the at least one layer of functional layer is at least two layers of functional layers.

18. The manufacturing method according to claim 11,
wherein the at least two layers of functional layers include a hard coat layer and an antireflection layer.
